(19) United States
(12) Patent Application Publication
(10) Pub. No.: US 2007/0126877 A1
(43) Pub. Date: Jun. 7, 2007

(54) MULTIFUNCTIONAL VIDEO APPARATUS AND METHOD OF PROVIDING USER INTERFACE THEREOF

(76) Inventor: Hong-seok YANG, Seongnam-si (KR)

Correspondence Address: STANZIONE & KIM, LLP, 919 18TH STREET, N.W., SUITE 440, WASHINGTON, DC, 20006, US

(21) Appl. No.: 11/563,071

(22) Filed: Nov. 24, 2006

(30) Foreign Application Priority Data
Dec. 1, 2005 (KR) 2005-116538
Dec. 2, 2005 (KR) 2005-117138

(51) Int. Cl. H04N 5/225

(52) U.S. Cl. 348/207.99

(57) ABSTRACT

A multifunctional video apparatus and a method of providing a user interface (UI) of the multifunctional video apparatus. The multifunctional video apparatus includes a CCD module to capture an image of an object and generating a corresponding video signal, a tuner module to receive a broadcasting signal provided through a selected channel, a decoding module to decode the broadcasting signal received through the tuner module, a display unit to display a video corresponding to a reproduced signal, and a signal processing block to process the video signal generated from the CCD module, to record the processed video signal in a memory, to reproduce an output signal of the decoding module, and to apply the reproduced signal to the display unit. Accordingly, diverse functions, such as DMB reception, photographing and/or reproduction, moving image filming and/or reproduction, music playback, voice recording and/or reproduction, etc., can be provided through one apparatus, and the user's manipulation is facilitated in using the multifunctional video apparatus providing many functions.

### CROSS-REFERENCE TO RELATED APPLICATIONS

This application claims the benefit under 35 U.S.C. §119 of Korean Patent Application Nos. 10-2005-0116538 filed on Dec. 1, 2005 & 10-2005-0117138 filed on Dec. 2, 2005, in the Korean Intellectual Property Office, the entire disclosures of which are incorporated herein in their entireties by reference.

### BACKGROUND OF THE INVENTION

1. Field of the Invention

The present general inventive concept relates to a multifunctional video apparatus and a method of providing a user interface thereof. More particularly, the present general inventive concept relates to a multifunctional video apparatus and a method of providing a user interface (UI) thereof, which has diverse functions of a digital camera, an MP3 player, a voice recorder, a DMB receiving unit, and so forth, and which can compress, store, and reproduce video and audio signals.

2. Description of the Related Art

A multifunctional video apparatus is an apparatus in which diverse video devices are integrated. The implementation of such a multifunctional video apparatus has become possible by grafting digital technology having been remarkably developed on video apparatuses.

In the multifunctional video apparatus, it is profitable to digitalize the internal signal process of the apparatus to perform diverse functions. In addition, since video data having multi-dimensional characteristics has a lot of information, unlike general data, massive data is required to process the video data as a digitalized video, and this necessitates a data compression technology having a high compression rate.

Recently, new videos such as a DMB service, and so forth, have appeared, and the demand for such videos is on an increasing trend.

Accordingly, in addition to basic video processing functions such as a digital camera, an MP3, and so forth, diverse functions grafted on the developing digital technology can be performed. A multifunctional video apparatus is an apparatus in which such diverse functions are integrated.

As the multifunctional video apparatus has more diverse and complex functions, becomes quite complicated to use. Accordingly, a need exists for a user interface (UI) that facilitates a user's manipulation and provides an excellent visual effect.

### SUMMARY OF THE INVENTION

The present general inventive concept provides a multifunctional video apparatus which has diverse functions of a digital camera, an MP3 player, a voice recorder, a DMB receiving unit, and so forth, and which can compress, store, and reproduce video and audio signals.

Additional aspects and utilities of the present general inventive concept will be set forth in part in the description which follows and, in part, will be obvious from the description, or may be learned by practice of the general inventive concept.

The foregoing and other aspects and utilities of the present general inventive concept may be achieved by providing a multifunctional video apparatus which includes a Charge Coupled Device (CCD) module to capture an image of an object and to generate a corresponding video signal, a tuner module to receive a broadcasting signal provided through a selected channel, a decoding module to decode the broadcasting signal received through the tuner module, a display unit to display a video corresponding to a reproduced signal, and a signal processing block to process the video signal generated from the CCD module, to record the processed video signal in a memory, to reproduce an output signal of the decoding module, and to apply the reproduced signal to the display unit.

The multifunctional video apparatus may further include a conversion unit to output an audio corresponding to an audio signal provided from the signal processing block, to generate and transfer an audio signal corresponding to an audio inputted from an outside to the signal processing block, and the signal processing block may process the audio signal transferred from the conversion unit and then store the processed audio signal in the memory.

The signal processing block may transfer a DAB signal received from the tuner module to the conversion unit.

The signal processing block may process the audio signal applied from the conversion unit, and then may record the processed audio signal in the memory.

The signal processing block may reproduce the signal stored in the memory, and then may transfer the reproduced signal to at least one of the display unit and the conversion unit.

The foregoing and other aspects and utilities may be achieved by providing a method of providing a user interface (UI) with a multifunctional video apparatus, which can simplify the manipulation of the multifunctional video apparatus, and can provide an excellent visual effect.

The method of providing a user interface (UI) with a multifunctional video apparatus, may include displaying a plurality of selectable shortcut icons by using a plurality of shortcut buttons included on an outer part of the multifunctional video apparatus, and performing a function of the multifunctional video apparatus that is indicated by the shortcut icon corresponding to the manipulated shortcut button among the plurality of shortcut buttons.

The display step may include displaying the plurality of shortcut icons to indicate different functions in accordance with a mode of the multifunctional video apparatus.

The display may be provided near the plurality of shortcut buttons.

The mode of the multifunctional video apparatus may include at least one of a setting mode to set an operation environment, a broadcast mode to receive a broadcast signal, a mode to record a photograph file generated through photographing, a mode to reproduce the recorded photograph file, a mode to record a moving image file generated through moving image filming, a mode to reproduce the recorded moving image file, a mode to play a music file, a mode to record a voice file generated through a voice recording, a mode to transfer the moving image generated through the moving image filming to an external device connected to the multifunctional video apparatus; and a mode to output the recorded photograph files to the external device.

The performing of the multifunction video apparatus may include displaying through a display a broadcast channel indicated by the manipulated shortcut button among the plurality of shortcut buttons, when the shortcut button is manipulated for less than a predetermined time.

The performing of the multifunction video apparatus may include registering a broadcast channel currently provided through a display as a favorite channel to be indicated by the manipulated shortcut button among the plurality of shortcut buttons, when the shortcut button is manipulated for more than a predetermined time.

The performing of the multifunction video apparatus may include displaying through a display one of a list of all receivable channels of the multifunction video apparatus, a list of video channels among all receivable channels, and a list of audio channels among all receivable channels.

The performing of the multifunction video apparatus may further include displaying through the display the currently displayed list along with the other lists among the list of all receivable channels, the list of video channels among all receivable channels, and the list of audio channels among all receivable channels, when the manipulated shortcut button is manipulated one more time.

The plurality of shortcut buttons may include at least one of a shortcut button to change operation mode of the multifunction video apparatus between a photographing mode and the reproducing mode, a shortcut button to set flash operation, a shortcut button to set photographing distance, and a shortcut button to set timer operation.

The plurality of shortcut buttons may include at least one of a shortcut button to change operation mode of the multifunction video apparatus between photographing mode and reproducing mode, a shortcut button to start photograph slide, a shortcut button to lock a file from deletion, and a shortcut button to delete a file.

The plurality of shortcut buttons may include at least one of a shortcut button to change operation of the multifunction video apparatus between photographing mode and reproducing mode, a shortcut button to set exposure, a shortcut button to set white balance, and a shortcut button to set digital effect of an image.

The plurality of shortcut buttons may include at least one of a shortcut button to change operation mode of the multifunction video apparatus between photographing mode and reproducing mode, a shortcut button to reproduce recorded files in order, a shortcut button to lock a file from deletion, and a shortcut button to delete a file.

The plurality of shortcut buttons may include at least one of a shortcut button to display a list of recorded files, a shortcut button to reproduce a predetermined number of files repeatedly, a shortcut button to lock certain buttons, and a shortcut button to delete a file.

The plurality of shortcut buttons may include at least one of a shortcut button to change operation mode of the multifunction apparatus between recording mode and reproducing mode, a shortcut button to display a list of recorded files, a shortcut button to reproduce a predetermined number of files repeatedly, and a shortcut button to delete a file.

The foregoing and/or other aspects and utilities of the present general inventive concept may also be achieved by providing a multifunction video apparatus including a memory which records a file, and a controller which controls such that a photograph file is recorded in a photograph folder of the memory, a moving image file is recorded in a moving image folder of the memory, and an audio related file is recorded in an audio folder of the memory, respectively.

The audio folder may include at least one of a voice folder which records a voice file generated through voice recording, and a music folder which records a music file.

The moving image folder and the audio folder may be subfolders of a same folder.

The foregoing and/or other aspects and utilities of the present general inventive concept may also be achieved by providing a multifunction video apparatus, including a first memory which records a file, and a controller which controls such that a file recorded in the first memory is copied onto a second memory which is newly mounted, or a file recorded in the second memory is copied onto the first memory.

The first memory may be provided inside the multifunction video apparatus, and the second memory may be removable with respect to the multifunction video apparatus.

The foregoing and/or other aspects and utilities of the present general inventive concept may also be achieved by providing a user interface (UI) of a multifunctional video apparatus, the UI including a plurality of selectable shortcut buttons provided on an outer part of the multifunctional video apparatus, and a plurality of shortcut icons corresponding to the plurality of shortcut buttons, each shortcut icon to perform an operation of the multifunctional video apparatus when the corresponding shortcut button is manipulated.

The plurality of shortcut icons may perform operations corresponding to operations of at least one of an audio file player, an audio file recorder, an audio and video signal compressor, an audio and video signal storage device, an audio and video reproducing device, an image capturing device, and a display unit.

The foregoing and/or other aspects and utilities of the present general inventive concept may also be achieved by providing a method of operating a multifunctional video apparatus, the method including capturing an image of an object and generating a corresponding video signal, recording the video signal in a memory, receiving a broadcasting signal provided through a selected channel, decoding and outputting the received broadcasting signal, reproducing the output broadcasting signal of the decoding module, and displaying an image corresponding to a reproduced broadcasting signal onto a display unit.

The foregoing and/or other aspects and utilities of the present general inventive concept may also be achieved by providing a multifunctional video apparatus, including a manipulation unit to receive a manipulation command and to output the received command; a photographing unit to photograph images, a DMB receiving unit to receive DMB, signal processing unit to process and store signals from audio files, moving images, still images, and DMB, and a control unit to receive an output from the manipulation unit and to control operation of each of the photographing unit, signal processing unit, and the DMB receiving unit according to the received command.

The photographing unit may send the images to the signal processing unit.

The photographing unit may include a charge coupled device (CCD) module to capture an image of an object and to generate a corresponding video signal, a lens to form an optical image of an object on an optical plane of the CCD, and a motor drive unit to operate the lens by driving a zoom motor, a focus motor, and an iris motor.

The DMB receiving unit may send the DMB to the signal processing unit.

The DMB receiving unit may include an antenna to receive the DMB signal, an active module to perform operations of DMB signal amplification or noise removal, a tuner module to perform channel tuning and signal decoding, and a video decoding module to transfer the DMB signal to the signal processing unit.

The signal processing unit may further reproduce the stored signals, and output the stored signals to a display unit.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a view illustrating construction of a multifunctional video apparatus according to an exemplary embodiment of the present general inventive concept;

FIG. 2 is a view illustrating the operation of the multifunctional video apparatus in a DAB receiving mode according to an embodiment of the present general inventive concept;

FIG. 3 is a view illustrating the operation of the multifunctional video apparatus in a DMB receiving mode according to an embodiment of the present general inventive concept;

FIG. 4 is a view illustrating the operation of the multifunctional video apparatus in a music playback mode according to an embodiment of the present general inventive concept;

FIG. 5 is a view explaining the operation of the multifunctional video apparatus in a photograph mode according to an embodiment of the present general inventive concept;

FIG. 6 is a view explaining the operation of the multifunctional video apparatus in a photo reproduction mode according to an embodiment of the present general inventive concept;

FIG. 7 is a view explaining a process of providing OSD in the multifunctional video apparatus according to an embodiment of the present general inventive concept;

FIGS. 8 to 10B are perspective views illustrating external appearances of the multifunctional video apparatus according to an embodiment of the present general inventive concept;

FIGS. 11A to 13 are views explaining an initial manipulation of the multifunctional video apparatus according to an embodiment of the present general inventive concept;

FIGS. 14 to 29B are views explaining a user interface (UI) provided by the multifunctional video apparatus in a setting mode according to an embodiment of the present general inventive concept;

FIGS. 30 to 32 are views explaining a UI provided by the multifunctional video apparatus in a DMB mode according to an embodiment of the present general inventive concept;

FIGS. 33 to 62C are views explaining a UI provided by the multifunctional video apparatus in a photograph mode according to an embodiment of the present general inventive concept;

FIGS. 63 to 80C are views explaining a UI provided by the multifunctional video apparatus in a moving image mode according to an embodiment of the present general inventive concept;

FIGS. 81A to 85C are views explaining a UI provided by the multifunctional video apparatus in a music mode according to an embodiment of the present general inventive concept;

FIGS. 86 to 93C are views explaining the UI provided by the multifunctional video apparatus in a voice mode according to an embodiment of the present general inventive concept;

FIG. 94 is a view explaining a UI provided by the multifunctional video apparatus in a direct print mode according to an embodiment of the present general inventive concept;

FIG. 95 is a view explaining a method of connecting a video cassette recorder to the multifunctional video apparatus according to an embodiment of the present general inventive concept; and

FIG. 96 is a block diagram illustrating the construction of a multifunctional video apparatus according to an embodiment of the present general inventive concept.

Throughout the drawings, like reference numerals will be understood to refer to like parts, components and structures.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

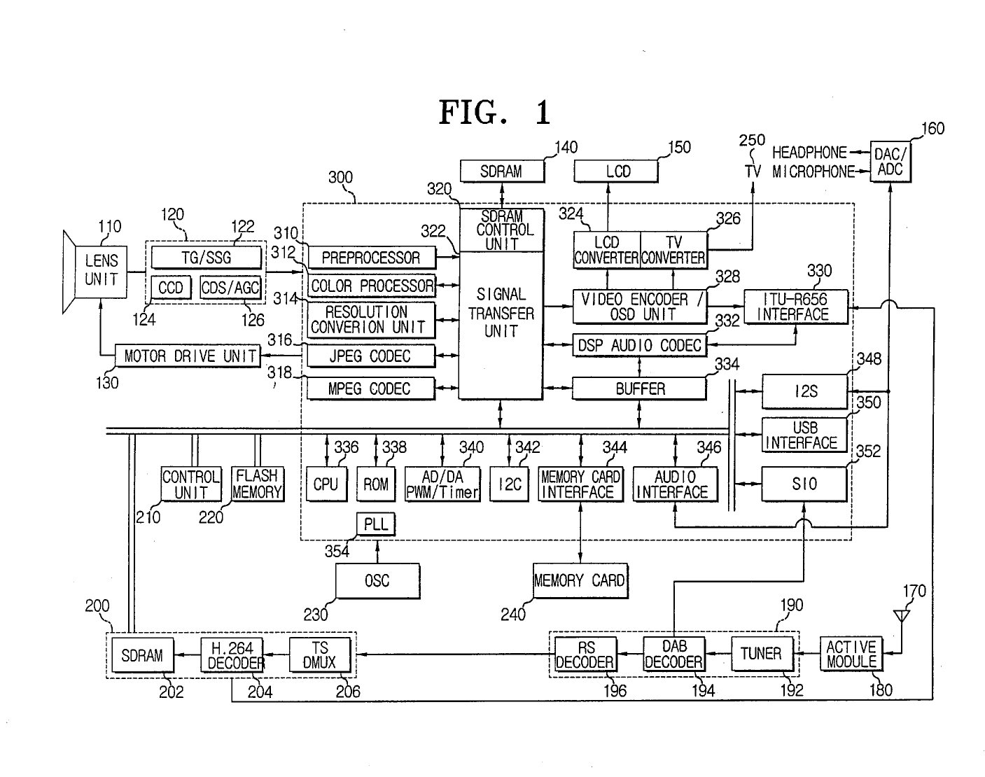

FIG. 1 is a view illustrating construction of a multifunctional video apparatus according to an exemplary embodiment of the present general inventive concept.

As illustrated in FIG. 1, the multifunctional video apparatus according to an exemplary embodiment of the present general inventive concept includes a lens unit 110, a Charge Coupled Device (CCD) module 120, a motor drive unit 130, an SDRAM 140, an LCD 150, a DAC/ADC 160, an antenna 170, an active module 180, a tuner module 190, a video decoding module 200, a control unit 210, a flash memory 220, an OSC unit 230, and a signal processing block 300.

A memory card 240 can be mounted in the multifunctional video apparatus, and a television receiving unit 250 (TV), a headphone (not illustrated), a microphone (not illustrated), a PC (not illustrated), and a printer (not illustrated) can be connected to the multifunctional video apparatus.

The lens unit 110 forms an optical image of an object on an optical plane of a CCD 124 to be described later.

The CCD module 120 captures an image of the object and generates a corresponding video signal. The video signal output from the CCD module 120 is a Y/Cb/Cr signal, and is input to the signal processing block 300.

As illustrated in FIG. 1, the CCD module 120 includes a TG/SSG unit 122, the CCD 124, and a CDS/AGC unit 126.

The TG/SSG unit 122 generates a drive pulse required to drive the CCD 124, and applies the generated drive pulse to the CCD 124. The CCD 124 generates and outputs an electric signal corresponding to the optical image formed on the optical plane by the lens unit 110. The CDS/AGC unit 126 performs a correlated double sampling (CDS) and an automatic gain control (AGC) with respect to the electric signal output from the CCD unit 124.

The motor drive unit 130 operates the lens unit 110 by driving a zoom motor, a focus motor, and an iris motor.

The SDRAM 140 is a buffer to provide a storage space required for the signal processing block 300 to process video/audio signals.

The LCD 150 is a display to display a video corresponding to a video signal output from the signal processing block 300.

The DAC/ADC 160 is an audio signal conversion element to convert a digital audio signal output from the signal processing block 300 into an analog audio signal and to output the analog audio signal to an audio output element such as an externally-connected headphone. In addition, the DAC/ADC 160 converts an analog audio signal input through an audio input element such as an externally-connected microphone externally into a digital audio signal, and transfers the digital audio signal to the signal processing block 300. The DAC/ADC 160 is a device in which a DAC and an ADC are integrated. However, the DAC and the ADC may be separately implemented.

The active module 180 performs a signal process such as amplification, noise removal, and so forth, with respect to the DMB/DAB signal received through the antenna 170.

The tuner module 190 performs a channel tuning and a decoding. As illustrated in FIG. 1, the tuner module 190 is provided with a tuner 192, a DAB decoder 194, and an RS decoder 196.

The tuner 192 tunes to the DMB/DAB signal provided through a channel selected by the user, and converts the DMB/DAB signal into a baseband signal.

The DAB decoder 194 converts the DAB signal output from the tuner 192 into a Musicam format, which is a type of 12S format, and transfers the converted signal to the signal processing block 300.

The RS decoder 196 detects and corrects errors by performing an RS decoding of the DMB signal output from the tuner 192, and transfers the error-corrected signal to the signal processing block 300.

The video decoding module 200 processes the DMB signal output from the RS decoder 196, and transfers the processed DMB signal to the signal processing block 300. As illustrated in FIG. 1, the video decoding module 200 is provided with an SDRAM 202, an H.264 decoder 204, and a TS DMUX 206.

The SDRAM 202 is a buffer to temporarily store a video signal and an audio signal included in the DMB signal.

The H.264 decoder 204 expands the video signal compressed in the H.264 format, which is temporarily stored in the SDRAM 202, converts the expanded video signal in a TIU-R656 format, and transfers the converted video signal to the signal processing block 300.

The TS DMUX 206 outputs the audio signal temporarily stored in the SDRAM 202 to the signal processing block 300.

The control unit 210 controls the entire operation of the multifunctional video apparatus so that functions according to a mode selected by the user can be performed.

The flash memory 220 is a built-in memory in which files transferred from the signal processing block 300 are stored. Files stored in the flash memory 220 may be read and reproduced through the signal processing block 300.

The OSC unit 230 generates a drive pulse required to drive the signal processing block 300.

The memory card 240 is a memory to store files transferred from the signal processing block 300, like the flash memory 220, and is detachably mounted in the multifunctional video apparatus. The files stored in the flash memory 220 can also be read and reproduced through the signal processing block 300.

The signal processing block 300 processes the video signal output from the CCD module 120, and reproduces the corresponding video on the LCD 150, or records the processed video signal in the flash memory 220 or memory card 240 in the form of a file.

The signal processing block 300 transfers the DAB signal received through the tuner module 190 to the DAB/ADC 160 to output the DAB signal through an external audio output element.

The signal processing block 300 also processes the DMB signal output from the video decoding module 200, and reproduces the corresponding video on the LCD 150 or records the processed video signal in the flash memory 220 and the memory card 240 in the form of a file.

In addition, the signal processing block 300 processes the audio signal applied through the DAC/ADC 160, and records the audio signal in the flash memory 220 or memory card 240 in the form of a file.

The signal processing block 300 can reproduce the file recorded in the flash memory 220 or memory card 240.

For the signal processing block 300 to perform the signal process, it uses the SDRAM 140 as a buffer. As illustrated in FIG. 1, the signal processing block 300 is provided with a preprocessor 310, a color-processor 312, a resolution conversion unit 314, a JPEG CODEC 316, an MPEG CODEC 318, an SDRAM control unit 320, a signal transfer unit 322, an LCD converter 324, a TV converter 326, a video encoder / OSD unit 328, an ITU-R656 interface 330, a DSP audio CODEC 332, a buffer 334, a CPU 336, a ROM 338, an AD/DA/PWM/Timer 340, an I2C 342, a memory card interface 344, an audio interface 346, an I2S 348, a USB interface 350, an SIO unit 352, and a PLL unit 354.

The preprocessor 310 converts a Y/Cb/Cr signal output from the CCD module 120 into a D2Y format. The color-processor 312 performs a white balancing and a gain adjustment of the D2Y-format video signal, and converts the video signal of the D2Y format into RAW data. The resolution conversion unit 314 converts the resolution of the video corresponding to the RAW data.

The JPEG CODEC 316 compresses the RAW data into a file of a JPEG format, and stores the compressed file in the flash memory 220 or the memory card 240. In addition, the JPEG CODEC 316 expands the JPEG format file stored in the flash memory 220 or the memory card 240.

The MPEG CODEC 310 compresses the RAW data into an MPEG-format file, and stores the compressed data in the flash memory 220 or the memory card 240. In addition, the MPEG CODEC 318 expands the MPEG format file stored in the flash memory 220 or the memory card 240.

The SDRAM control unit 320 temporarily stores the signal transferred to elements provided in the signal processing block 300 through the signal transfer unit 322 in the SDRAM 140, reads the signal temporarily stored in the SDRAM 140, and transfers the signal read through the signal transferring unit 322 to the elements that will process the signal read through the signal transfer unit 322.

The video encoder/OSD unit 328 processes the RAW data that is the video signal to make the RAW data reproducible, and outputs the RAW data to the LCD converter 324 or the TV converter 326. Also, the video encoder/OSD unit 328 can perform an OSD process of a menu, an icon, and so forth. The video encoder/OSD unit 328 may be understood as a unit in which the video encoder and the OSD unit are integrated into one chip. However, they may be separately implemented.

The LCD converter 324 converts the output signal of the video encoder/OSD unit 328 into a signal that can be displayed on the LCD 140, and outputs the signal to the LCD 150.

The TV converter 326 converts the output signal of the video encoder/OSD unit 328 into a signal that can be displayed through a TV 250, and outputs the signal to the TV 250.

The ITU-R656 interface 330 transfers the video signal from the video decoding module 200 to the video encoder/OSD unit 328, and transfers the audio signal to a DSP audio CODEC 332 to be described later.

The DSP audio CODEC 332 encodes the audio signal with a Bit Sliced Arithmetic Code (BSAC), or BSAC-decodes the BSAC-encoded audio signal. The DSP audio CODEC 332 uses the buffer 334 to perform the BSAC encoding/decoding.

The CPU 336 controls the signal process and/or signal transmission of elements provided in the signal processing block 300 to perform the signal process suitable for a mode of the multifunctional video apparatus according to embodiments of the present general inventive concept, under the control of the control unit 210.

The ROM 338 is a memory to store programs required to control the operation of the signal processing block 300 and data.

The AD/DA/PWM/Timer 340 performs an A/D conversion, a D/A conversion, a PWM signal generation, a timer function, and so forth. The I2C unit 342 controls an I2C communication in the multifunctional video apparatus according to embodiments of the present general inventive concept.

The memory card interface 344 detects whether the memory card 240 is mounted, and stores files in the mounted memory card 240 or reads the files stored in the memory card 240.

The audio interface 346 provides an interface to transmit and/or receive audio signals between the signal processing block 300 and the DAC/ADC 160.

The I2S unit 348 converts the audio signal transferred from the DAC/ADC 160 into a Musicam format, which is a type of 12S format.

The USB interface 350 provides a USB communication interface between a USB device, such as a PC and a printer, and the multifunctional video apparatus. The SIO unit 352 provides an interface to transmit the DAB signal between the signal processing block 300 and the tuner module 190. The PLL 354 stabilizes the drive pulse generated by the OSC unit 230.

The multifunctional video apparatus according to embodiments of the present general inventive concept operates in any of a setting mode to set an operation environment, a DAB/DMB mode to receive and/or reproduce a DAB/DMB signal and to display the DAB/DMB signal on the LCD 150, a photo mode including a photograph mode to record a photograph file generated through the photographing and a photograph reproduction mode to reproduce the recorded photograph file, a moving image mode including a moving image filming mode to record a moving image file generated through the moving image filming and a moving image reproduction mode to reproduce the recorded moving image file, a music playback mode to play a music file, a voice mode to record a voice file generated through a voice recording, a PC camera mode to transfer the moving image generated through the moving image filming to a PC connected to the multifunctional video apparatus,; and a direct print mode to directly output the recorded photograph files to a printer that supports a PictBridge.

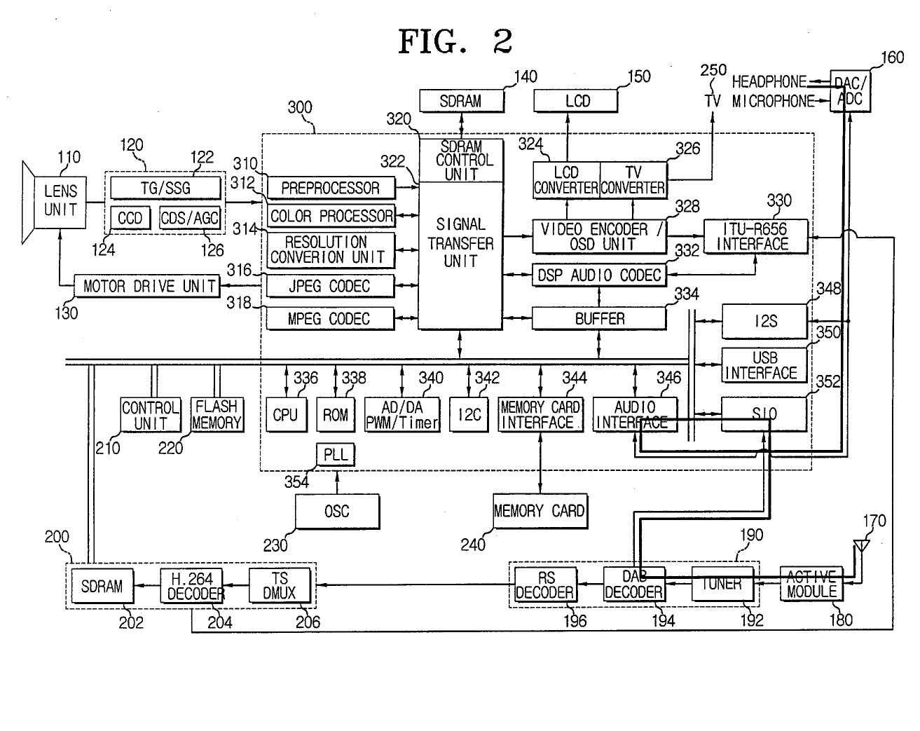

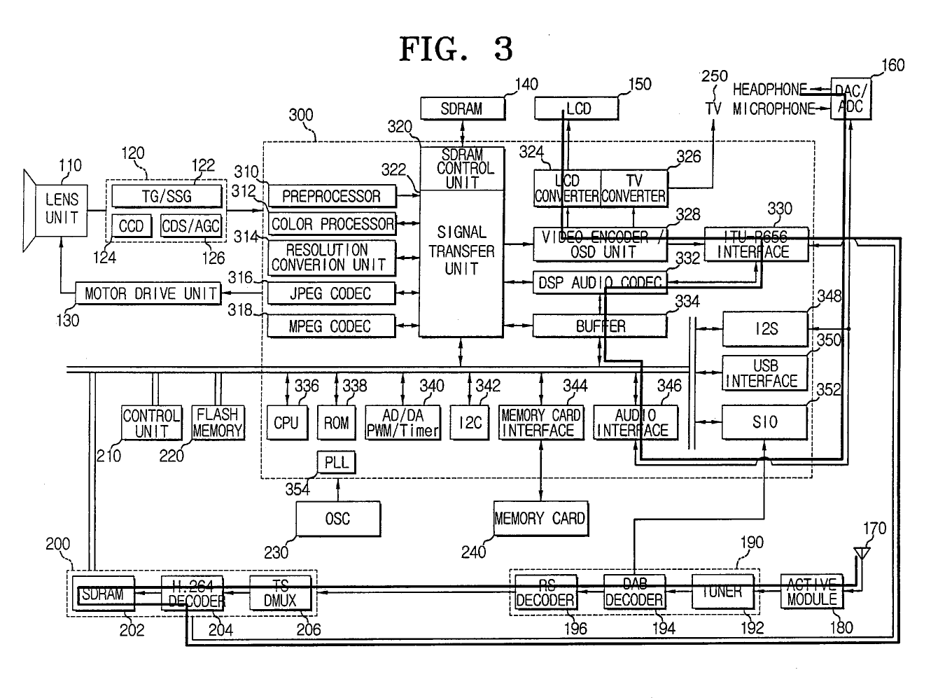

Hereinafter, the operation of the multifunctional video apparatus of FIG. 1 in a DAB receiving mode will be described in more detail with reference to FIG. 2.

As illustrated in FIGS. 1 and 2, the active module 180 performs a signal process such as an amplification, noise removal, and so forth, with respect to the DMB/DAB signal received through the antenna 170, and the tuner 192 tunes to the DAB signal provided through a channel selected by the user, and converts the DAB signal into a baseband signal.

Then, the DAB decoder 194 converts the DAB signal output from the tuner 192 into a Musicam format, which is a type of I2S format, and transfers the converted signal to the signal processing block 300.

The transferred DAB signal is output to the DAC/ADC 160 through the SIO 352 of the signal processing block 300 and the audio interface 346.

The DAC/ADC 160 converts the input digital audio signal into an analog audio signal, and outputs the analog audio signal to the externally connected headphone (not illustrated).

Accordingly, the user can listen to the DAB contents.

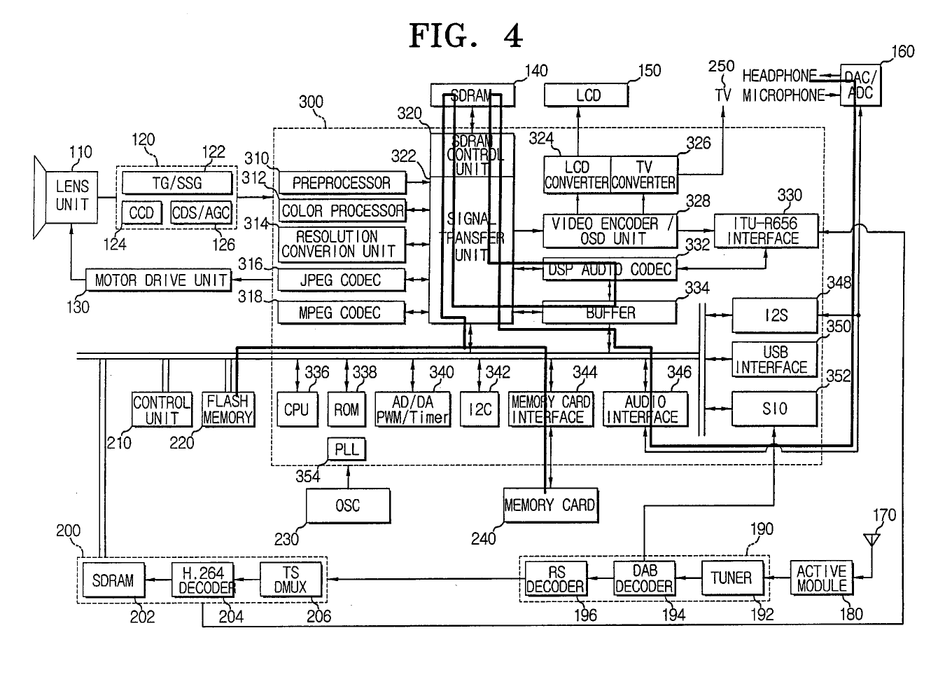

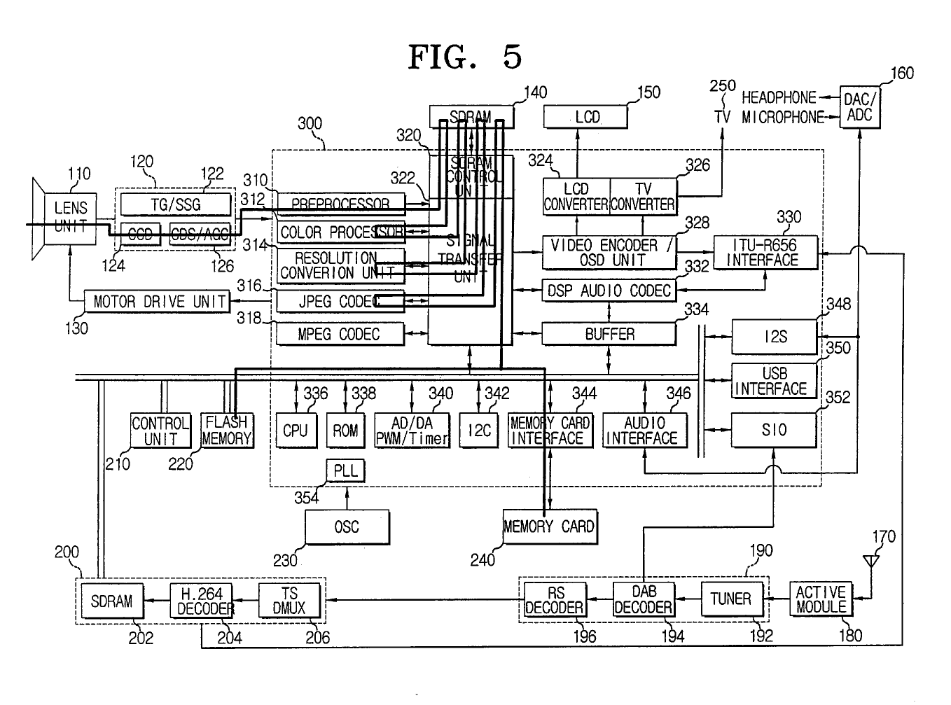

The operation of the multifunctional video apparatus of FIG. 1 in a DMB receiving mode will be described in more detail with reference to FIG. 3.

As illustrated in FIGS. 1 and 3, the active module 180 performs a signal process such as the amplification, noise removal, and so forth, with respect to the DMB/DAB signal received through the antenna 170, and the tuner 192 tunes to the DMB signal provided through a channel selected by the user, and converts the DMB signal into a baseband signal.

Then, the RS decoder 196 detects and corrects errors by performing an RS decoding on the DMB signal output from the tuner 192, and transfers the error-corrected DMB signal to the video decoding module 200. The video signal and the audio signal included in the transferred DMB signal are temporarily stored in the SDRAM 202 of a video decoding module 200.

The H.264 decoder 204 expands the video signal compressed in an H.264 format temporarily stored in the SDRAM 202, and converts the expanded video signal into an ITU-R656 format to output the converted video signal to the signal processing block 300. The TS DEMUX 206 outputs the audio signal temporarily stored in the SDRAM 202 to the signal processing block 300.

Then, the video signal is transferred to the video encoder/OSD unit 328 through the ITU-R656 interface 330 of the signal processing block 300, and the audio signal is transferred to the DSP audio CODEC 332.

The video encoder/OSD unit 328 processes and outputs the video signal to the LCD converter 324 or the TV converter 326, and thus the corresponding video is output to the LCD 150 or the TV 250.

The DSP audio CODEC 332 converts the audio signal into an I2S format. The converted audio signal is outputted to the DAC/ADC 160 through the audio interface 346.

The DAC/ADC 160 converts the input digital audio signal into an analog audio signal, and outputs the analog audio signal to an audio output element such as an externally-connected headphone.

Accordingly, the user can view the DMB contents.

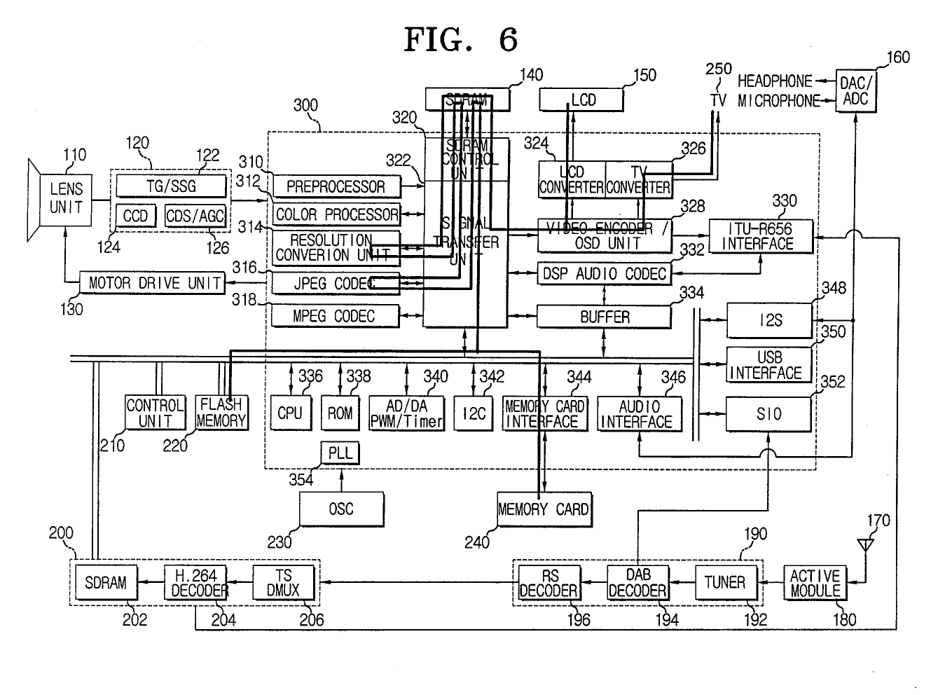

The operation of the multifunctional video apparatus of FIG. 1 in a music mode will be described in more detail with reference to FIG. 4.

Referring to FIGS. 1 and 4, the SDRAM control unit 320 temporarily stores a music file recorded in the flash memory 220 or the memory card, which is transferred through the signal transfer unit 322, in the SDRAM 140. Then, the SDRAM control unit 320 transfers the music file temporarily stored in the SDRAM 140 to the buffer 334.

The DSP audio CODEC 332 converts the music file temporarily stored in the buffer 334 into PCM data by decoding the music file, and the SDRAM control unit 320 temporarily stores the PCM data in the SDRAM 140.

Then, the PCM data temporarily stored in the SDRAM 140 is output to the DAC/ADC 160 through the audio interface 346.

The DAC/ADC 160 converts the incoming PCM data into an analog audio signal, and outputs the analog audio signal to an audio output element such as the externally connected headphone (not illustrated).

The operation of the multifunctional video apparatus in a photograph mode will be described in more detail with reference to FIG. 5.

Referring to FIGS. 1 and 5, the CCD module 120 picks up an image of an object, generates and transfers a Y/Cb/Cr signal that is an image signal to the signal processing block 300.

The preprocessor 310 of the signal processing block 300 converts the Y/Cb/Cr signal output from the CCD module 120 into a D2Y format. The converted signal is temporarily stored in the SDRAM 140 by the SDRAM control unit 320.

The color-processor 312 performs the white balancing and the gain adjustment of the D2Y-format video signal temporarily stored in the SDRAM 140, and converts the video signal of the D2Y format into RAW data. The converted signal is temporarily stored in the SDRAM 140 by the SDRAM control unit 320.

The resolution conversion unit 314 converts the resolution of the video corresponding to the RAW data temporarily stored in the SDRAM 140. The converted signal is temporarily stored in the SDRAM 140 by the SDRAM control unit 320.

The JPEG CODEC 316 compresses the RAW data temporarily stored in the SDRAM 140 into a JPEG format, and the compressed signal is temporarily stored in the SDRAM 140. Then, the compressed signal temporarily stored in the SDRAM 140 is stored in the flash memory 220 or the memory card 240 in the form of a file.

The operation of the multifunctional video apparatus in a photograph reproduction mode will be described in more detail with reference to FIG. 6.

Referring to FIGS. 1 and 6, the SDRAM control unit 320 temporarily stores a photograph file recorded in the flash memory 220 or the memory card 240, which is transferred through the signal transfer unit 322, in the SDRAM 140.

The JPEG CODEC 316 generates RAW data by expanding the file of the JPEG format, which is temporarily stored in the SDRAM 140, and temporarily stores the RAW data in the SDRAM 140.

The resolution conversion unit 314 converts the resolution of the video corresponding to the RAW data temporarily stored in the SDRAM 140 into resolution suitable for the LCD 150. The converted data is temporarily stored in the SDRAM 140 by the SDRAM control unit 320.

Then, the video encoder/ OSD unit 328 processes the data temporarily stored in the SDRAM 140 so as to make the data reproducible, and outputs the reproducible data to the LCD converter 324 or the TV controller 326, so that the corresponding video is output through the LCD 150 or the TV 250.

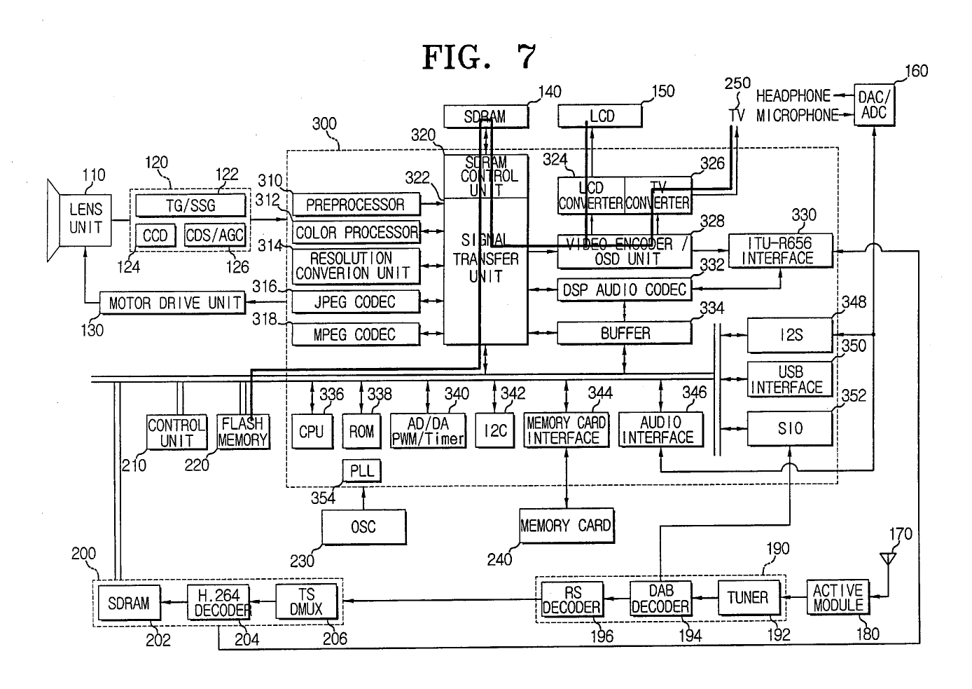

A process of providing an OSD that is performed by the multifunctional video apparatus will be described in more detail with reference to FIG. 7.

Referring to FIGS. 1 and 7, the SDRAM control unit 320 temporarily stores OSD information (e.g., menu screen, icons, and so forth) recorded in the flash memory 220, which is transferred through the signal transfer unit 322, in the SDRAM 140.

Then, the video encoder/OSD unit 328 performs an OSD process on the video to be output according to the OSD information temporarily stored in the SDRAM 328. Then, the OSD-processed video is provided to the LCD converter 324 or the TV converter 326 to be output through the LCD 150 or the TV 250.

The multifunctional video apparatus according to embodiments of the present general inventive concept may include an additional video apparatus, and may be implemented to receive other types of broadcasts in addition to the DMB/MAB broadcasts.

As described above, according to embodiments of the present general inventive concept, diverse functions such as a DMB reception, a photographing and/or reproduction, a moving image filming and/or reproduction, a music playback, a voice recording and/or reproduction, and so forth, can be provided through one apparatus, and video and audio signals can be compressed, stored, and reproduced to improve user-convenience.

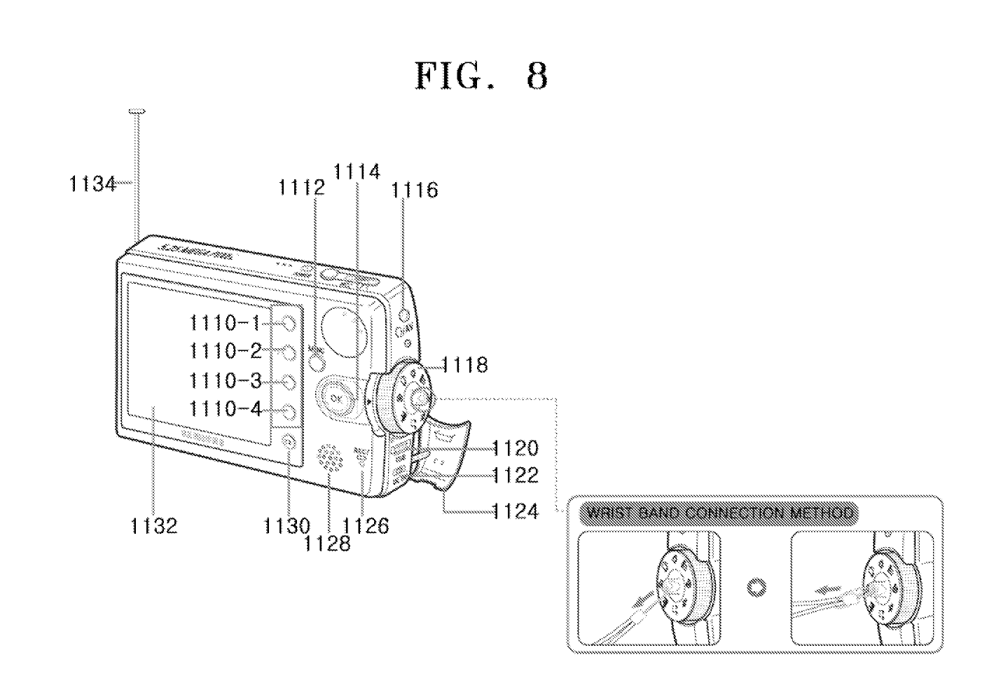

FIG. 8 is a perspective view illustrating external appearances of the multifunctional video apparatus, viewed from the rear and the left of the main body of the multifunctional video apparatus, according to exemplary embodiments of the present general inventive concept.

As illustrated in FIG. 8, a main body of the multifunctional video apparatus includes shortcut buttons 1110-1 to 1110-4, a menu button 1112, a joystick 1114, an earphone and a video/audio terminal 1116, a mode dial 1118, a USB connection terminal 1120, a DC power supply terminal 1122, a connection terminal cover 1124, a record/charge indicating lamp 1126, a built-in speaker 1128, a display button 1130, an LCD 1132, and a DMB antenna 1134.

The multifunctional video apparatus is provided with four shortcut buttons 1110-1 to 1110-4. The respective shortcut buttons are used to select the shortcut icons appearing on the right side of the LCD 1132. The shortcut icons appearing on the right side of the LCD 1132 are icons used to input call commands for the frequently used menus, or icons used to input commands for the frequently used functions. The shortcut icons displayed on the LCD 1132 may differ according to the modes of the multifunctional video apparatus, of which the details will be described later.

The menu button 1112 is a button used to input commands to call menus on the LCD 1132.

The joystick 1114 is a PUI (Physical User Interface) that the user can move up, down, left, right, or push in a direction perpendicular to the plane from which it protrudes. The joystick 1114 is used to move to a desired menu among menus displayed on the LCD 1132, or to move to a desired sub-menu among the sub-menus of the desired menu.

A command to move through a menu is inputted as the user moves the joystick 1114 right and left, and a command to move through a sub-menu is input as the user moves the joystick 1114 upward and downward. In addition, a command to select a sub-menu is input as the user pushes the joystick 1114.

The joystick 1114 may be used to adjust a volume in a moving image reproduction mode, a music playback mode, and a voice reproduction mode.

The mode dial 1118 is a PUI to select modes of the multifunctional video apparatus (e.g., functions of the multifunctional video apparatus). In the mode dial 1118, icons to guide respective modes are indicated, and the user can input a command to select a desired mode as he/she rotates the mode dial 1118 with reference to the icons.

In addition, the mode dial 1118 is provided with a wrist band connection ring. A wrist band can be connected to the wrist band connection ring as illustrated in FIG. 8. In the embodiments of the present general inventive concept, the wrist band is connected to the center of the left side of the main body of the multifunctional video apparatus. Specifically, the wrist band is connected to the center part, in which no mode guide icon is indicated, of the mode dial 1118 that is provided on the center of the left side of the main body. In addition, the wrist band connection ring is projected from the outermost part of the left side of the main body, so that the wrist band is prevented from going over to the front side of the main body, to improve user-convenience.

The display button 1130 is a button used to input a command to make icons appear on or disappear from the LCD 1132. For example, in a photograph mode, the multifunctional video apparatus makes only the shortcut icons remain on the LCD 1132 if the display button 1130 is pressed once, the multifunctional video apparatus makes only an auto focus mark remains on the LCD 1132 if the display button 1130 is pressed twice, and the multifunctional video apparatus makes the icons having disappeared from the LCD 1132 reappear on the LCD 1132 if the display button 1130 is pressed three times. As another example, in the DMB mode, the multifunctional video apparatus makes the icons disappear from the LCD 1132 if the display button 1130 is pressed once, and the multifunctional video apparatus makes the icons having disappeared from the LCD 1132 reappear on the LCD 1132 if the display button 1130 is pressed twice.

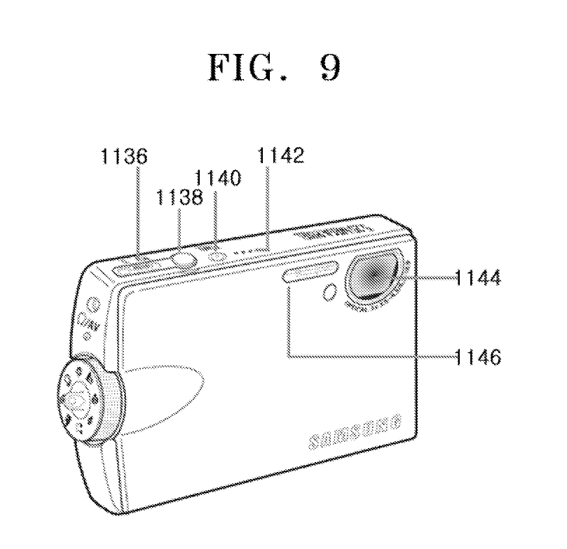

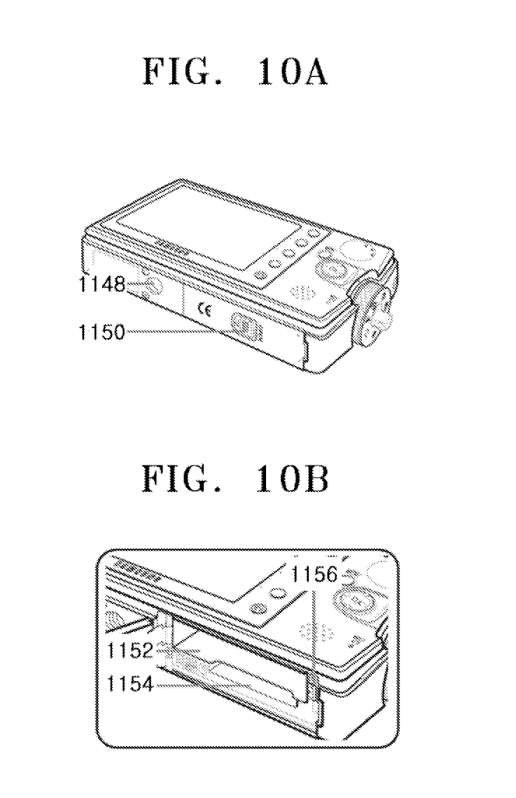

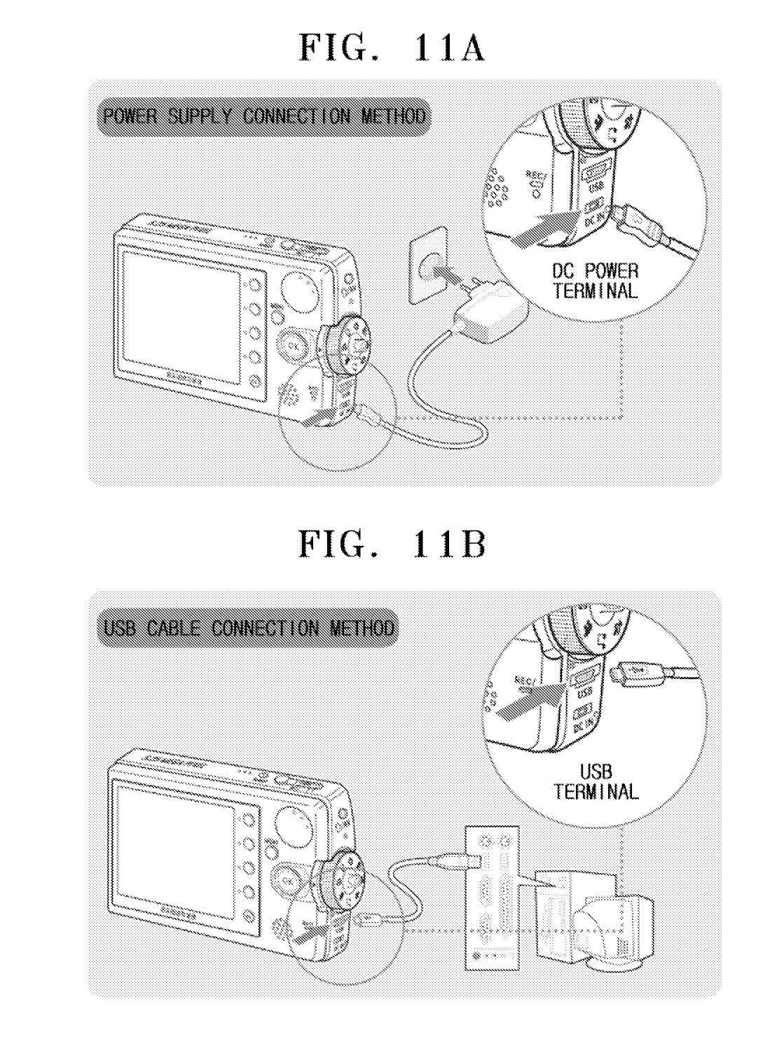

FIG. 9 is a perspective view illustrating an external appearance of the multifunctional video apparatus, viewed from the front of the main body of the multifunctional video apparatus.

As illustrated in FIG. 9, the main body of the multifunctional video apparatus is provided with a zooming switch 1136, a record start/stop button 1138, a power button 1140, a built-in microphone 1142, a lens 1144, and a built-in flash 1146.

FIGS. 10A and 10B are perspective views illustrating external appearances of the multifunctional video apparatus, viewed from the bottom of the main body of the multifunctional video apparatus.

As illustrated in FIGS. 10A and 10B, the main body of the multifunctional video apparatus is provided with a three-legged support fixing part 1148, an open type switch 1150, a battery insertion part 1152, a memory card insertion part 1154, and a battery locking lever 1156.

Referring to FIG. 8, the battery mounted in the battery insertion part 1152 can be recharged using a power supply (i.e., adapter) or a USB cable. When recharging the battery using the power supply, as illustrated in FIG. 11A, the power supply should be connected to a DC power terminal 1122 provided on the multifunctional video apparatus and to a wall outlet, respectively. When recharging the battery using the USB cable, as illustrated in FIG. 11B, the USB cable should be connected to a USB terminal 1120 provided on the multifunctional video apparatus and to a USB terminal provided on the PC, respectively.

The multifunctional video apparatus according to an embodiment of the present general inventive concept includes a built-in memory. In addition, a memory card may be mounted in the memory card insertion part 1154 of the multifunctional video apparatus. Accordingly, the multifunctional video apparatus may include two memories.

If no memory card is mounted in the memory card insertion part 1154, the multifunctional video apparatus sets the built-in memory as a base memory. The term “base memory” is a memory to record files generated in the multifunctional video apparatus and files transmitted from external apparatuses. Also, during the reproduction operation, the multifunctional video apparatus reproduces the files recorded in the base memory.

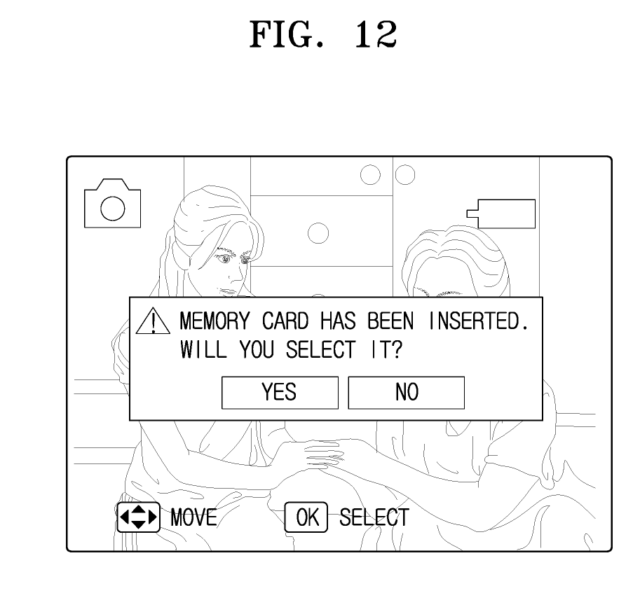

If a memory card is mounted in the memory card insertion part 1154, a menu to set the base memory is displayed on the LCD 1132. A menu screen to set the base memory, which is displayed on the LCD 1132, is illustrated in FIG. 12. If the user selects “Yes” on the menu screen as illustrated in FIG. 12, the memory card is set as the base memory, while if the user selects “No”, the built-in memory is set as the base memory.

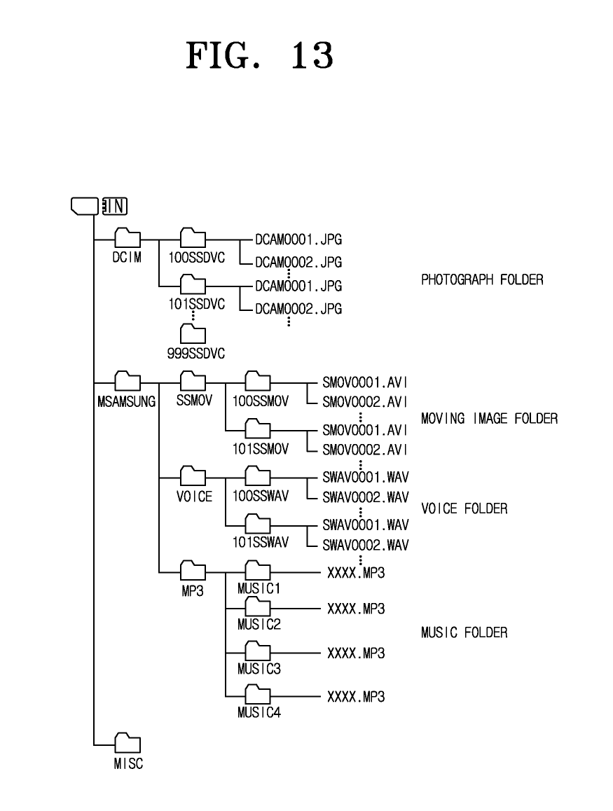

The file/folder structure of the built-in memory and the memory card is illustrated in FIG. 13. Among folders illustrated in FIG. 13, a “DCIM” folder is a photograph folder in which photograph files are recorded, an “SSMOV” folder is a moving image folder in which moving image files are recorded, a “VOICE” folder is a folder in which voice files are recorded, and an “MP3” folder is a folder in which music files are recorded.

In folders “MUSIC1” to “MUSIC4”, which are lower folders of the “MP3” folder, the user can optionally create lower folders thereof.

The modes of the multifunctional video apparatus may be classified into a setting mode, a DMB mode, a photograph mode, a moving image mode, a music playback mode, a voice mode, a PC camera mode, and a direct print mode.

Hereinafter, the operation of the multifunctional video apparatus in a setting mode will be explained in more detail. The setting mode is a mode to set an operation environment of the multifunctional video apparatus.

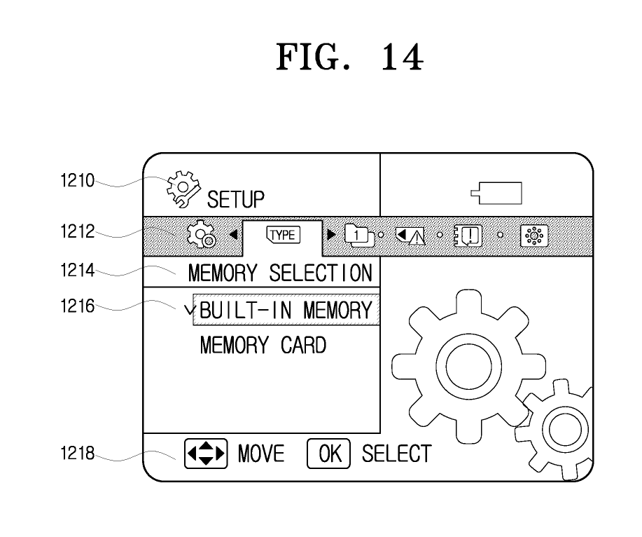

FIG. 14 illustrates the LCD 1132 of FIG. 8, where the LCD 1132 displays icons, menus, and sub-menus when the multifunctional video apparatus operates in the setting mode. As illustrated in FIG. 14, in the setting mode, a present mode guide icon 1210, icons 1212 corresponding to menus provided in a setting mode, a menu 1214 corresponding to the selected icon, sub-menus 1216 subordinate to the selected menu, and a manipulation guide icon 1218, are displayed on the LCD 1132 of the multifunctional video apparatus.

In the setting mode, the multifunctional video apparatus may adjust settings, including record memory selection, file number, memory format, provision of memory information, LCD brightness adjustment, date and time, date form, date/time display, NTSC/PAL, beep sound, shutter sound, language selection, mode screen display, automatic power-off, and initialization. The above will be described in more detail.

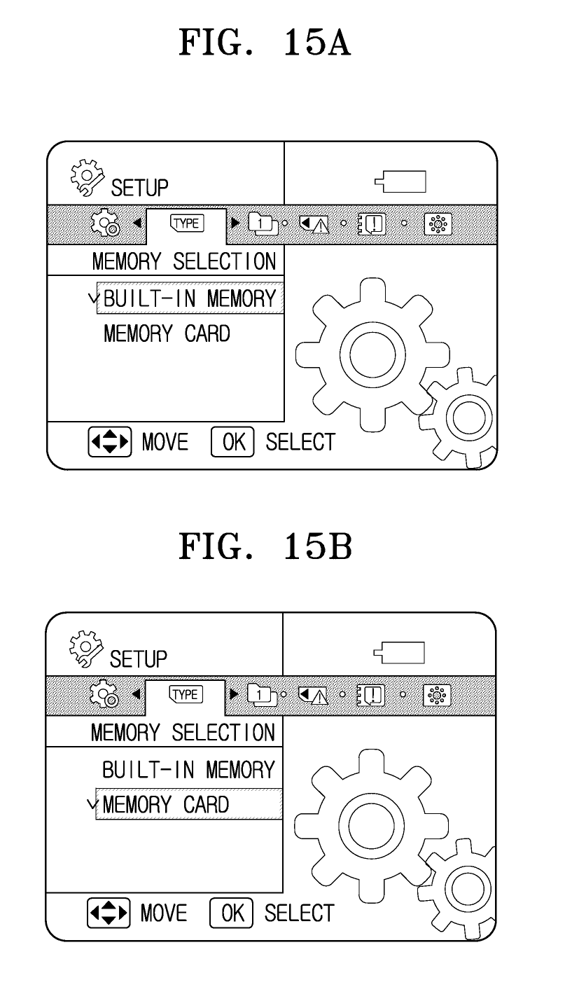

FIGS. 15A and 15B illustrate the LCD 1132 of FIG. 8, where the LCD 1132 displays a “memory selection” (e.g. record memory selection) menu and its sub-menus when the “memory selection” menu is selected. As illustrated in FIG. 15A, if the term “built-in memory” is selected, the multifunctional video apparatus sets the built-in memory so that a photograph/moving image/music/voice file is recorded in the built-in memory. In contrast, as illustrated in FIG. 15B, if the term “memory card” is selected, the multifunctional video apparatus sets the memory card so that a photograph/moving image/music/voice file is recorded in the memory card.

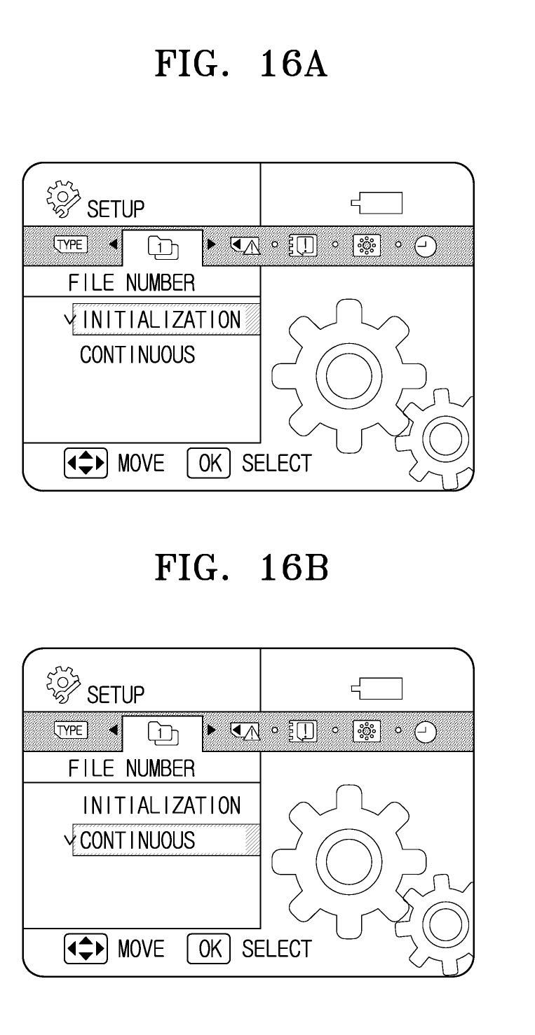

FIGS. 16A and 16B illustrate the LCD 1132 of FIG. 8, where the LCD 1132 displays a “file number” menu and its sub-menus following the selecting of the “file number” menu. As illustrated in FIG. 16A, if the term “initialization” is selected, the multifunctional video apparatus sets the record memory so that the file number starts from the basic initialization value if the recording memory is initialized. In contrast, as illustrated in FIG. 16B, if the term “continuous” is selected, the multifunctional video apparatus sets the memory card so that the file number is continuously given to follow the existing file number if the memory card is newly mounted.

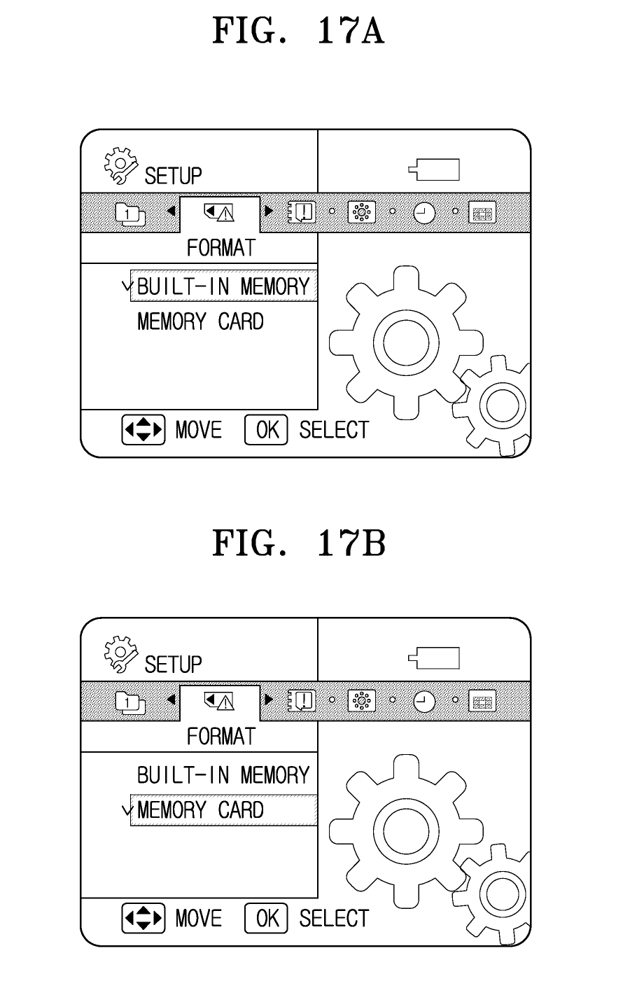

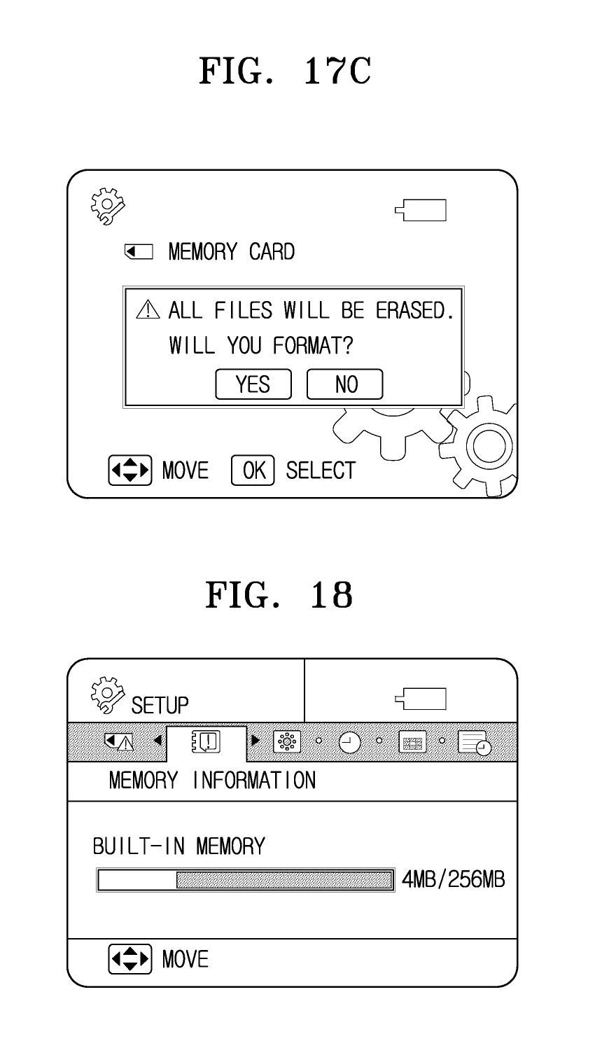

FIGS. 17A to 17C illustrate the LCD 1132 of FIG. 8, where the LCD 1132 displays a “memory format” menu and its sub-menus when the “memory format” menu is selected. As illustrated in FIG. 17A, if the term “built-in memory” is selected, the multifunctional video apparatus formats the built-in memory. In contrast, as illustrated in FIG. 17B, if the term “memory card” is selected, the multifunctional video apparatus formats the memory card. As illustrated in FIG. 17C, before formatting the selected memory, the multifunctional video apparatus may display a warning expression notifying that “all files will be erased” if the memory is formatted, and a confirming expression asking the user “will you format?.”

FIG. 18 illustrates the LCD 1132 of FIG. 8, where the LCD 1132 displays a “memory information” (e.g. memory information providing) menu and its sub-menus as the “memory information” menu is selected. As illustrated in FIG. 18, the multifunctional video apparatus provides the memory information to the user by displaying a used memory capacity and the total memory capacity on the LCD 1132.

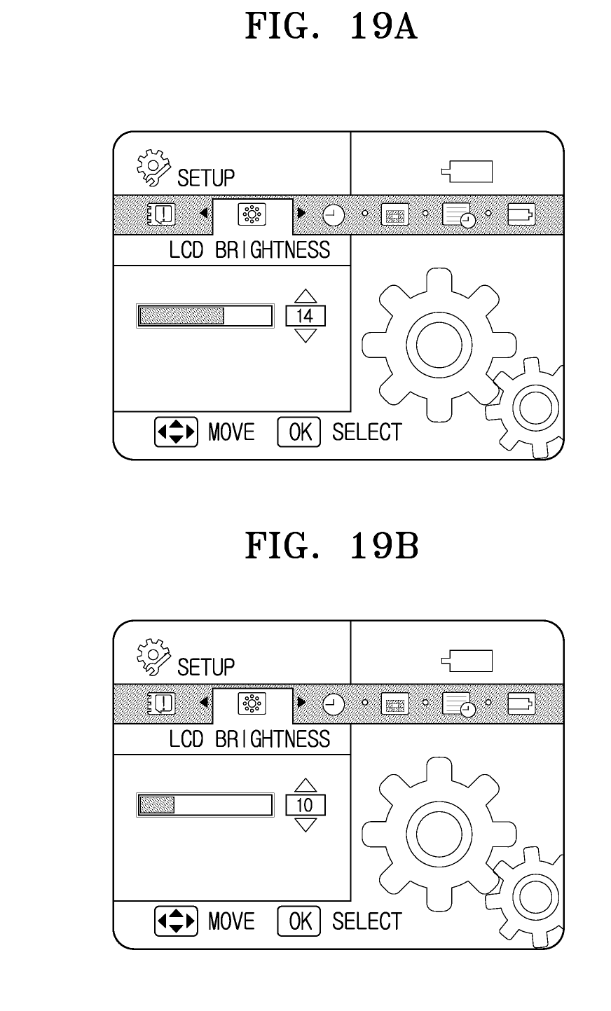

FIGS. 19A and 19B illustrate the LCD 1132 of FIG. 8, where the LCD 1132 displays an “LCD brightness” (e.g. LCD brightness adjustment) menu and its sub-menus as the “LCD brightness” menus is selected. If the LCD brightness adjustment is made through the displayed sub-menus, the multifunctional video apparatus adjusts the brightness of the LCD accordingly. For example, as illustrated in FIGS. 19A and 19B, if the “LCD brightness” is adjusted from “14” to “10” through the displayed items, the multifunctional video apparatus adjusts the brightness of the LCD 1132 from “14” to “10”. The adjustment of the LCD brightness is performed by moving the joystick 1114 of FIG. 8 upward and/or downward, and the selection of the adjusted brightness is performed by pushing the joystick 1114.

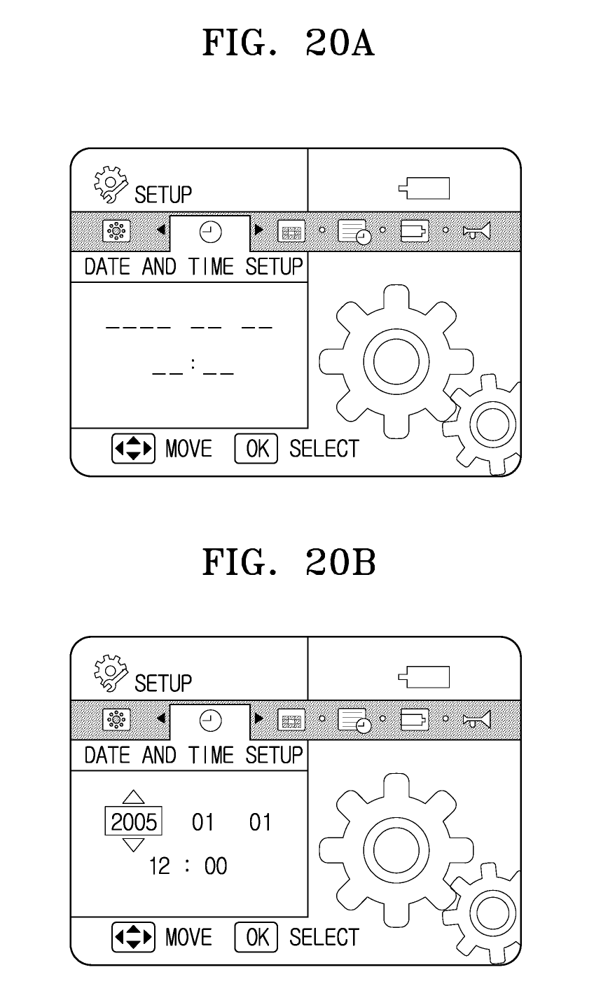

FIGS. 20A and 20B illustrate the LCD 1132 of FIG. 8, where the LCD 1132 displays a “date and time setup” menu and its sub-menus as the “date and time setup” menu is selected. If the date and time are inputted through the displayed sub-menus, the multifunctional video apparatus sets the date and time in accordance with the inputted date and time. The input of the date and time can be made through the joystick 1114 of FIG. 8.

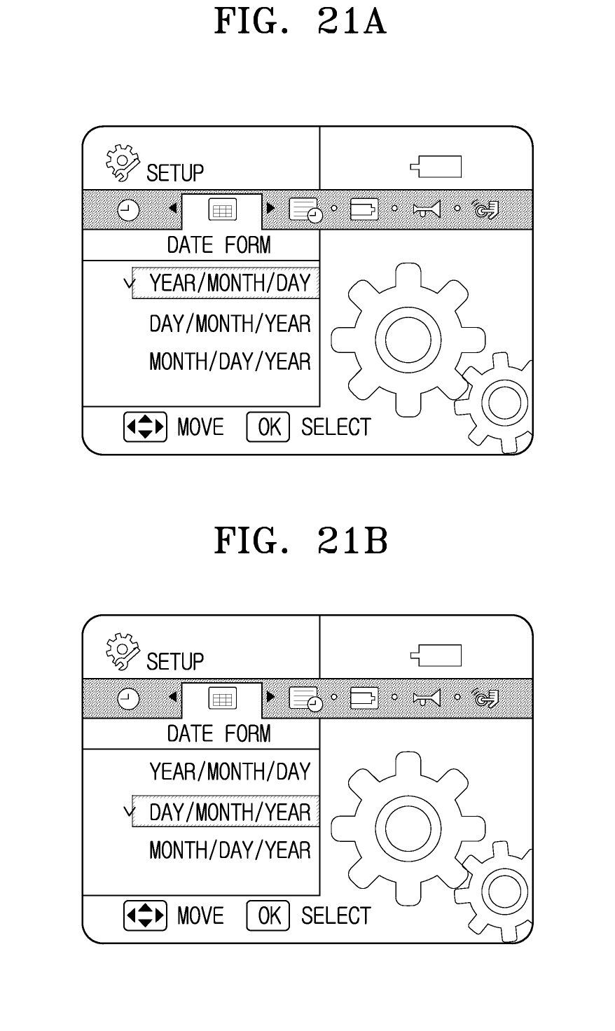

FIGS. 21A and 21B illustrate the LCD 1132 of FIG. 8, where the LCD 1132 displays a “date form” menu and its sub-menus following the selecting of the “date form” menu. As illustrated in FIG. 21A, if a term “year/month/day” is selected, the multifunctional video apparatus displays the date in the order of year, month, and day. In contrast, as illustrated in FIG. 21B, if “day/month/year” is selected, the multifunctional video apparatus displays the date in the order of day, month, and year. In contrast, if “month/day/year” is selected, the multifunctional video apparatus displays the date in the order of month, day, and year.

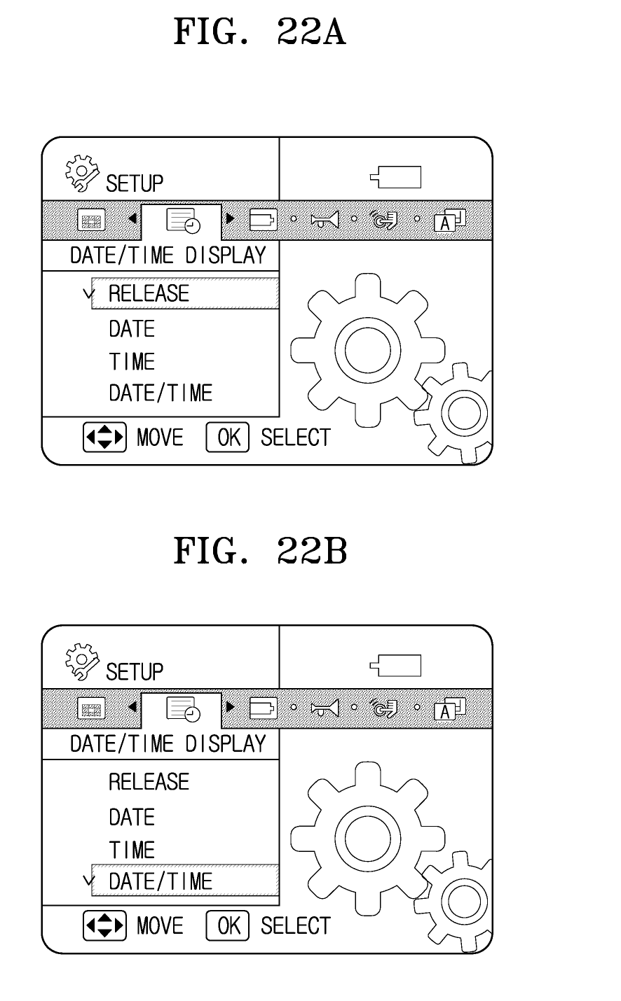

FIGS. 22A and 22B illustrate the LCD 1132 of FIG. 8, where the LCD 1132 displays a “date/time display” menu and its sub-menus following the selecting of the “date/time display” menu. As illustrated in FIG. 22A, if a term “release” is selected, the multifunctional video apparatus does not display the date and the time on the LCD 1132. In contrast, as illustrated in FIG. 22B, if “date/time” is selected, the multifunctional video apparatus displays both the date and the time. In contrast, if “date” is selected, the multifunctional video apparatus displays the date only on the LCD 1132, while if “time” is selected, the multifunctional video apparatus displays the time only on the LCD 1132.

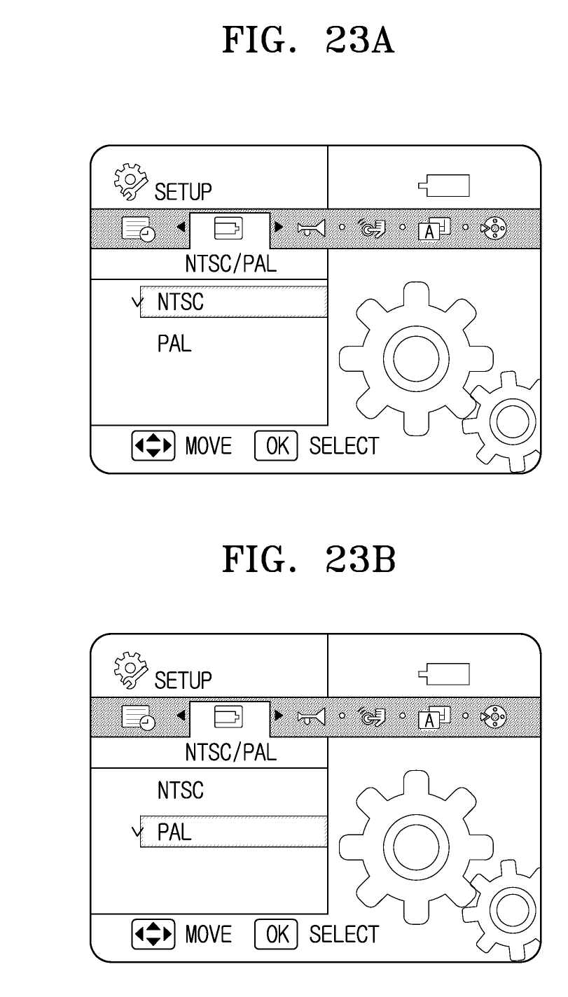

FIGS. 23A and 23B illustrate the LCD 1132 of FIG. 8, where the LCD 1132 displays a “NTSC/PAL” menu and its sub-menus following the selecting of the “NTSC/PAL” menu. As illustrated in FIG. 23A, if “NTSC” is selected, the multifunctional video apparatus outputs an NTSC type video signal, while if “PAL” is selected, it outputs a PAL type video signal.

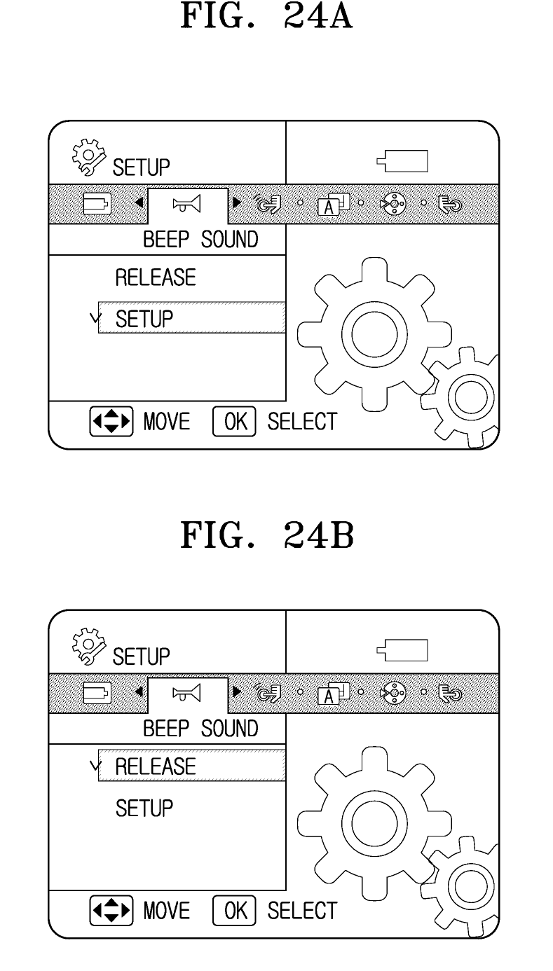

FIGS. 24A and 24B illustrate the LCD 1132 of FIG. 8, where the LCD 1132 displays a “beep sound” menu and its sub-menus following the selecting of the “beep sound” menu. As illustrated in FIG. 24A, if “setup” is selected, the multifunctional video apparatus sets the beep sound (e.g., sound produced during a button manipulation) to be outputted. In contrast, as illustrated in FIG. 24B, if “release” is selected, the multifunctional video apparatus sets the beep sound not to be outputted.

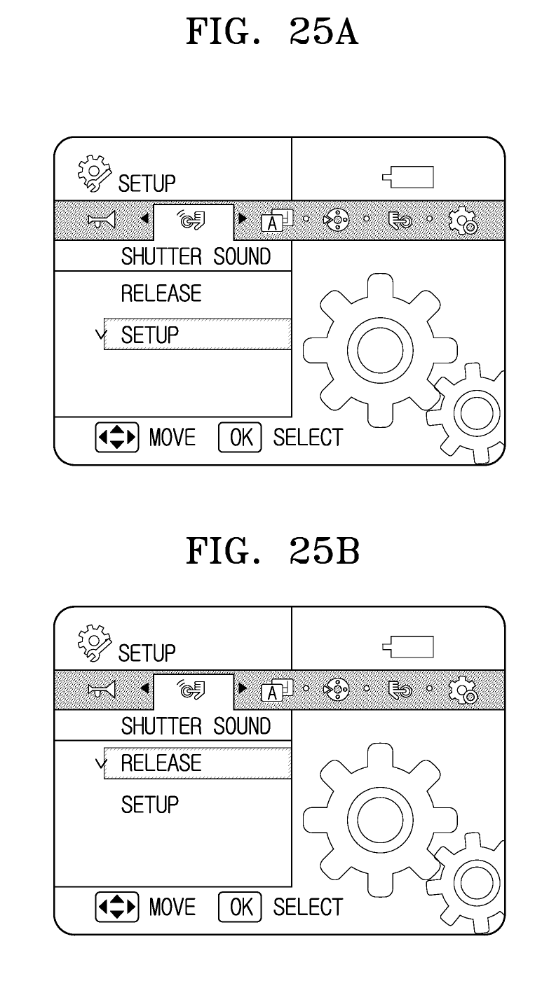

FIGS. 25A and 25B illustrate the LCD 1132 of FIG. 8, where the LCD 1132 displays a “shutter sound” menu and its sub-menus following the selecting of the “shutter sound” menu. As illustrated in FIG. 25A, if “setup” is selected, the multifunctional video apparatus sets the shutter sound (e.g., sound produced when the shutter is pressed) to be outputted. In contrast, as illustrated in FIG. 25B, if “release” is selected, the multifunctional video apparatus sets the shutter sound not to be outputted.

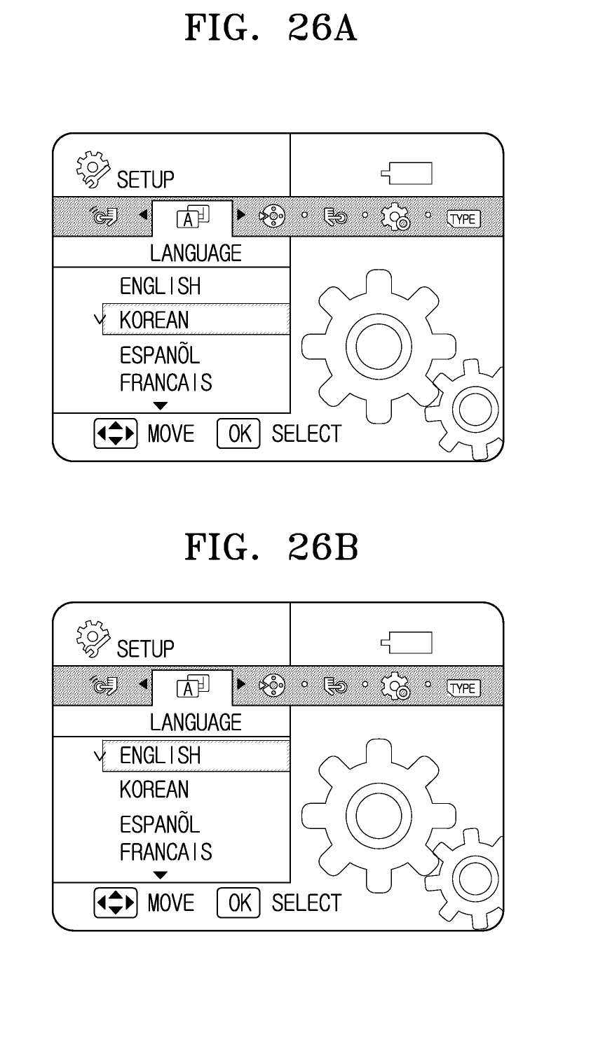

FIGS. 26A and 26B illustrate the LCD 1132 of FIG. 8, where the LCD 1132 displays a “language” (e.g. language selection) menu and its sub-menus following the selecting of the “language” menu. As illustrated in FIG. 26A, if “Korean” is selected, the multifunctional video apparatus displays menus and messages appearing on the LCD 1132 in Korean. In contrast, as illustrated in FIG. 26B, if “English” is selected, the multifunctional video apparatus displays menus and messages appearing on the LCD 1132 in English.

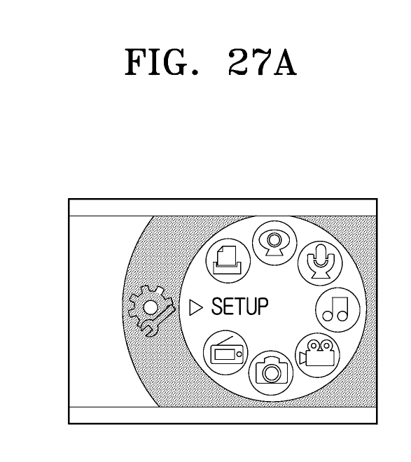

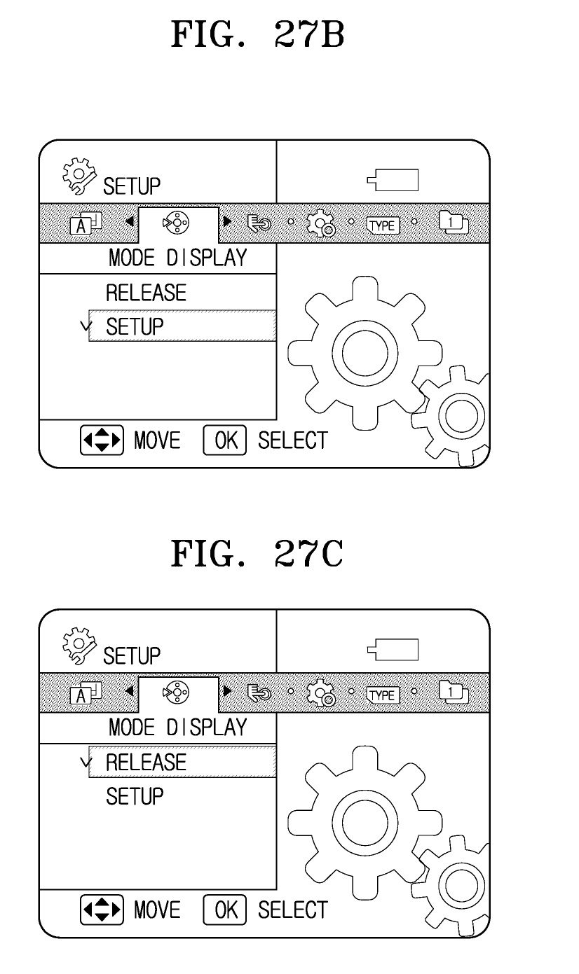

FIGS. 27A to 27C illustrate the LCD 1132 of FIG. 8, where the LCD 1132 displays a “mode screen display” menu and its sub-menus following the selecting of the “mode screen display” menu. As illustrated in FIG. 27B, if “setup” is selected, the multifunctional video apparatus displays a mode screen to guide a changed mode when the mode is changed on the LCD 1132. FIG. 27A illustrates a mode screen displayed on the LCD 1132 when the multifunctional video apparatus changes the mode to a setup mode. In contrast, as illustrated in FIG. 27C, if “release” is selected, the multifunctional video apparatus does not display the mode screen on the LCD 1132 although the mode is changed.

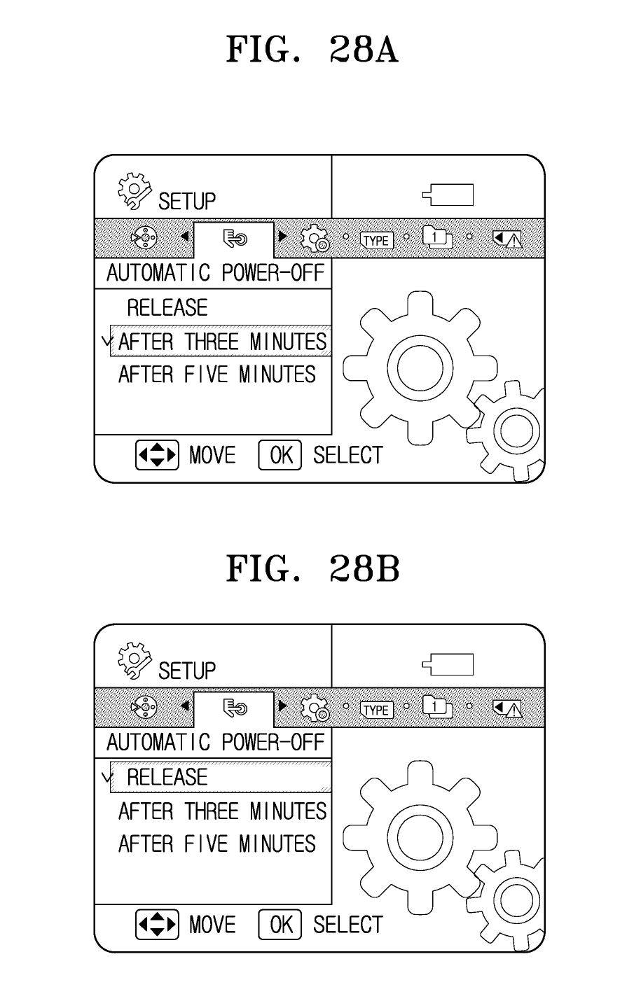

FIGS. 28A and 28B illustrate the LCD 1132 of FIG. 8, where the LCD 1132 displays an “automatic power-off” menu and its sub-menus following the selecting of the “automatic power-off” menu. As illustrated in FIG. 28A, if “after three minutes” is selected, the multifunctional video apparatus automatically turns off the power when three minutes elapse without any button manipulation. In contrast, as illustrated in FIG. 28B, if “release” is selected, the multifunctional video apparatus does not turn off the power even if no button is manipulated for a long time. In contrast, if “after five minutes” is selected, the multifunctional video apparatus automatically turns off the power when five minutes elapse without any button manipulation.

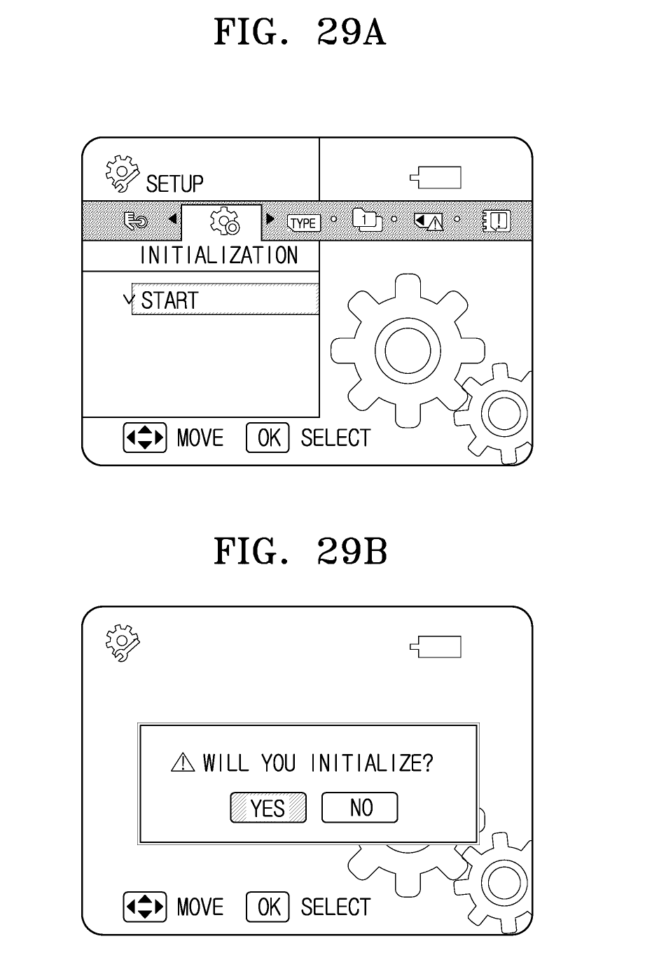

FIGS. 29A and 29B illustrate the LCD 1132 of FIG. 8, where the LCD 1132 displays an “initialization” menu and its sub-menus following the selecting of the “initialization” menu. If “yes” is selected in an initialization execution confirming message as illustrated in FIG. 29B, which is provided through the LCD when “start” is selected as illustrated in FIG. 29A, the multifunctional video apparatus sets all operation environments to an initial environment.

Operation of the multifunctional video apparatus in a DMB mode will be explained in more detail. The DMB mode is a mode in which the multifunctional video apparatus receives/reproduces a DMB or DAB signal and displays the received/reproduced DMB or DAB signal on the LCD 1132 of FIG. 8.

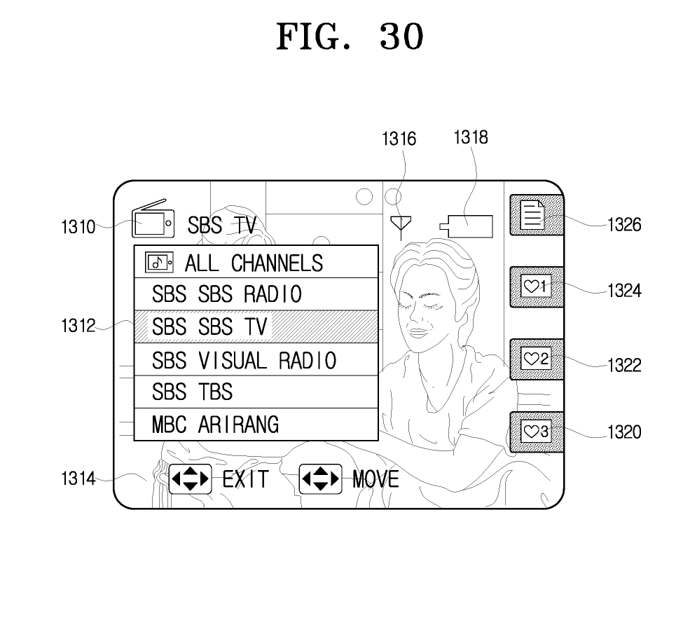

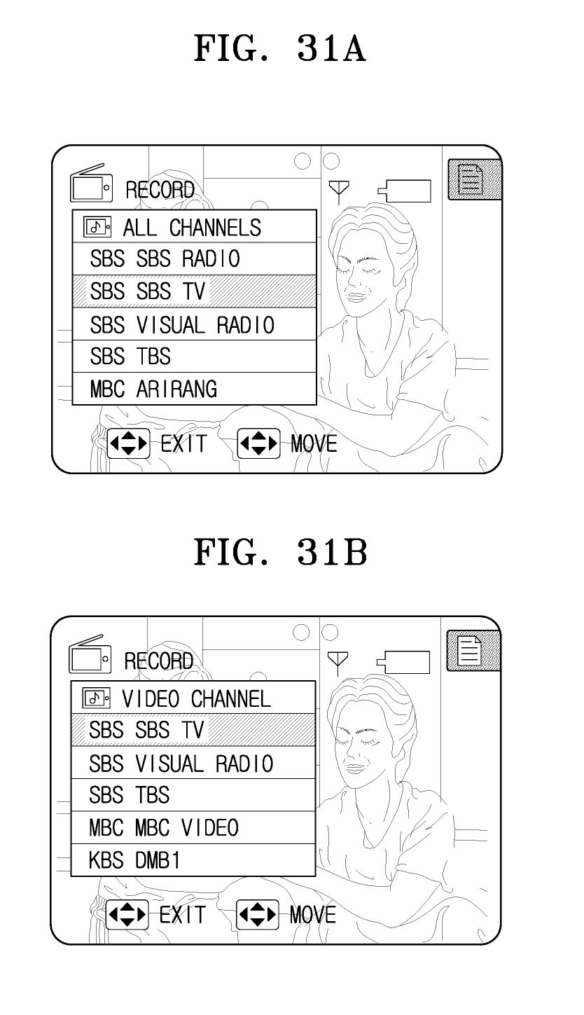

When the multifunctional video apparatus operates in the DMB mode, icons and channel list that can be displayed on the LCD 1132 of FIG. 8 are illustrated in FIG. 30. As illustrated in FIG. 30, in the DMB mode, a present mode guide icon/viewing channel guide text 1310, a channel list 1312, a manipulation guide icon 1314, receiving sensitivity icon 1316, a battery state icon 1318, a preference channel 3 shortcut icon 1320, a preference channel 2 shortcut icon 1322, a preference channel 1 shortcut icon 1324, and a channel list shortcut icon 1326, are displayed on the LCD 1132 of the multifunctional video apparatus.

If the DMB mode is selected first, the multifunctional video apparatus automatically searches for receivable channels and produces a channel list. In contrast, if the DMB mode is selected thereafter, the multifunctional video apparatus receives/reproduces the DMB service provided through a finally viewed channel, and displays the received/reproduced DMB service on the LCD 1132.

Whenever a shortcut button-1 1110-1 of FIG. 8 that is used to select the channel list shortcut icon 1326 is pressed, the multifunctional video apparatus repeats display of a whole channel list, display of a video channel list, display of an audio channel list, and non-display of a channel list (i.e., display of a DMB service provided through the viewing channel).

Here, the whole channel list is a list of receivable channels of all broadcasting stations that provide the DMB service, the video channel list is a list of video channels among all the channels, and the audio channel list is a list of audio channels among all the channels.

FIG. 31A illustrates the whole channel list that is displayed on the left part of the LCD 1132 of FIG. 8 when the shortcut button-1 1110-1 of FIG. 8 is pressed once, and FIG. 31B illustrates the video channel list that is displayed on the LCD 1132 when the shortcut button-1 1110-1 is pressed once more.

If a user selects a desired channel through an upward/downward manipulation of the joystick 1114 of FIG. 8 in a state that the channel list is displayed on the LCD 1132, the multifunctional video apparatus receives/reproduces a DMB service provided through the selected channel, and displays the received/reproduced DMB service on the LCD 1132. Then, the multifunctional video apparatus makes the displayed channel list disappear from the LCD 1132.

The channel selection can be made using the joystick 1114 even if the DMB service is displayed on the LCD 1132. Specifically, if the joystick 1114 is manipulated left and/or right in a state that the DMB service is displayed on the LCD 1132, the multifunctional video apparatus receives/reproduces the DMB service provided through the previous/next channel, and displays the received/reproduced DMB service on the LCD 1132.

If the shortcut button-2 1110-2 of FIG. 8 used to select the preference channel-1 shortcut icon 1324 of FIG. 30 is pressed quickly, the multifunctional video apparatus displays the DMB service provided through the preference channel-1 on the LCD 1132. Also, if the shortcut button-3 1110-3 of FIG. 8 used to select the preference channel-2 shortcut icon 1322 of FIG. 30 is pressed quickly, the multifunctional video apparatus displays the DMB service provided through the preference channel-2 on the LCD 1132. In addition, if the shortcut button-4 1110-4 of FIG. 8 used to select the preference channel-3 shortcut icon 1320 of FIG. 30 is pressed quickly, the multifunctional video apparatus displays the DMB service provided through the preference channel-3 on the LCD 1132.

The preference channels are changeable. Specifically, if the shortcut button is pressed for a long period of time, the multifunctional video apparatus registers the present viewing channel as the preference channel for the shortcut button. For example, if the shortcut button-2 1110-2 is pressed for a long period of time during viewing of “A” channel, the multifunctional video apparatus registers “A” channel as the preference channel for the shortcut button-2 1110-2. If the preference channel is registered, the multifunctional video apparatus displays a message reporting that the present channel has been registered as the preference channel on the LCD 1132.

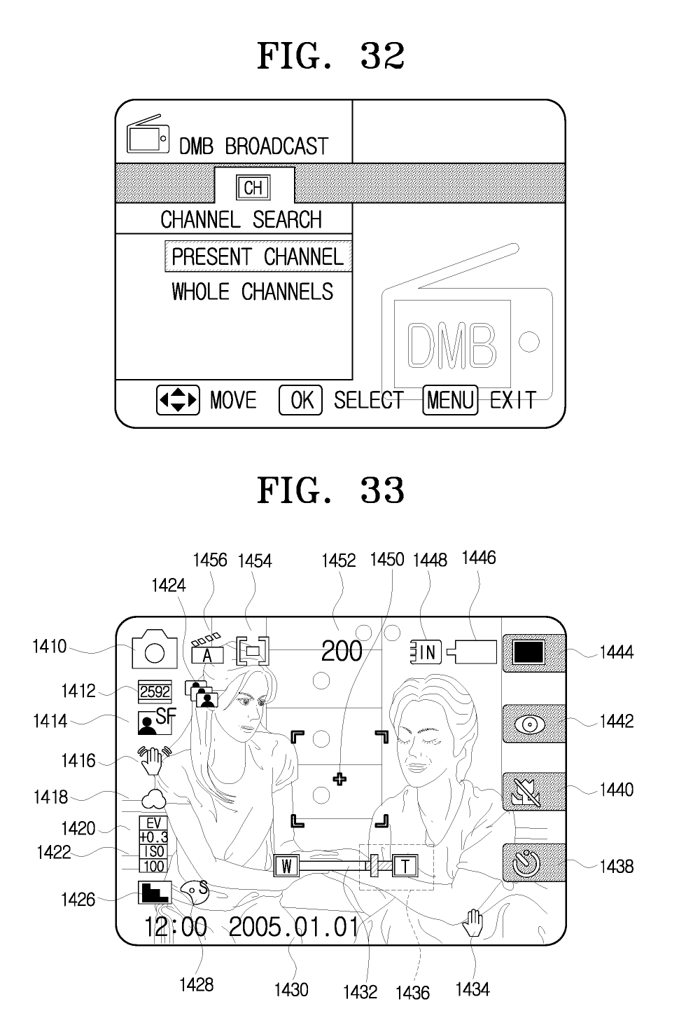

In the DMB mode, the multifunctional video apparatus can perform a channel search. FIG. 32 illustrates the LCD 1132 of FIG. 8, where the LCD 1132 displays a “channel search” menu and its sub-menus following the selecting of the “channel search” menu. If “present channel” is selected, as illustrated in FIG. 32, the multifunctional video apparatus searches for receivable channels among broadcasting channels that are presently received. In contrast, if “whole channels” is selected, the multifunctional video apparatus searches for receivable channels of all broadcasting stations providing the DMB service.

Operation of the multifunctional video apparatus in a photograph mode will be explained in more detail. The photograph mode is divided into a photograph mode in which the multifunctional video apparatus records photograph files created through the photographing in a memory (e.g., a built-in memory or memory card), and a photograph reproduction mode to reproduce a photograph file recorded in the memory and displaying the reproduced photograph files on the LCD 1132. Each mode will now be described in more detail.

When the multifunctional video apparatus operates in the photograph mode, icons that can be displayed on the LCD 1132 of FIG. 8 are illustrated in FIG. 33. As illustrated in FIG. 33, icons displayed in the photograph mode may include a present mode guide icon 1410, a photograph size guide icon 1412, a photograph quality guide icon 1414, a still-life compensation guide icon 1416, a white balance guide icon 1418, an EV guide icon 1420, an ISO photosensitivity guide icon 1422, a continuous shooting mode guide icon 1424, definition guide icon 1426, a digital effect guide icon 1428, a date/time guide icon 1430, a zoom in/out guide icon 1432, a shake compensation warning guide icon 1434, a digital zoom guide icon 1436, an automatic timer setting shortcut icon 1438, a macro setting shortcut icon 1440, a flash setting shortcut icon 1442, a photographing/reproduction switchover shortcut icon 1444, a battery state guide icon 1446, a record memory guide icon 1448, a focus guide icon 1450, a possible photographing frequency guide icon 1452, a photometry guide icon 1454, a scene mode guide icon 1456.

In the photograph mode, if the record start/stop button 1138 of FIG. 8 is slightly pressed, the multifunctional video apparatus automatically sets the focus and exposure. When the focus and the exposure are set, the multifunctional video apparatus changes the color of an auto focus mark being displayed on the LCD 1132 from red to green.

Then, if the record start/end button 1138 is fully pressed, the multifunctional video apparatus performs the photographing by operating a shutter.

If the zoom switch 1136 of FIG. 8 is pushed in a “Wide” direction, the multifunctional video apparatus performs the zoom out to display the object being gradually reduced. In contrast, if the zoom switch is pushed in a “Tele” direction, the multifunctional video apparatus performs the zoom in to display the object being gradually enlarged.

In the photograph mode, the multifunctional video apparatus may adjust settings including scene mode, photo size, photo quality, photometry, automatic timer, continuous shooting mode, digital effect, manual exposure, ISO photosensitivity, white balance, macro, flash, clearness, focus, still-life compensation, digital zoom, and date/time record. Hereinafter, the respective setting functions will be described in more detail.

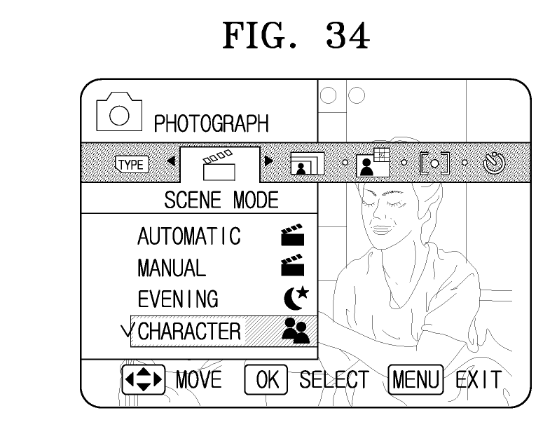

FIG. 34 illustrates the LCD 1132 of FIG. 8, where the LCD 1132 displays a “scene mode” menu and its sub-menus. As illustrated in FIG. 34, if “character” is selected, the multifunctional video apparatus sets a character mode. The character mode is a mode suitable to photograph a centered character or a centered character and scene. When the settings are completed, the multifunctional video apparatus displays an icon to guide the set scene mode on the LCD 1132.

In addition, the scene mode includes an automatic mode, a manual mode to release the scene mode selection, an evening mode to allow images to be seen during early evening or in dark places, a children mode suitable to instantaneously capture figures of children having great motions, a scene mode suitable to take scenery pictures in which green trees, blue skies, etc., are emphasized, a proximity photograph mode suitable closely photograph flowers, insects, or small objects, a sunset mode suitable to photograph the evening glow at dusk, a dawn mode suitable to photograph figures at dawn, a backlight mode suitable to photograph an image without casting a shadow during the photographing against a light, a firework mode suitable to photograph a fireworks display, and a beach/snow scene mode suitable to photograph the sea or lake in clear weather, a sandy plain, a snowy scene, etc. If a manual mode is set, the multifunctional video apparatus does not display a guide icon on the LCD 1132.

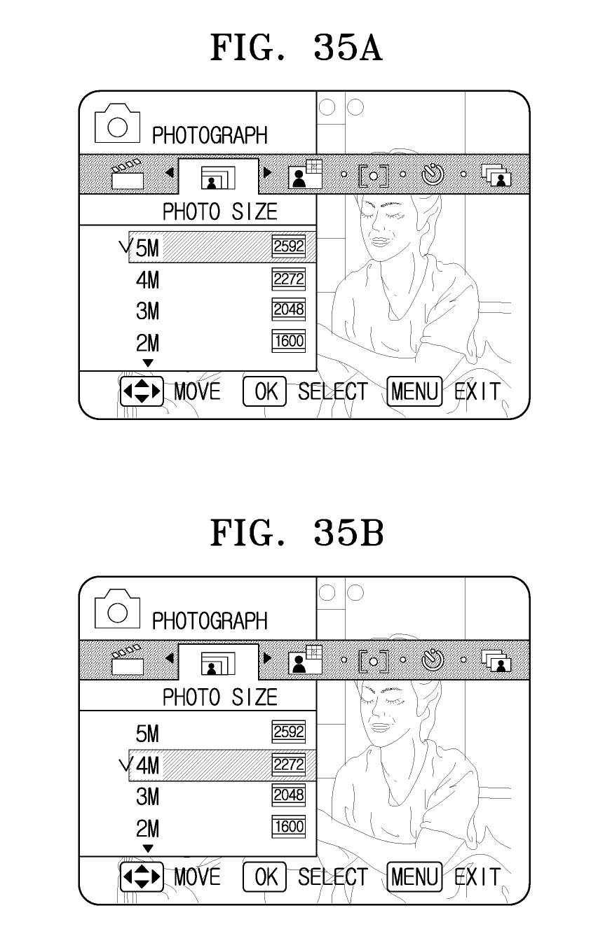

FIGS. 35A and 35B illustrate the LCD 1132 of FIG. 8, where the LCD 1132 displays a “photo size” menu and its sub-menus following the selecting of the “photo size” menu. If “5M” is selected as illustrated in FIG. 35A, the multifunctional video apparatus sets the photo size to “2592”. If “4M” is selected as illustrated in FIG. 35B, the multifunctional video apparatus sets the photo size to “2272”. If the settings are completed, the multifunctional video apparatus displays an icon to guide the set photo size on the LCD 1132.

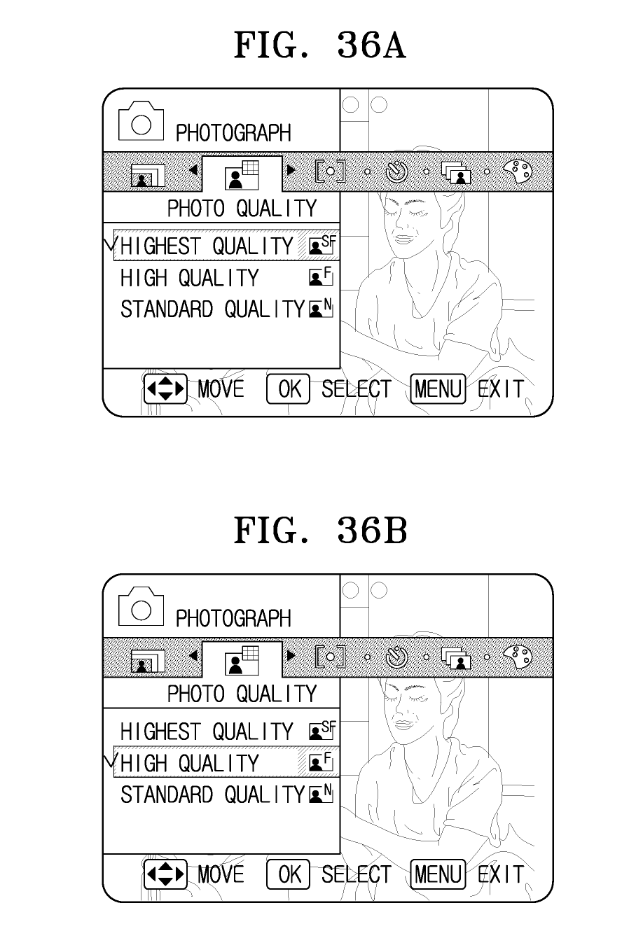

FIGS. 36A and 36B illustrate the LCD 1132 of FIG. 8, where the LCD 1132 displays a “photo quality” menu and its sub-menus following the selecting of the “photo quality” menu. If “highest quality” is selected as illustrated in FIG. 36A, the multifunctional video apparatus sets the quality of the photo to the highest grade. If “high quality” is selected as illustrated in FIG. 36B, the multifunctional video apparatus sets the photo quality to a high quality. In contrast, if “standard quality” is selected, the multifunctional video apparatus sets the photo quality to a standard quality. If the settings are completed, the multifunctional video apparatus displays an icon to guide the set photo quality on the LCD 1132.

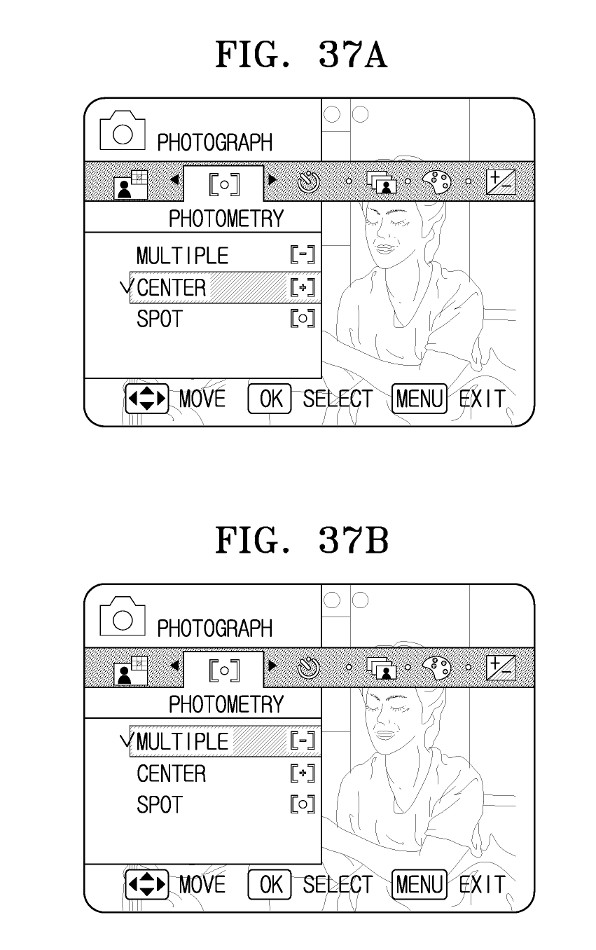

FIGS. 37A and 37B illustrate the LCD 1132 of FIG. 8, where the LCD 1132 displays a “photometry” menu and its sub-menus following the selecting of the “photometry” menu. If “center” is selected as illustrated in FIG. 37A, the multifunctional video apparatus sets to perform photometry only on a region illustrated in a square of the center part of the LCD 1132. This is suitable when a center object is accurately exposed irrespective of the background lighting. In contrast, if “multiple” is selected as illustrated in FIG. 37B, the multifunctional video apparatus divides the screen into several parts and determines a balanced exposure value around the center part, based on the brightness information by divided parts. This is suitable in most cases. In contrast, “spot” is suitable for an accurate photometry of an object in the event that the neighborhood of the object is bright. If the settings are completed, the multifunctional video apparatus displays an icon to guide the set photometry on the LCD 1132.

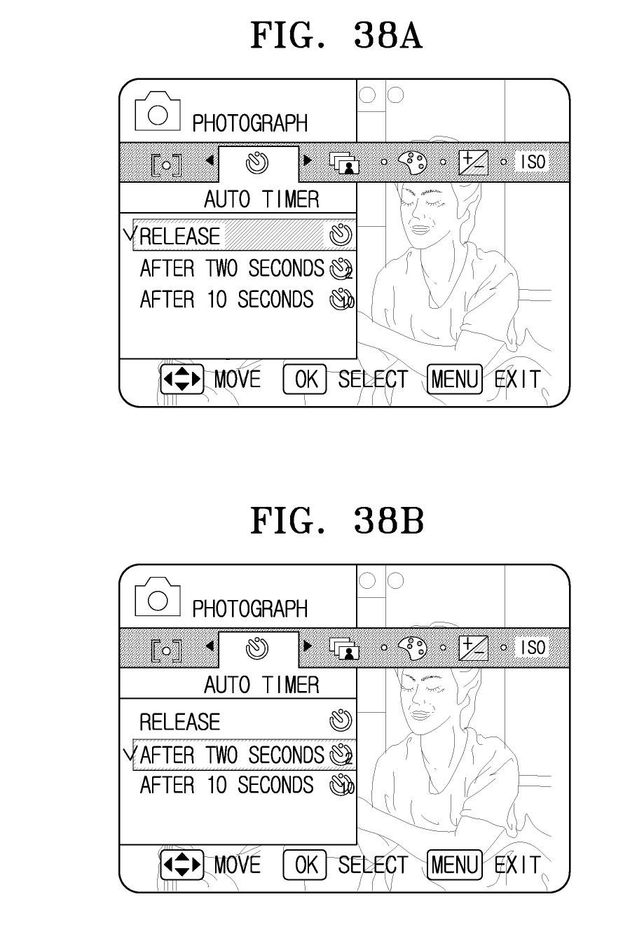

FIGS. 38A and 38B illustrated the LCD 1132 of FIG. 8, where the LCD 1132 displays an “auto timer” (e.g. automatic time) menu and its sub-menus following the selecting of the “auto timer” menu. If “release” is selected as illustrated in FIG. 38A, the multifunctional video apparatus releases the automatic timer function. In contrast, if “after two seconds” is selected as illustrated in FIG. 38B, the multifunctional video apparatus takes a photograph when two seconds elapse after the record start/stop button 1138 of FIG. 8 is pressed. If “after 10 seconds” is selected, the multifunctional video apparatus takes a photograph when 10 seconds elapses after the recording start/stop button 1138 is pressed. If the settings are completed, the multifunctional video apparatus displays an icon to guide the set automatic timer on the LCD 1132. If “release” is set, no icon is displayed. In contrast, the automatic timer can be set in accordance with the manipulation frequency of the shortcut button-4 1110-4 of FIG. 8.

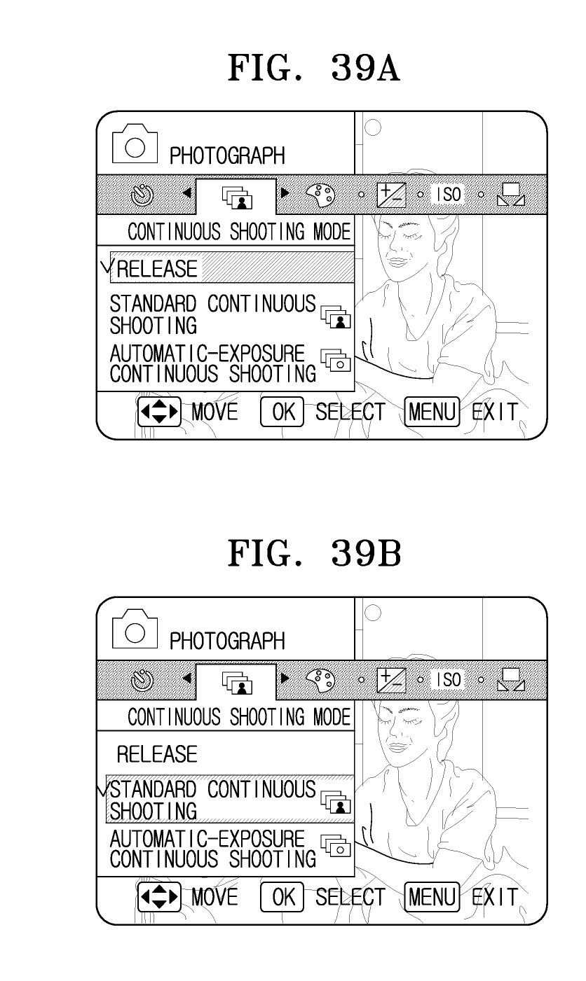

FIGS. 39A and 39B illustrate the LCD 1132 of FIG. 8, where the LCD 1132 displays a “continuous shooting mode” (e.g. continuous mode) menu and its sub-menus following the selecting of the “continuous shooting mode” menu. If “release” is selected as illustrated in FIG. 39A, the multifunctional video apparatus takes a photograph in a normal mode. In contrast, if “standard continuous shooting” is selected as illustrated in FIG. 39B, the multifunctional video apparatus performs a three-cut continuous shooting. In contrast, if “automatic-exposure continuous shooting” is selected, the multifunctional video apparatus performs a three-cut continuous shooting with different exposure value. If the settings are completed, the multifunctional video apparatus displays an icon to guide the set continuous mode on the LCD 1132. If “release” is set, no icon is displayed.

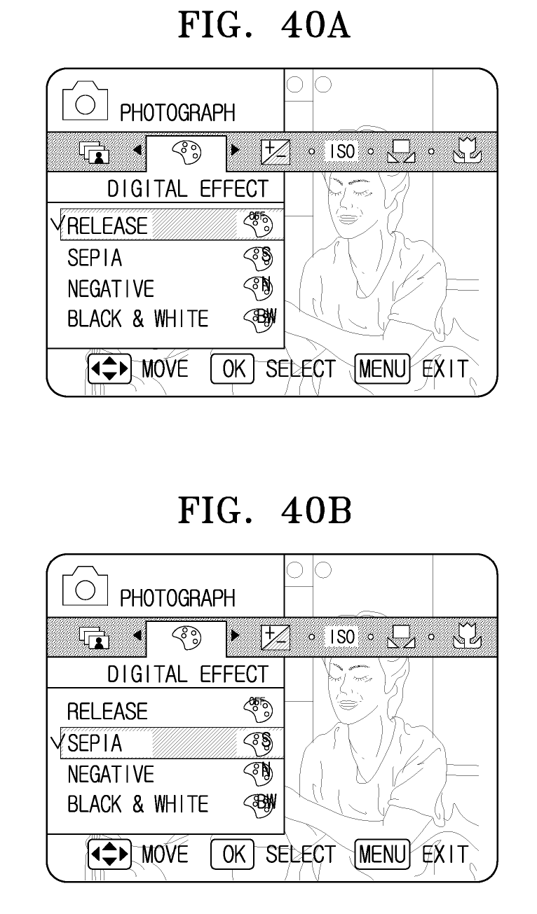

FIGS. 40A and 40B illustrate the LCD 1132 of FIG. 8, where the LCD 1132 displays a “digital effect” menu and its sub-menus following the selecting of the “digital effect” menu. If “release” is selected as illustrated in FIG. 40A, the multifunctional video apparatus expresses the taken photograph with a natural color. In contrast, if “sepia” is selected as illustrated in FIG. 40B, the multifunctional video apparatus expresses the taken photograph with a brown color. In contrast, if “negative” is selected, the multifunctional video apparatus expresses the taken photograph with an inverted color. In contrast, if “black & white” is selected, the multifunctional video apparatus expresses the taken photograph with black and white. If the settings are completed, the multifunctional video apparatus displays an icon to guide the set digital effect on the LCD 1132. If “release” is set, no icon is displayed.

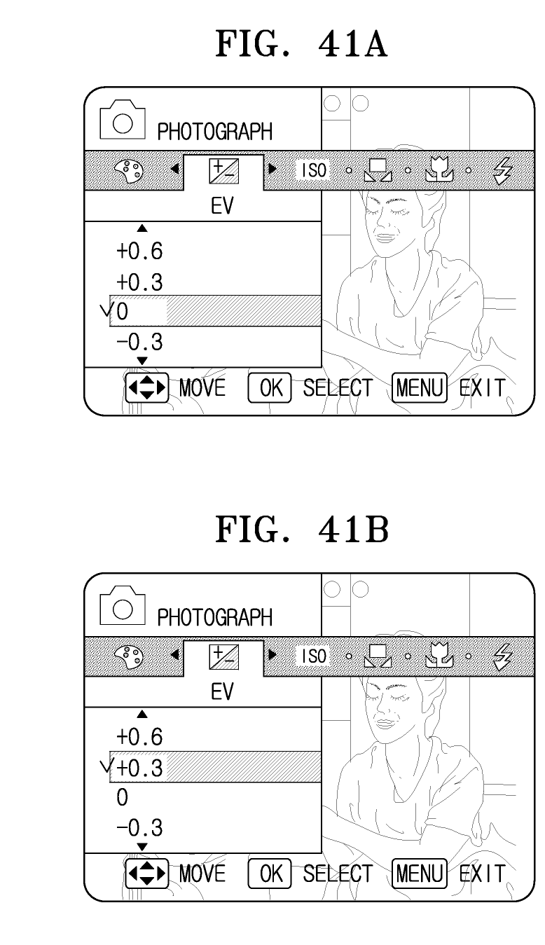

FIGS. 41A and 41B illustrate the LCD 1132 of FIG. 8, where the LCD 1132 displays an “EV” (e.g. manual exposure) menu and its sub-menus following the selecting of the “EV” menu. If “0” is selected as illustrated in FIG. 41A, the multifunctional video apparatus sets the manual exposure to “0”. If “+0.3” is selected as illustrated in FIG. 41B, the multifunctional video apparatus sets the manual exposure to “+0.3”. As the set manual exposure value goes to the negative (−) side, the photograph becomes darker, while as the set manual exposure value goes to the positive (+) side, the photograph becomes brighter. If the settings are completed, the multifunctional video apparatus displays an icon to guide the set manual exposure on the LCD 1132. If “0” is set, no icon is displayed.

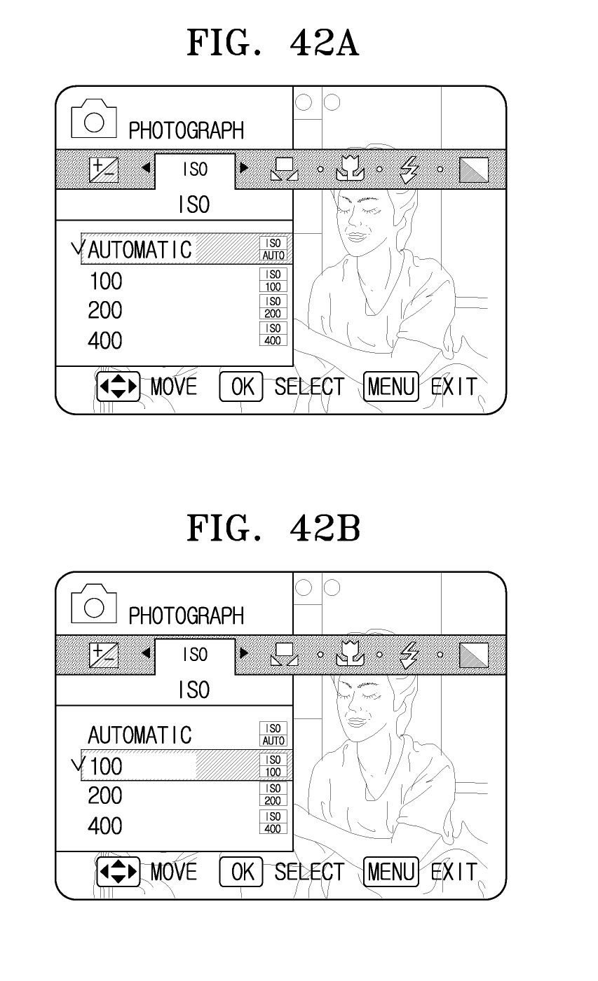

FIGS. 42A and 42B illustrate the LCD 1132 of FIG. 8, where the LCD 1132 displays an “ISO” (e.g. ISO photosensitivity effect) menu and its sub-menus following the selecting of the “ISO” menu. If “automatic” is selected as illustrated in FIG. 42A, the multifunctional video apparatus automatically sets the ISO in accordance with the brightness of the light. In contrast, if “100” is selected as illustrated in FIG. 42B, the multifunctional video apparatus sets the ISO to “100”. “100” is a standard sensitivity that is a general photosensitivity. The photosensitivity suitable for a dark place is “200,” and “400” is suitable for an extremely dark place. If the settings are completed, the multifunctional video apparatus displays an icon to guide the set ISO photosensitivity on the LCD 132. If “automatic” is set, no icon is displayed.

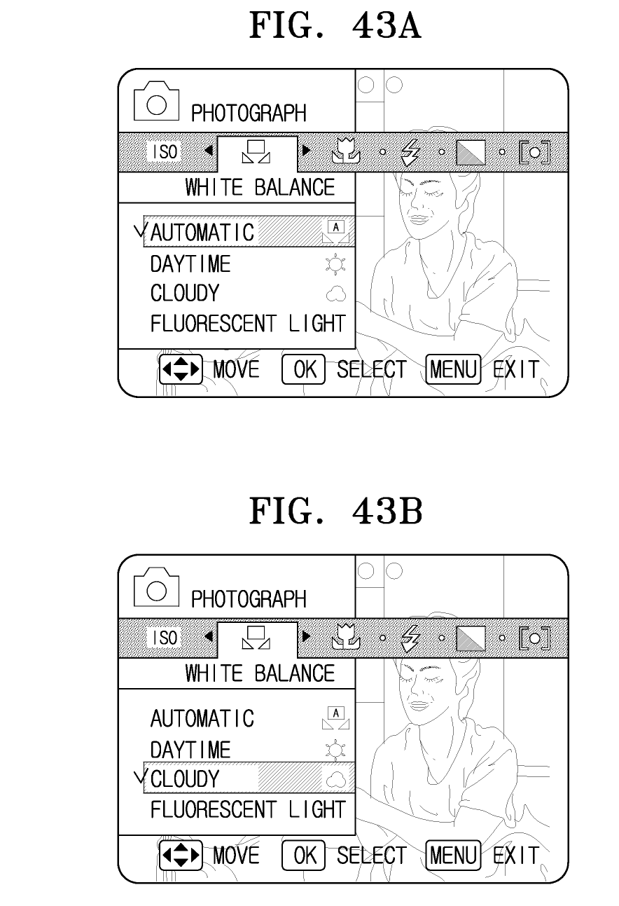

FIGS. 43A and 43B illustrate the LCD 1132 of FIG. 8, where the LCD 1132 displays a “white balance” menu and its sub-menus following the selecting of the “white balance” menu. If “automatic” is selected as illustrated in FIG. 43A, the multifunctional video apparatus automatically adjusts the white balance in accordance with the photographing environment. In contrast, if “cloudy” is selected as illustrated in FIG. 43B, the multifunctional video apparatus sets the white balance suitable for a cloudy day.

In addition, the white balance setting menu includes a daytime mode suitable to photograph with a color sense compensation based on a natural color, a fluorescent light H mode suitable to photograph with a color sense compensation when using a 3-wavelength fluorescent lighting such as halogen, a fluorescent light L mode suitable to photograph with a color sense compensation when under various kinds of white fluorescent lightings, an incandescent light mode suitable to photograph with a color sense compensation when under an incandescent light, and a user mode compensation to vary according to user preferences.

If the settings are completed, the multifunctional video apparatus displays an icon to guide the set white balance mode on the LCD 1132. If “automatic” is set, no icon is displayed.

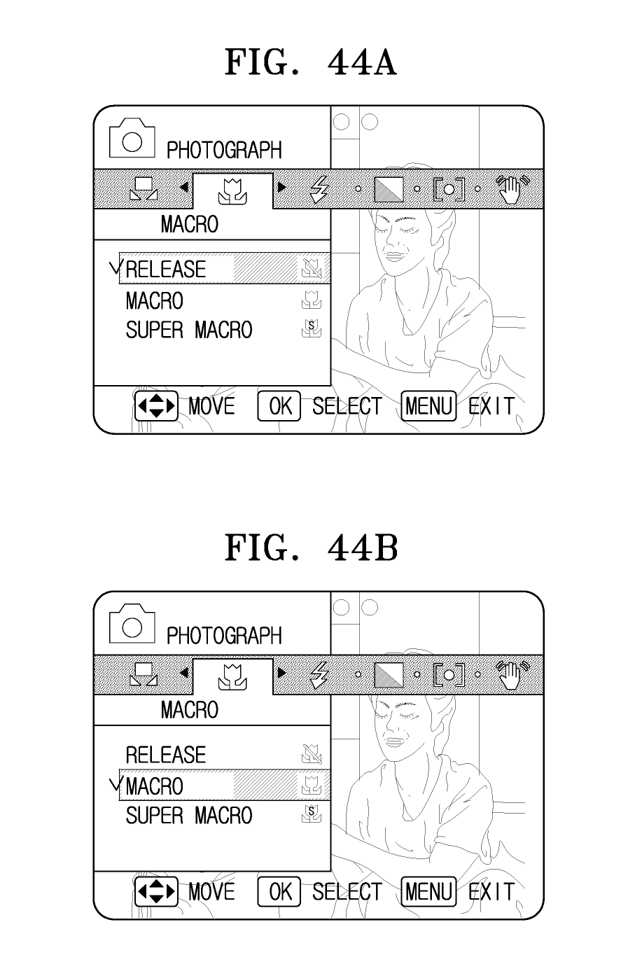

FIGS. 44A and 44B illustrate the LCD 1132 of FIG. 8, where the LCD 1132 displays a “macro” menu and its sub-menus following the selecting of the “macro” menu. If “release” is selected as illustrated in FIG. 44A, the multifunctional video apparatus sets the photographing distance to suit 50 cm to infinite. If “macro” is selected as illustrated in FIG. 44B, the multifunctional video apparatus sets the photographing distance to suit for 10 cm to infinite. If “super macro” is selected, the multifunctional video apparatus sets the photographing distance to suit for 1 cm to 10 cm. Upon completing the settings, the multifunctional video apparatus displays an icon on the LCD 1132 to indicate the macro as set. There is no icon displayed when “release” is selected. The macro settings may be made through the shortcut button-3 1110-3 of FIG. 8, and the settings may be adjusted differently in accordance with the number of times the shortcut button-3 1110-3 is manipulated.

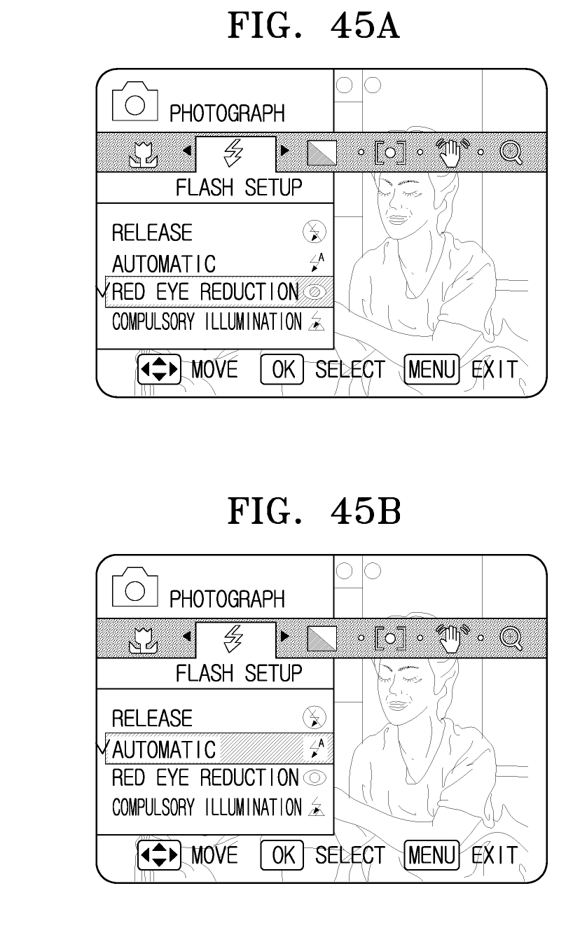

FIGS. 45A and 45B illustrate the LCD 1132 of FIG. 8, where the LCD 1132 displays a “flash setup” (e.g. flash) menu and its sub-menus following the selecting of the “flash setup” menu. If “red-eye reduction” is selected as illustrated in FIG. 45A, the multifunctional video apparatus reduces the red-eye phenomenon in which a human eye appears red by operating the built-in flash 1146 of FIG. 9 if an object or background is dark. In contrast, if “automatic” is selected as illustrated in FIG. 45B, the multifunctional video apparatus automatically operates the built-in flash 1146 if an object or background is dark. If “release” is selected, the multifunctional video apparatus does not operate the built-in flash. In contrast, if “compulsory lighting” is selected, the multifunctional video apparatus always operates the built-in flash 1146 irrespective of the brightness of the object or background. Furthermore, if “low-speed shutter flash” is selected, the multifunctional video apparatus operates the shutter at a low speed and operates the built-in flash 1146 to brighten the object and background during the photographing in a dark place or in the evening. If the settings are completed, the multifunctional video apparatus displays an icon to guide the set flash on the LCD 1132. The flash settings may be made through the shortcut button-2 1110-2 of FIG. 8, and the settings may be adjusted differently in accordance with the number of times the shortcut button-2 1110-2 is manipulated.

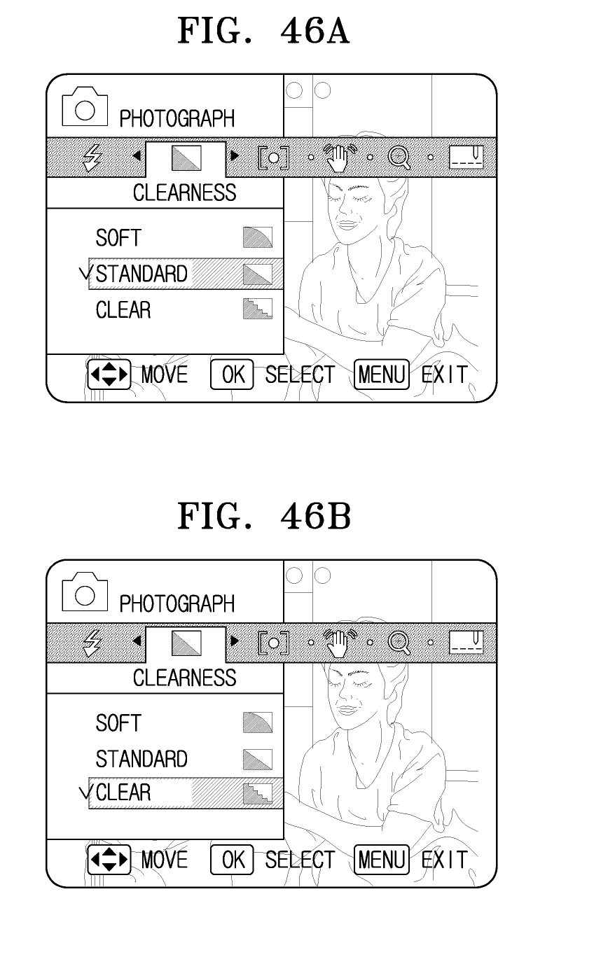

FIGS. 46A and 46B illustrate the LCD 1132 of FIG. 8, where the LCD 1132 displays a “clearness” menu and its sub-menus following the selecting of the “clearness” menu. If “standard” is selected as illustrated in FIG. 46A, the multifunctional video apparatus sharply expresses an edge part of an image. In contrast, if “clearness” is selected as illustrated in FIG. 46B, the multifunctional video apparatus makes the image be seen clear by emphasizing the edge part of the image. In contrast, if “soft” is selected, the multifunctional video apparatus softly expresses the edge part of the image. If the settings are completed, the multifunctional video apparatus displays an icon to guide the set clearness on LCD 1132. No icon is displayed if “standard” is selected.

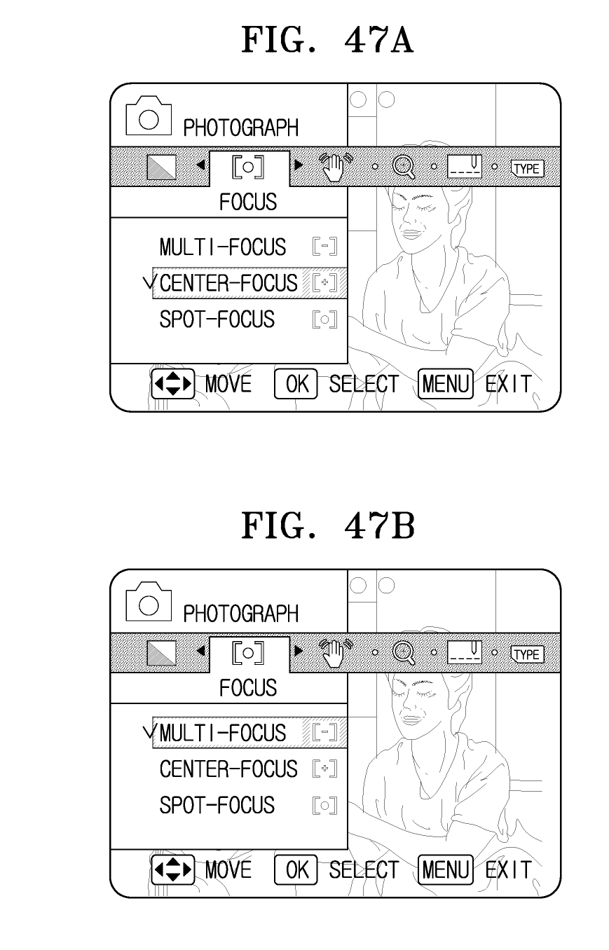

FIGS. 47A and 47B illustrate the LCD 1132 of FIG. 8, where the LCD 1132 displays a “focus” menu and its sub-menus following the selecting of the “focus” menu. If “center-focus” is selected as illustrated in FIG. 47A, the multifunctional video apparatus sets the focus in the center. In contrast, if “multi-focus” is selected as illustrated in FIG. 47B, the multifunctional video apparatus sets the focus as a multi-focus. In contrast, if “spot-focus” is selected, the multifunctional video apparatus sets the focus as a spot focus. If the settings are completed, the multifunctional video apparatus displays an icon to guide the set focus.

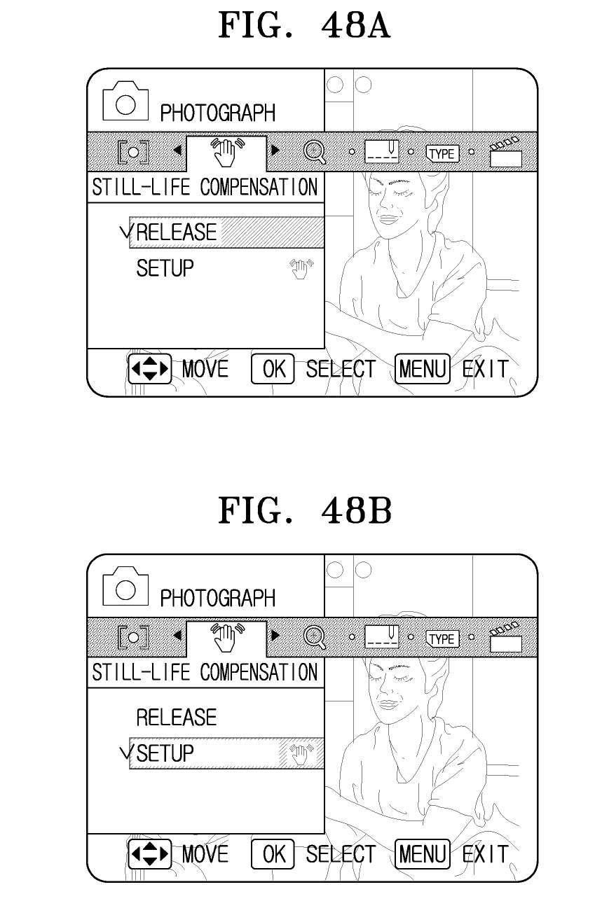

FIGS. 48A and 48B illustrate the LCD 1132 of FIG. 8, where the LCD 1132 displays a “still-life compensation” menu and its sub-menus following the selecting of the “still-life compensation” menu. If “release” is selected as illustrated in FIG. 48A, the multifunctional video apparatus performs a normal photographing. In contrast, if “setting” is selected as illustrated in FIG. 48B, the multifunctional video apparatus takes three photographs, and automatically synthesizes the photographs to provide a stable photographs. If the settings are completed, the multifunctional video apparatus displays an icon to guide the set still-life compensation on the LCD 1132. If “release” is set, no icon is displayed.

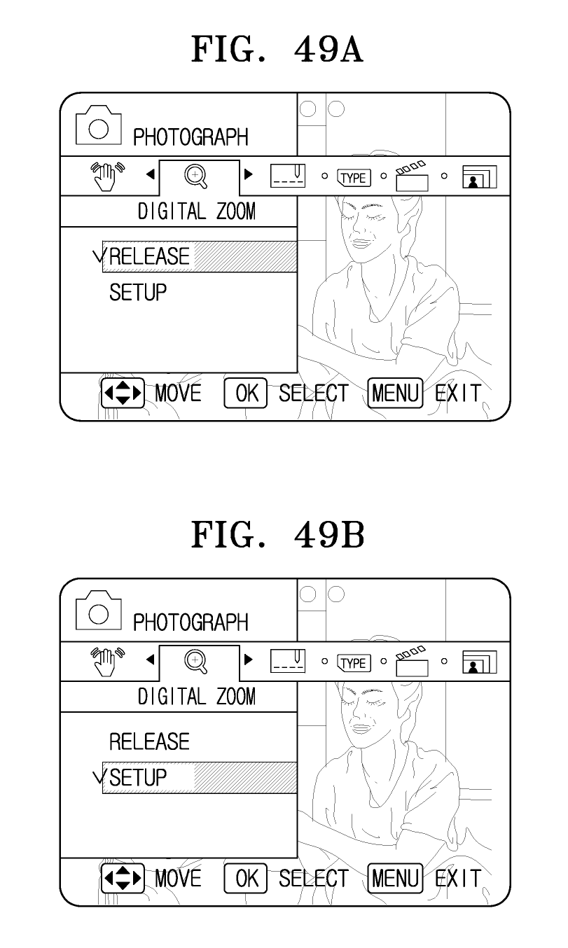

FIGS. 49A and 49B illustrate the LCD 1132 of FIG. 8, where the LCD 1132 displays a “digital zoom” menu and its sub-menus following the selecting of the “digital zoom” menu. If “release” is selected as illustrated in FIG. 49A, the multifunctional video apparatus does not perform the digital zoom. In contrast, if “setup” is selected as illustrated in FIG. 49B, the multifunctional video apparatus performs the digital zoom if required.

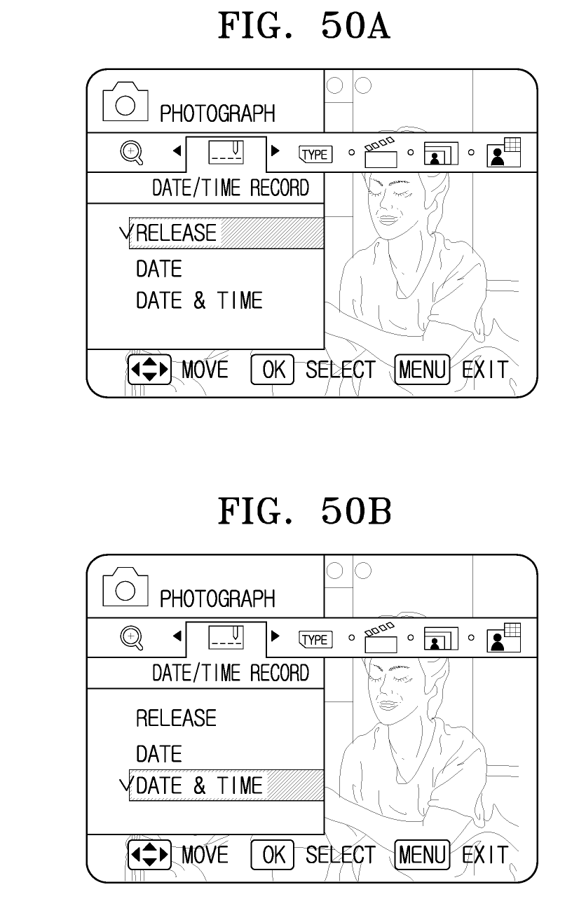

FIGS. 50A and 50B illustrate the LCD 1132 of FIG. 8, where the LCD 1132 displays a “date/time record” menu and its sub-menus following the selecting of the “date/time record” menu. If “release” is selected as illustrated in FIG. 50A, the multifunctional video apparatus does not record the date and time when recording the taken photographs. In contrast, if “date & time” is selected as illustrated in FIG. 50B, the multifunctional video apparatus records both the date and time when recording the taken photographs. In contrast, if “date” is selected, the multifunctional video apparatus records only the date when recording the taken photographs.

If the shortcut button-1 1110-1 of FIG. 8 is pressed in the photograph mode, the multifunctional video apparatus changes the present mode to a photograph reproduction mode. If the shortcut button-1 1110-1 is pressed in the photograph mode, the multifunctional video apparatus selects the photograph mode as the present mode. Hereinafter, a photograph reproduction mode will be described in more detail.

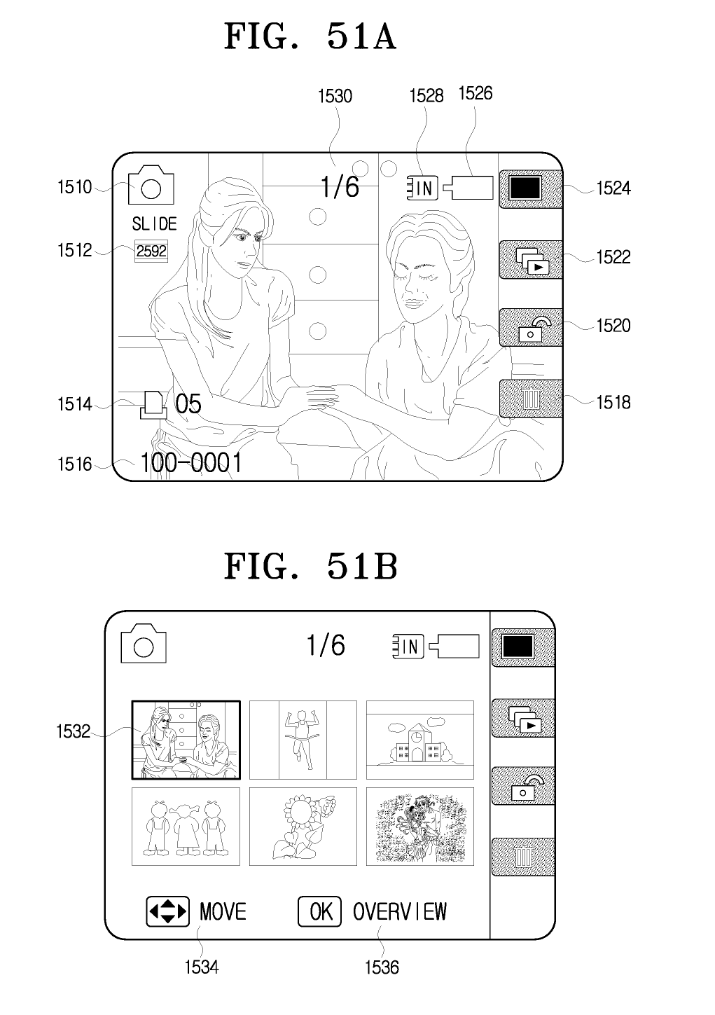

As the multifunctional video apparatus operates in the photograph reproduction mode, icons that can be displayed on the LCD 1132 of FIG. 8 are illustrated in FIGS. 51A and 51B. In the photograph reproduction mode as illustrated in FIGS. 51A and 51B, the LCD 1132 of the multifunctional video apparatus can display a present mode guide icon 1510, a photograph size guide icon 1512, a DPOF guide icon 1514, a photograph number guide icon 1516, a deletion shortcut icon 1518, a locking shortcut icon 1520, a slide shortcut icon 1522, a photographing/reproduction switchover guide icon 1524, a battery state guide icon 1526, a record memory guide icon 1528, the present number of sheets/the whole number of sheets guide icon 1530, a presently selected file guide icon 1532, and manipulation guide icons 1534 and 1536.

In the photograph reproduction mode, the multifunctional video apparatus displays a photograph recorded in a memory (i.e., a memory selected between a built-in memory and a memory card) on the LCD 1132. If the joystick 1114 of FIG. 8 is pushed left and/or right, the multifunctional video apparatus displays a photograph, which is a previous/next photograph of the presently displayed photograph among the photographs recorded in the memory, on the LCD 1132.

If the joystick 1114 is pushed left and/or right for more than one second, the multifunctional video apparatus sequentially switches and displays the previous/next photograph.

If the zoom switch is pushed in a “Wide” direction in the photograph reproduction mode, the multifunctional video apparatus, as illustrated in FIG. 51B, displays the plural photographs through a multi-screen on the LCD 1132. In contrast, if the zoom switch is pushed in a “Tele” direction, the multifunctional video apparatus displays only on photograph on the LCD 1132 as illustrated in FIG. 51A. If the zoom switch is further pushed in the “Tele” direction, the multifunctional video apparatus enlarges and displays the photograph displayed on the LCD 1132.

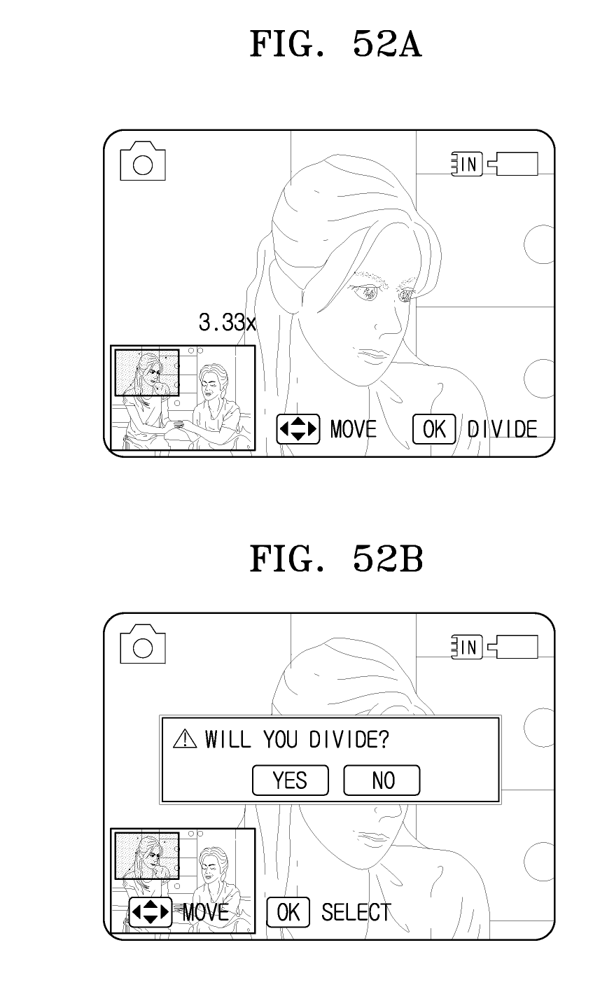

Referring to FIGS. 52A and 52B, if the displayed photograph is enlarged, a specified part thereof is moved and selected, a division confirmation thereof is inputted, and the multifunctional video apparatus cuts and stores the part displayed on the LCD 1132 of FIG. 8 as a new file. A command to enlarge the displayed photograph can be input through the zoom switch 1136 of FIG. 9, and a command to move, select, and divide confirmation of the photograph can be input through the joystick 1114 of FIG. 8.

In the photograph reproduction mode, the multifunctional video apparatus may adjust settings to delete a photograph file, set a photograph file locking, rotate a photograph change a photograph size, set a slide set a DPOF of a photograph file, and copy a photograph file. Hereinafter, the respective functions thereof will be described in more detail.

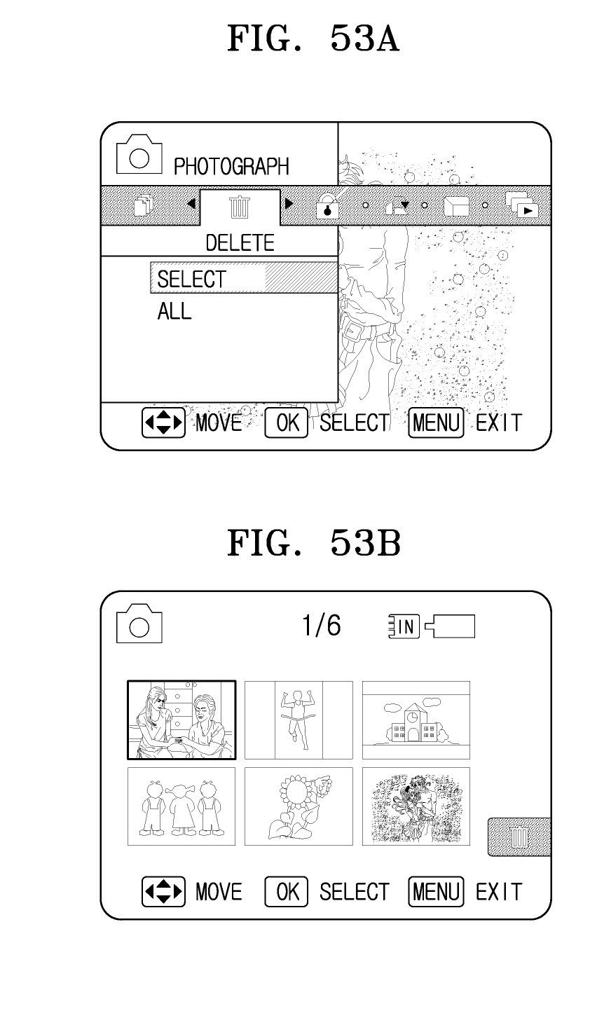

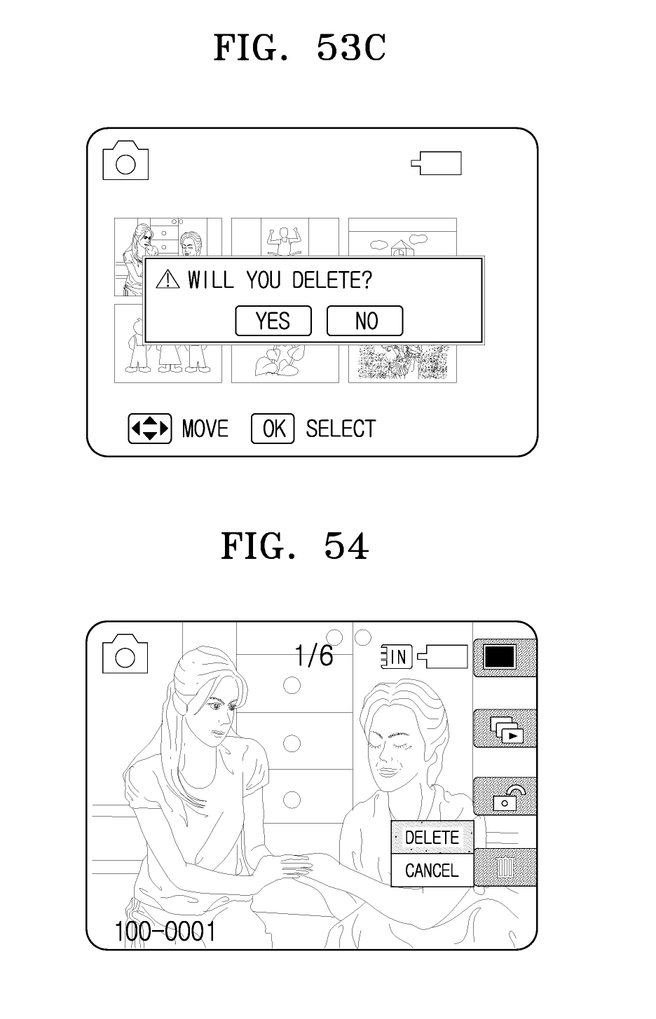

FIGS. 53A to 53C illustrate the LCD 1132 of FIG. 8, where the LCD 1132 displays a “delete” (e.g. deletion of a photograph file) menu and its sub-menus following the selecting of the “delete” menu. As illustrated in FIGS. 53A to 53C, if “select” is selected, the multifunctional video apparatus displays a multi-screen on the LCD 1132, and deletes the photograph file, which is selected by the user using the joystick 1114 of FIG. 8, through a process of confirming deletion of the photograph file. As illustrated in FIG. 53B, the multifunctional video apparatus displays a deletion icon with respect to the photograph file selected by the user, on the multi-screen. In contrast, if “all” is selected, the multifunctional video apparatus deletes all photograph files recorded in the memory through a deletion confirmation process.

The deletion of the photograph file is possible through a manipulation of the shortcut button-4 1110-4 of FIG. 8. FIG. 54 illustrates the LCD 1132 on which sub-menus of the shortcut botton-4 1110-4 of FIG. 8 is displayed through a manipulation of the shortcut button-4 1110-4 in a state that the photograph reproduction screen is displayed on the LCD 1132. If “deletion” is selected as illustrated in FIG. 54, the multifunctional video apparatus deletes the photograph file displayed on the LCD 1132 through the deletion confirmation process.

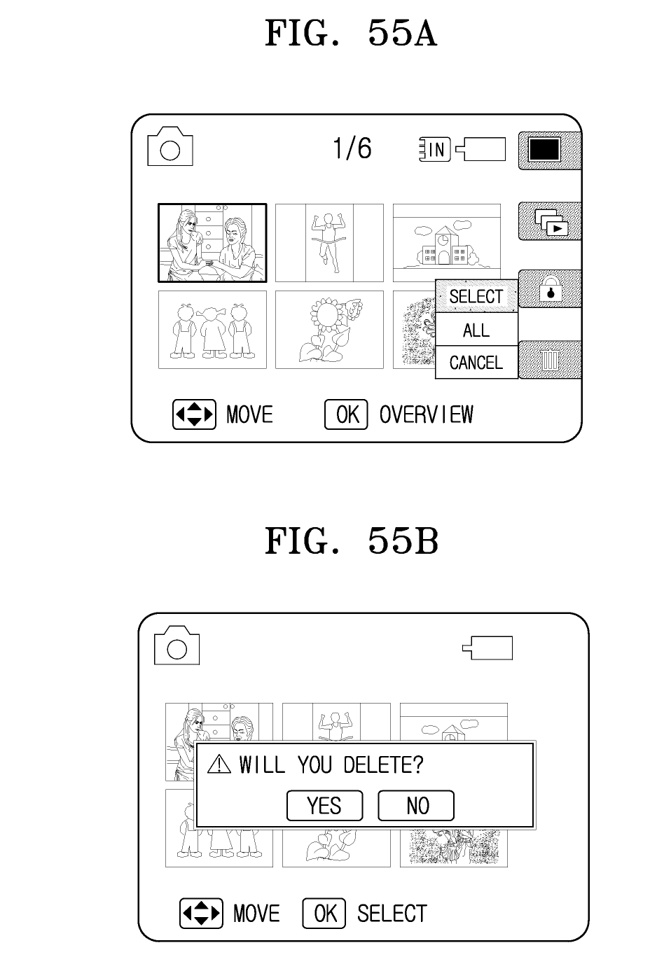

FIGS. 55A and 55B illustrate the LCD 1132 of FIG. 8, on which sub-menus of the shortcut button-4 1110-4 of FIG. 8 are displayed through the manipulation of the shortcut button-4 1110-4 in a state that the multi-screen is displayed on the LCD 1132. As illustrated in FIGS. 55A and 55B, if “select” is selected, the multifunctional video apparatus deletes the photograph file selected by the user using the joy stick 1114 of FIG. 8, through the deletion confirmation process. In contrast, if “all” is selected, the multifunctional video apparatus deletes all the photograph files recorded in the memory, through the deletion confirmation process.

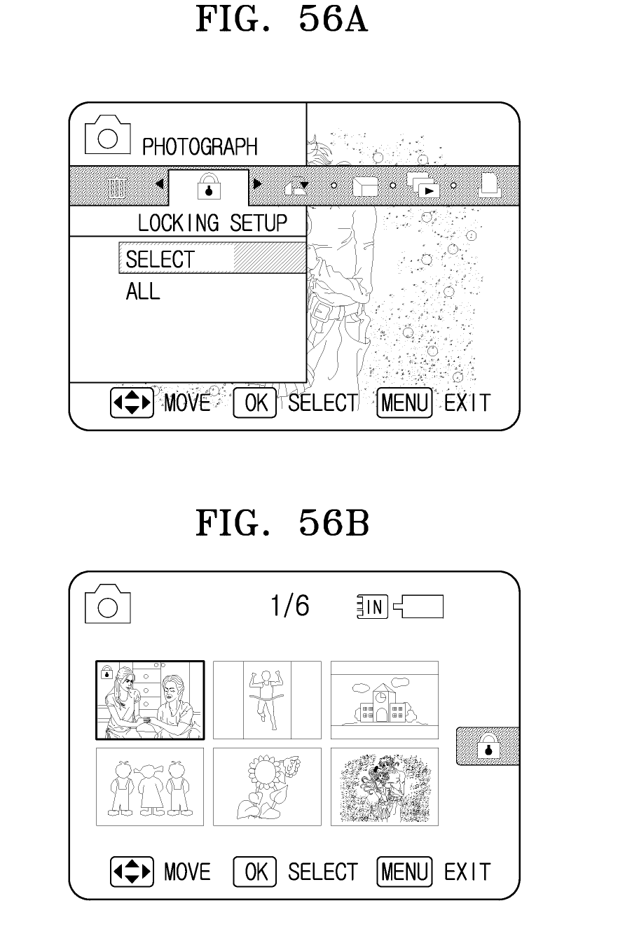

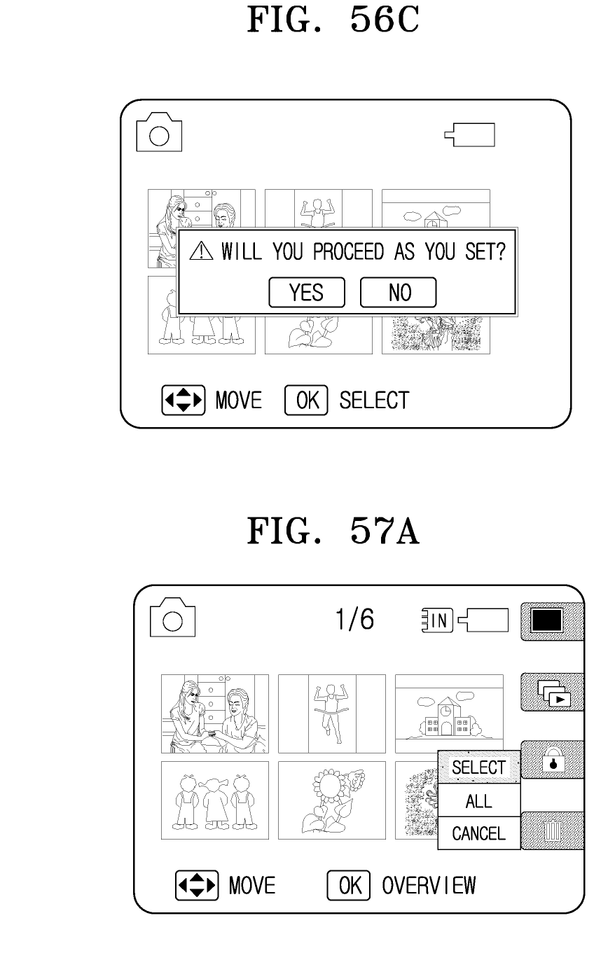

FIGS. 56A to 56C illustrate the LCD 1132 of FIG. 8, where the LCD 1132 displays a “locking setup” (e.g. “photograph file locking setup”) menu and its sub-menus following the selecting of the “locking setup” menu. As illustrated in FIGS. 56A to 56C, if “select” is selected, the multifunctional video apparatus displays the multi-screen on the LCD 1132, and sets the locking of the photograph file selected by the user using the joystick 1114 of FIG. 8, through the conformation process. The locked photograph file is only deleted when the memory is formatted or the lock setting is released. As illustrated in FIG. 56B, the multifunctional video apparatus displays the locking icon with respect to the photograph file selected by the user, on the multi-screen. In contrast, if “all” is selected, the multifunctional video apparatus sets the locking of all the photograph files recorded in the memory through the confirmation process.

The locking of the photograph file can also be performed through the manipulation of the shortcut button-3 1110-3 of FIG. 8. Specifically, if the shortcut button-3 1110-3 is pressed in a state that the reproduced photograph is displayed on the LCD 1132, the multifunctional video apparatus sets the locking of the photograph file displayed on the LCD 1132.

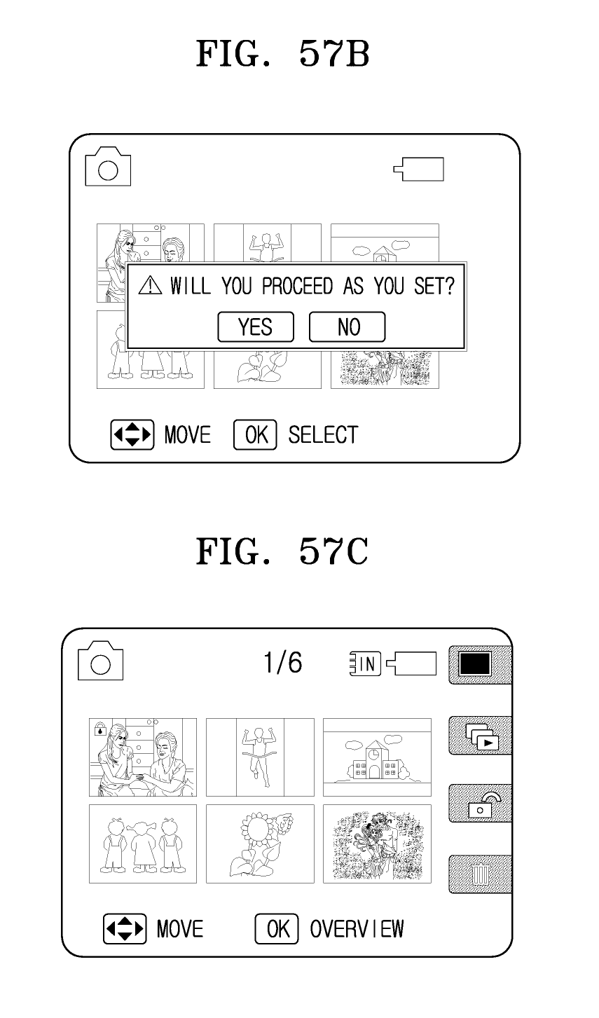

FIGS. 57A to 57C illustrate the LCD 1132 of FIG. 8 on which sub-menus of the shortcut button-3 1110-3 are displayed through the manipulation of the shortcut button-3 1110-3 of FIG. 8 in a state that the multi-screen is displayed on the LCD 1132. As illustrated in FIGS. 57A to 57C, if “select” is selected, the multifunctional video apparatus sets the locking of the photograph file selected by the user using the joystick 1114 of FIG. 8, through the confirmation process, and displays a locking icon on the photograph file of which the locking has been set. In contrast, if “all” is selected, the multifunctional video apparatus sets the locking of all the photograph files recorded in the memory through the confirmation process.

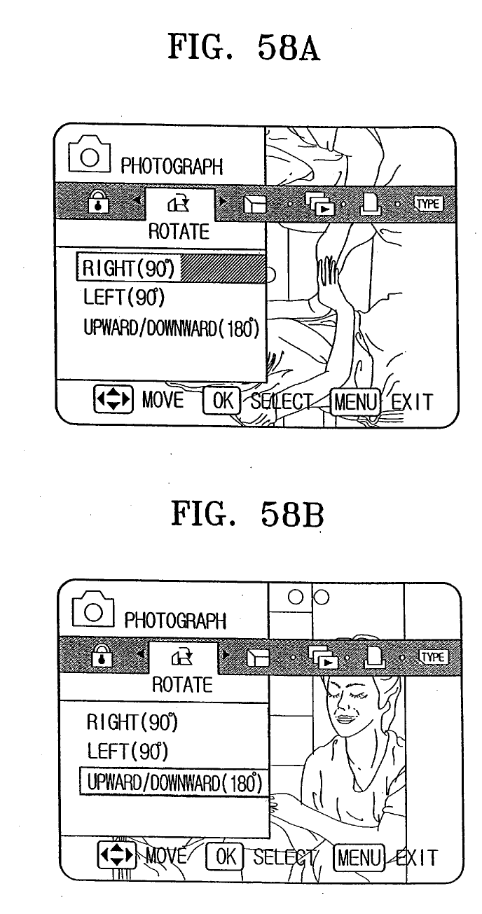

FIGS. 58A and 58B illustrate the LCD 1132 of FIG. 8, where the LCD 1132 displays a “rotate” (e.g. rotation of a photograph) menu and its sub-menus following the selecting of the “rotate” menu. If “right (90°)” is selected as illustrated in FIG. 58A, the multifunctional video apparatus rotates the photograph displayed on the LCD 1132 clockwise (i.e., right) by 90° and displays the rotated photograph on the LCD 1132. In contrast, if “upward/downward (180°)” is selected as illustrated in FIG. 58B, the multifunctional video apparatus rotates the photograph displayed on the LCD 1132 by 180° and displays the rotated photograph on the LCD 1132. In contrast, if “left (90°)” is selected, the multifunctional video apparatus rotates the photograph displayed on the LCD 1132 counter-clockwise (i.e., left) by 90° and displays the rotated photograph on the LCD 1132.

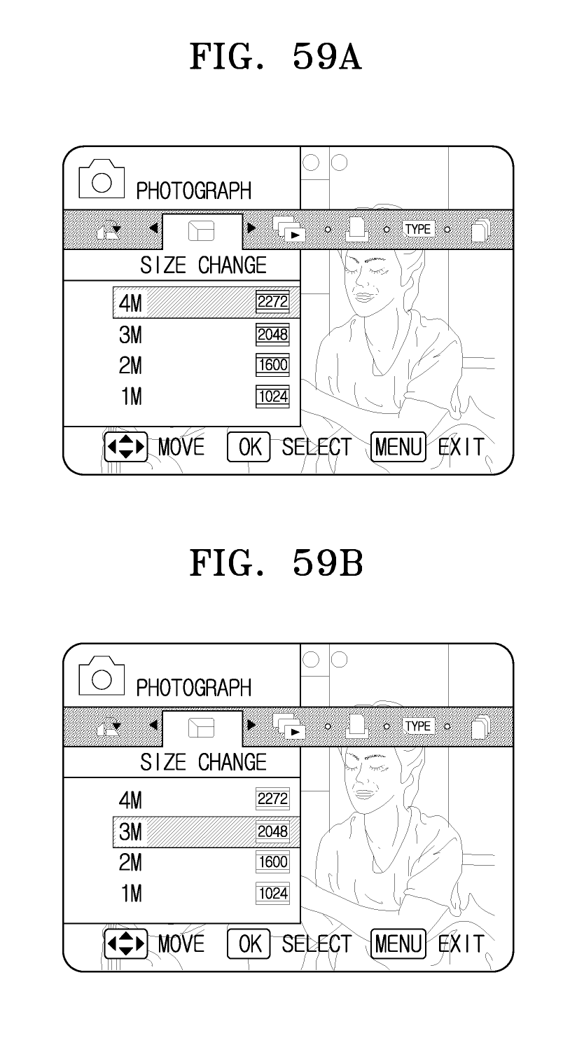

FIGS. 59A and 59B illustrate the LCD 1132 of FIG. 8, where the LCD 1132 displays a “size change” (e.g. change of a photograph size) menu and its sub-menus following the selecting of the “size change” menu. If “4M” is selected as illustrated in FIG. 59A, the multifunctional video apparatus sets the photo size to “2272”. In contrast, if “3M” is selected as illustrated in FIG. 59B, the multifunctional video apparatus sets the photo size to “2048”. If the settings are completed, the multifunctional video apparatus displays an icon to guide the set photograph size on the LCD 1132.

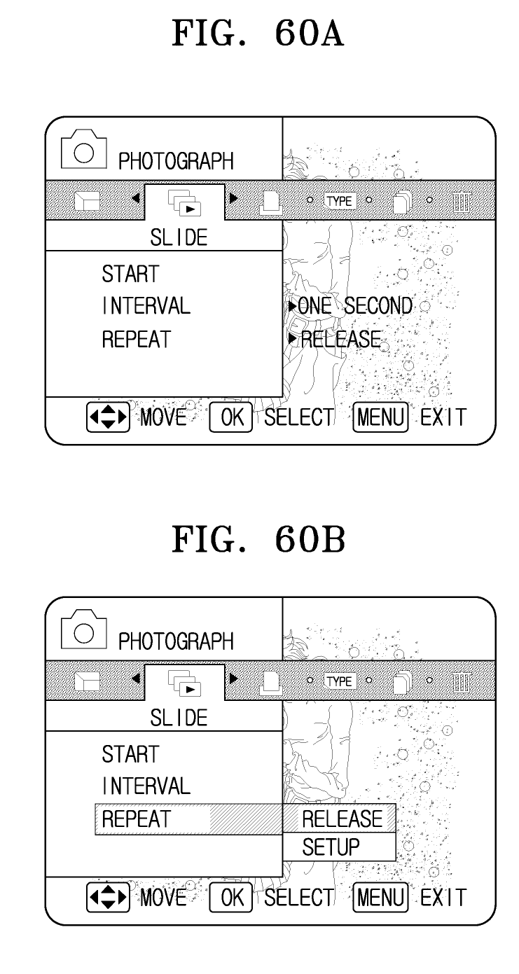

FIGS. 60A to 60C illustrate the LCD 1132 of FIG. 8, where the LCD 1132 displays a “slide” menu and its sub-menus following the selecting of the “slide” menu. If a photograph slide interval (i.e., time interval to reproduce the photograph) is inputted through the sub-menu “interval”, the multifunctional video apparatus sets the slide interval in accordance with the contents of the input. If “release,” which is a lower sub-menu of “repeat” is selected, as illustrated in FIG. 60B, the multifunctional video apparatus sets the photograph slide to not be repeated. In contrast, if “setup” is selected, the multifunctional video apparatus sets the photograph slide to be repeated. In contrast, if “start” is selected, the multifunctional video apparatus starts the photograph slide, and displays the slide guide icon to guide that the photograph slide is currently performed as illustrated in FIG. 60C.

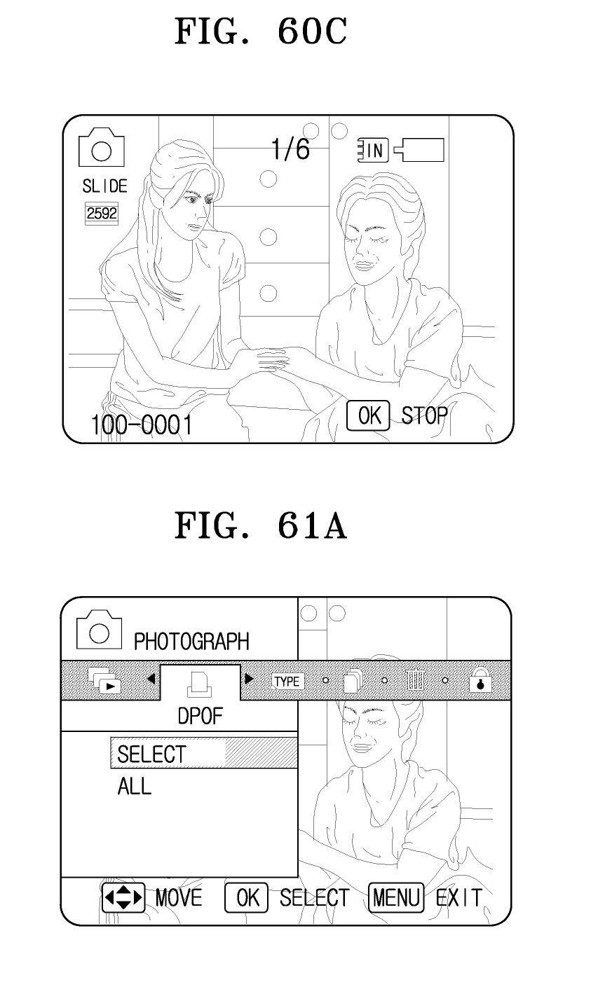

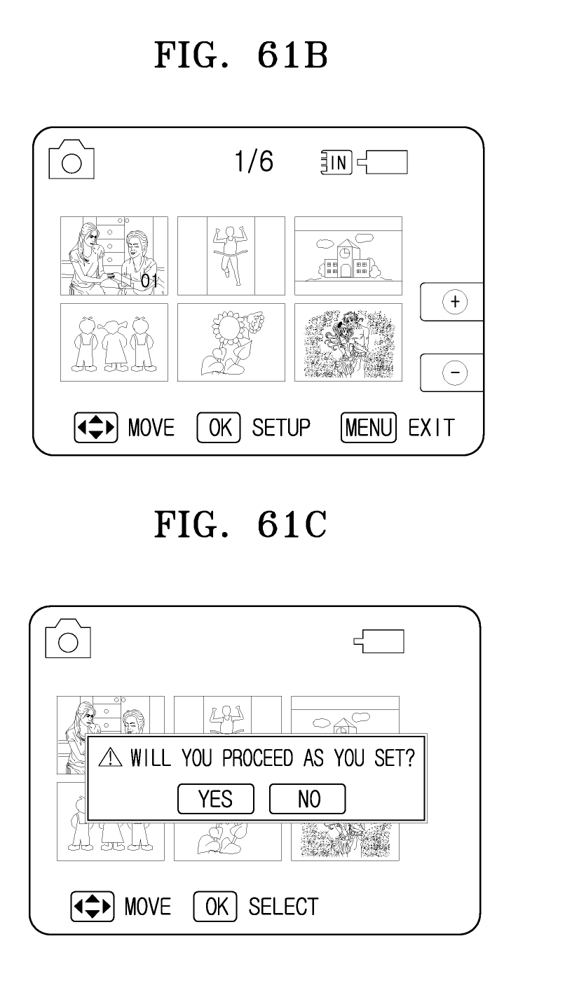

FIGS. 61A to 61C illustrate the LCD 1132 of FIG. 8, where the LCD 1132 displays a “DPOF” (e.g. photograph file DPOF) menu and its sub-menus following the selecting of the “DPOF” menu. As illustrated in FIGS. 61A to 61C, “select” is selected, the multifunctional video apparatus displays the multi-screen on the LCD 1132, and the user sets the photograph file selected by the user using the joystick 1114 of FIG. 8 in a DPOF (Digital Print Order Format). The DPOF is a function of selecting a photograph to be outputted and the number of sheets to be outputted using photograph output information by storing the photograph output information in the memory card. In contrast, if “all” is selected, the multifunctional video apparatus sets all the photograph files recorded in the memory card in the DPOF.

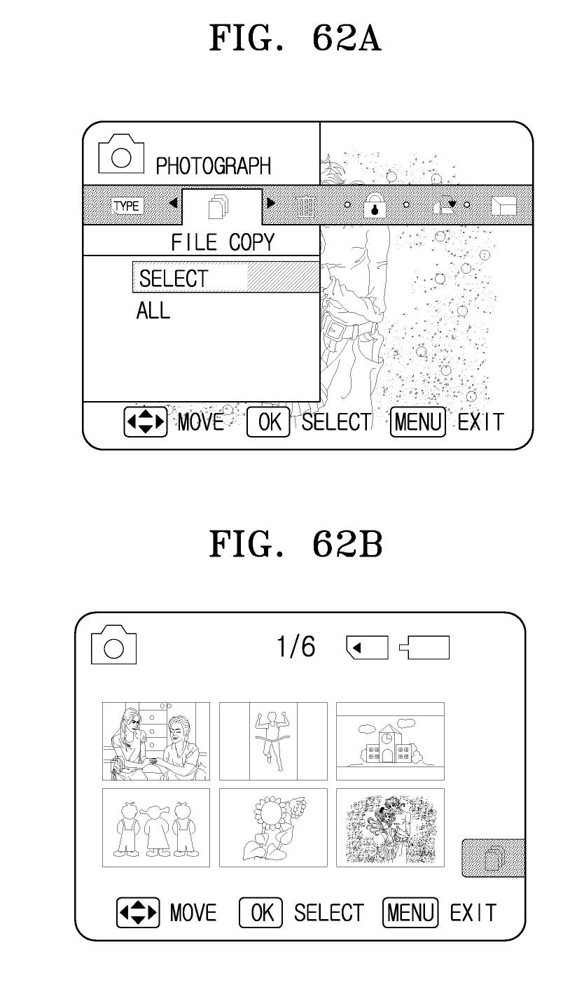

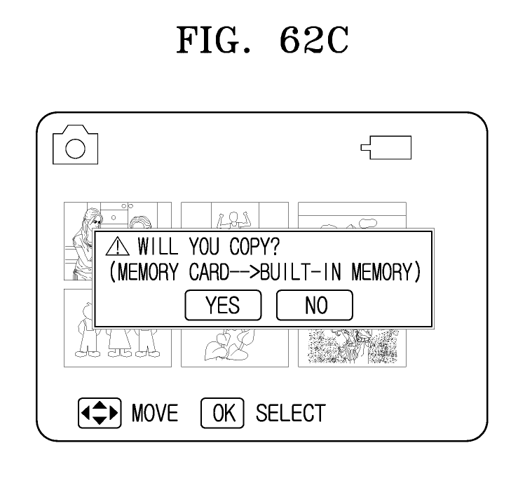

FIGS. 62A to 62C illustrate the LCD 1132 of FIG. 8, where the LCD 1132 displays a “file copy” (e.g. photograph file copy) menu and its sub-menus following the selecting of the “file copy” menu. The photograph file copy is a function of copying the photograph file recorded in the memory that is set as the present record memory into another memory. As illustrated in FIGS. 62A to 62C, “select” is selected, the multifunctional video apparatus displays the multi-screen on the LCD 1132, and the user copies the photograph file selected by the user using the joystick 1114 of FIG. 8 through a confirmation process. As illustrated in FIG. 62B, the multifunctional video apparatus displays a target icon on the photograph file selected by the user on the multi-screen. In contrast, if “all” is selected, the multifunctional video apparatus performs the copying with respect to all the photograph files recorded in the memory through the confirmation process.

Hereinafter, operation of the multifunctional video apparatus in the moving image mode will be described in detail. The moving image mode is divided into a moving image filming mode to record a moving image file generated through the moving image filming of the multifunctional video apparatus in a memory (i.e., built-in memory or memory card) and a moving image reproducing mode to reproduce the recorded moving image file recorded in the memory and to display the same on the LCD 1132. Each mode will now be described in detail.

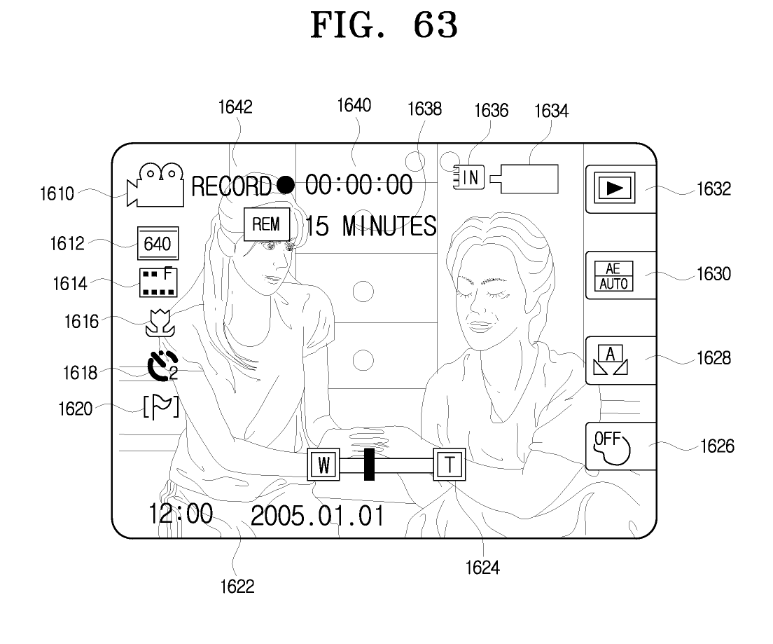

When the multifunctional video apparatus operates in the moving image filming mode, icons which may be displayed on the LCD 1132 of FIG. 8 are illustrated in FIG. 63. As illustrated in FIG. 63, in the moving image filming mode, a present mode guide icon 1610,a moving image size guide icon 1612, a moving image quality guide icon 1614, a macro guide icon 1616, an automatic timer guide icon 1618, a wind sound elimination guide icon 1620, a date/time guide icon 1622, a zoom-in/out guide icon 1624, a digital effect setting shortcut icon 1626, a white balance setting button 1628, a program AE setting shortcut icon 1630, a filming/reproduction conversion shortcut icon 1632, a battery status guide icon 1634, a recording memory guide icon 1636, an elapsed filming time guide icon 1638, a recording/standby guide icon 1640, and a residual time guide icon 1642, are displayed on an LCD 1132 of the multifunctional video apparatus.

In the moving image filming mode, if the record start/stop button 1138 of FIG. 9 is pushed down, the multifunctional video apparatus starts to make a moving image. While making the moving image, if the record start/stop button 1138 is pushed down, the multifunctional video apparatus stops the moving image filming.

If the zooming switch 1136 of FIG. 9 is pushed in a “Wide” direction, the multifunctional video apparatus performs a zoom-out function to display the object to be filmed in a zoom-out effect. But, if the zooming switch 1136 is pushed in a “Tele” direction, the multifunctional video apparatus performs a zoom-in function to display the object to be filmed in a zoom-in effect.

In the moving image filming mode, the multifunctional video apparatus may adjust settings including program AE, white balance, digital effect, macro, moving image quality, moving image size, automatic timer, and wind sound elimination, which will be respectively described hereinafter.

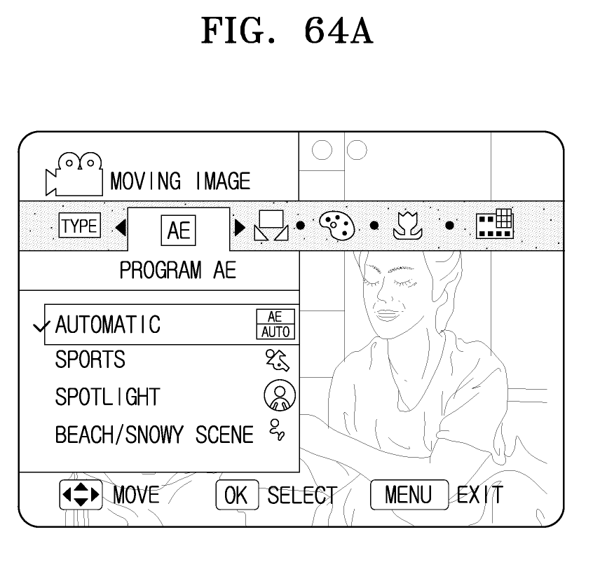

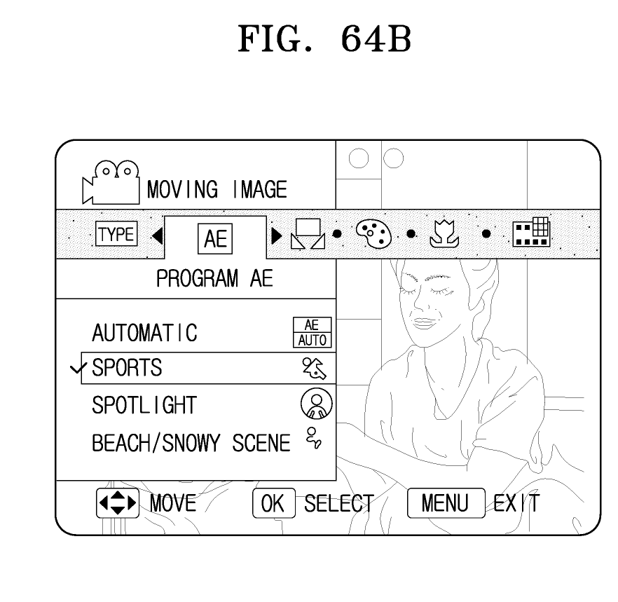

FIGS. 64A and 64B illustrate the LCD 1132 of FIG. 8, where the LCD 1132 displays a “program AE” menu and its sub-menus following the selecting of the “program AE” menu. As illustrated in FIGS. 64A and 64B, if “automatic” is selected, the multifunctional video apparatus automatically sets the exposure depending upon the filming environments. In contrast, as illustrated in FIG. 64B, if “sports” is selected, the multifunctional video apparatus sets the exposure suitable to image a lot of motion such as athletics. Furthermore, if “spotlight” is selected, the multifunctional video apparatus sets the exposure suitable to image a strongly illuminated object such as theatrical performance. If “beach/snow” is selected, the multifunctional video apparatus sets the exposure suitable to image an object in a situation having a strong reflective light such as beach or skiing ground. When the settings are completed, the multifunctional video apparatus displays the icon guiding the set program AR on the LCD 1132. When “release” is set, no icon is displayed. The program AE settings may be made through the shortcut button 1110-2 of FIG. 8, and the settings may be adjusted differently in accordance with the number of times the shortcut button 1110-2 is manipulated.

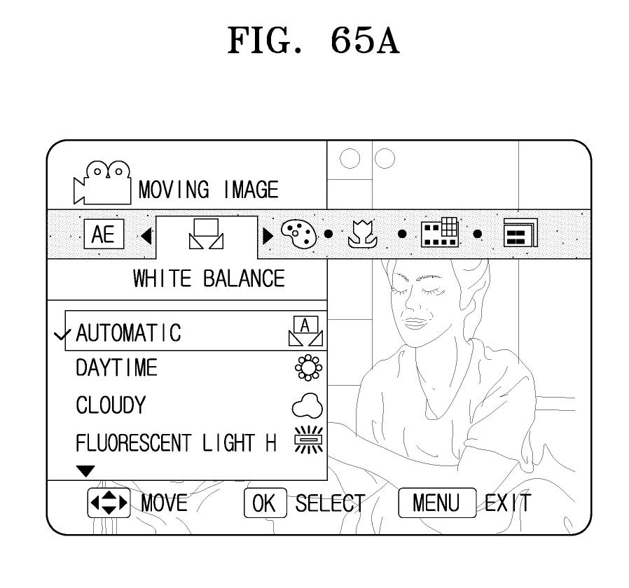

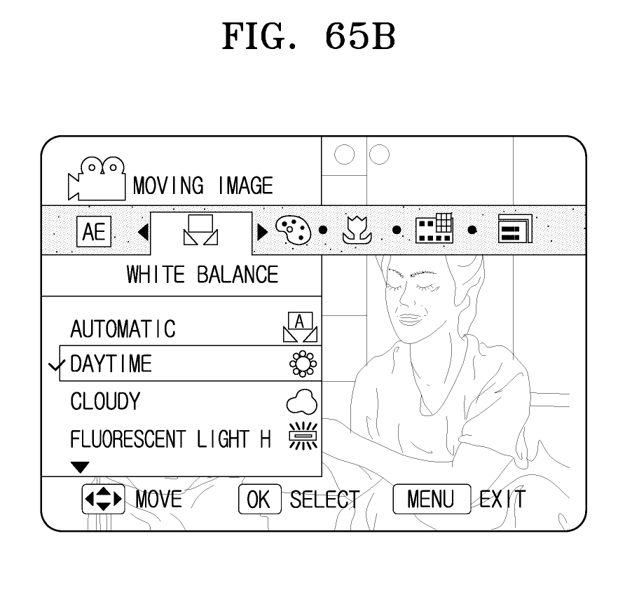

FIGS. 65A and 65B illustrate the LCD 1132 of FIG. 8, where the LCD 1132 displays a “white balance” menu and its sub-menus following the selecting of the “white balance” menu. As illustrated in FIG. 65A, if “automatic” is selected, the multifunctional video apparatus automatically sets the white balance according to the image circumstance. But, as illustrated in FIG. 65B, if “daytime” is selected, the multifunctional video apparatus sets the white balance to image an object in compensated impression of a color based on a natural light standard.

In addition, the white balance menu includes a cloudy mode suitable to image an object in a cloudy situation, a fluorescent H mode suitable to image an object in compensated impression of a color by using 3-wavelength fluorescent illumination such as halogen lamp, a fluorescent L mode suitable to image an object in compensated impression of a color by using various white fluorescent lamp illumination, and an incandescent lamp mode suitable to image an object in compensated impression of a color under a filming circumstance such as an incandescent lamp. When the settings are completed, the multifunctional video apparatus displays the icon guiding the set white balance on the LCD 1132. The white balance settings may be made through the shortcut button 1110-3, and the white balance settings may be adjusted differently in accordance with the number of times the shortcut button 1110-3 of FIG. 8 is manipulated.

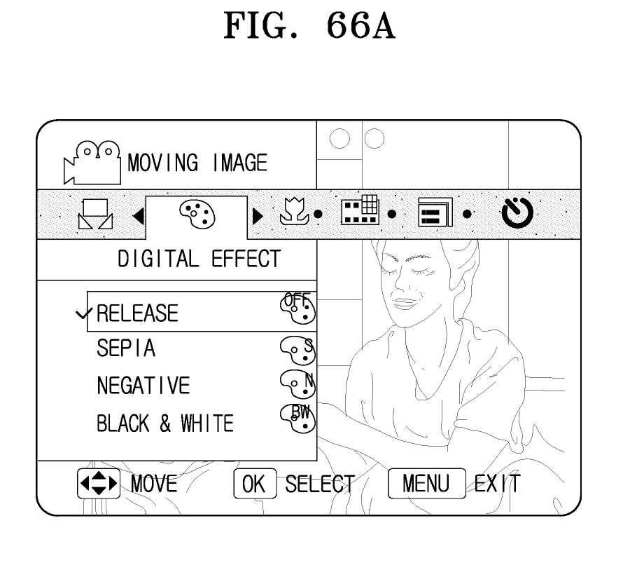

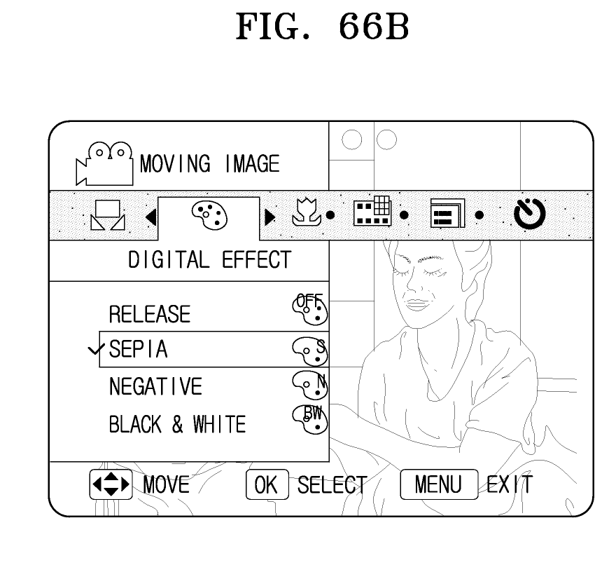

FIGS. 66A and 66B illustrate the LCD 1132 of FIG. 8, where the LCD 1132 displays a “digital effect” menu and its sub-menus following the selecting of the “digital effect” menu. As illustrated in FIG. 66A, if “release” is selected, the multifunctional video apparatus expresses the moving image in a natural color. In contrast, as illustrated in FIG. 66B, if “sepia” is selected, the multifunctional video apparatus expresses the moving image in a brown monotone hue. If “negative” is selected, the multifunctional video apparatus expresses the moving image by reversing it in the same color as the moving image film. If “black & white” is selected, the multifunctional video apparatus expresses the moving image in black and white colors. When the settings are completed, the multifunctional video apparatus displays the icon guiding the digital effect on the LCD 1132. The white balance setting may be made through the shortcut button 1110-4 of FIG. 8, and the white balance setting may be adjusted differently in accordance with the number of times the shortcut button 1110-4 is manipulated.

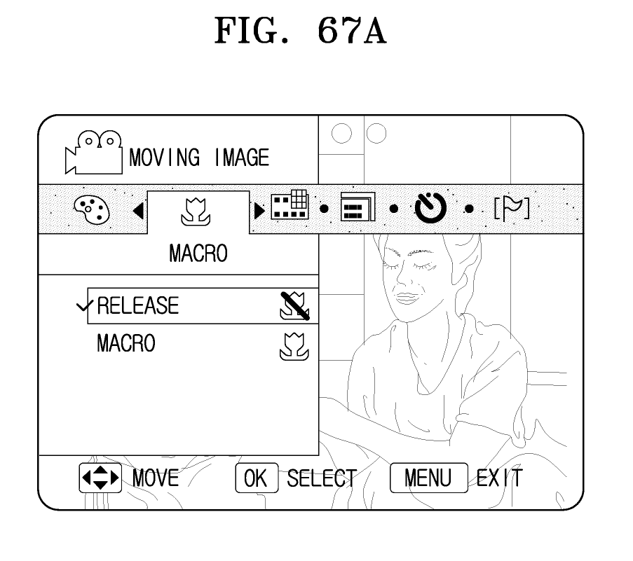

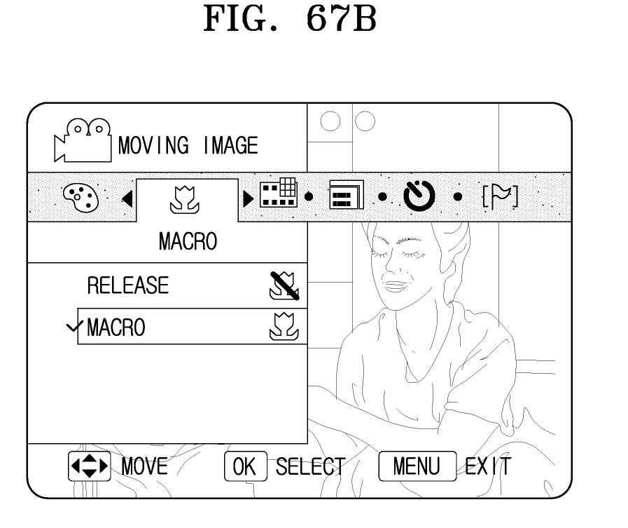

FIGS. 67A and 67B illustrate the LCD 1132 of FIG. 8, where the LCD 1132 displays a “macro” menu and its sub-menus following the selecting of the “macro” menu. As illustrated in FIG. 67A, if “release” is selected, the multifunctional video apparatus is set to be suitable for a shooting distance from 50 cm to infinite. In contrast, as illustrated in FIG. 67B, if “macro” is selected, the multifunctional video apparatus is set to be suitable for a shooting distance from 10 cm to infinite. When the settings are completed, the multifunctional video apparatus displays the icon guiding the macro on the LCD 1132. When “release” is set, no icon is displayed.

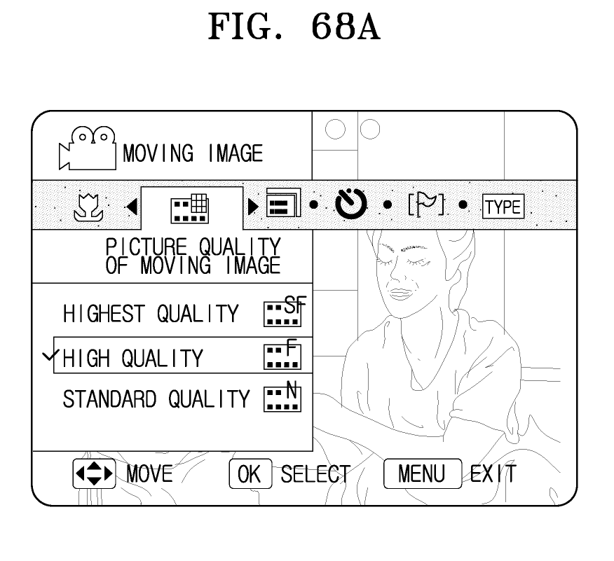

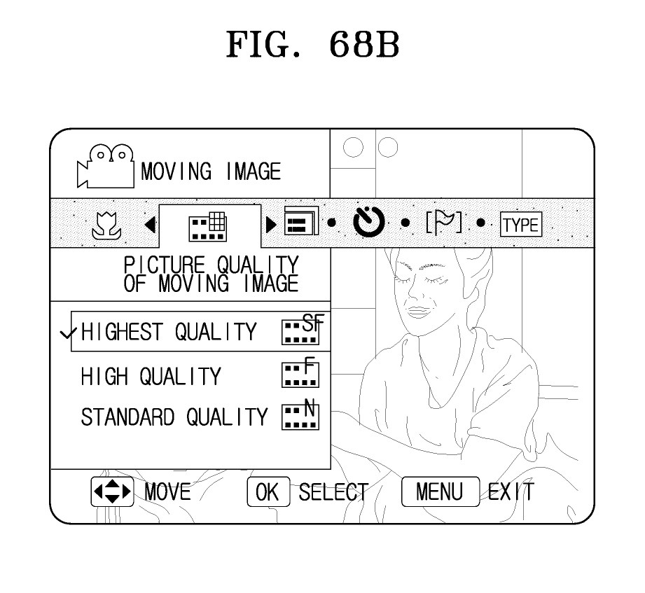

FIGS. 68A and 68B illustrate the LCD 1132 of FIG. 8, where the LCD 1132 displays a “picture quality of moving image” (e.g. moving image quality) menu and its sub-menus following the selecting of the “picture quality of moving image” menu. As illustrated in FIG. 68B, if “highest quality” is selected, the multifunctional video apparatus sets a quality of the moving image in a highest grade. In contrast, as illustrated in FIG. 68A, if “high quality” is selected, the multifunctional video apparatus sets a quality of the moving image in a high grade. In addition, if “standard quality” is selected, the multifunctional video apparatus sets a quality of the moving image in a standard grade. When the settings are completed, the multifunctional video apparatus displays the icon guiding the moving image quality on the LCD 1132.

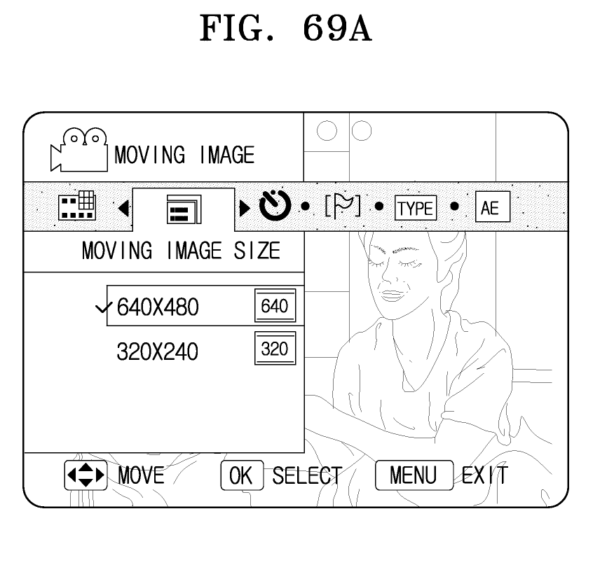

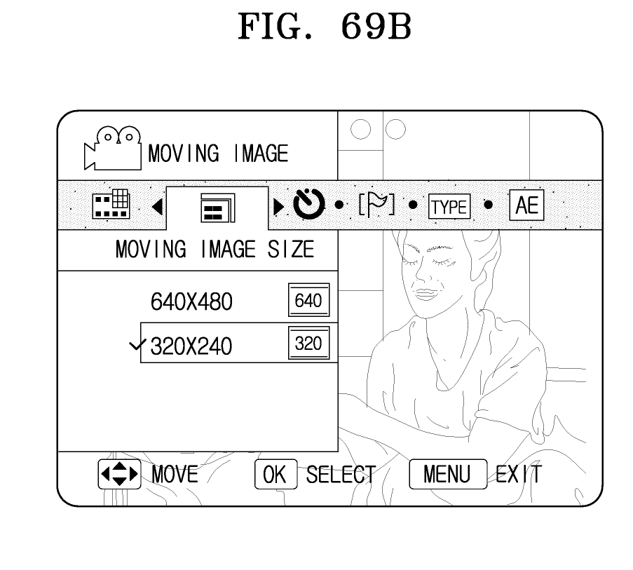

FIGS. 69A and 69B illustrate the LCD 1132 of FIG. 8, where the LCD 1132 displays a “moving image size” menu and its sub-menus following the selecting of the “moving image size” menu. As illustrated in FIG. 69A, if “640×840” is selected, the multifunctional video apparatus sets a size of the moving image as 640×840. In contrast, as illustrated in FIG. 69B, if “320×240” is selected, the multifunctional video apparatus sets a size of the moving image as 320×240. When the settings are completed, the multifunctional video apparatus displays the icon guiding the moving image size on the LCD 1132.

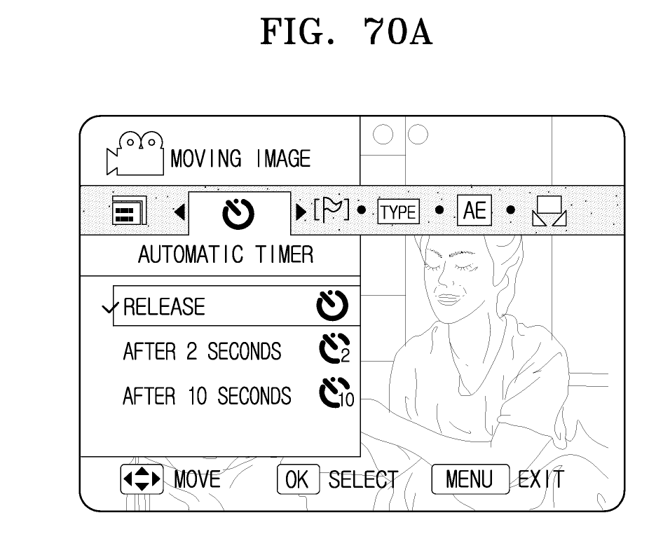

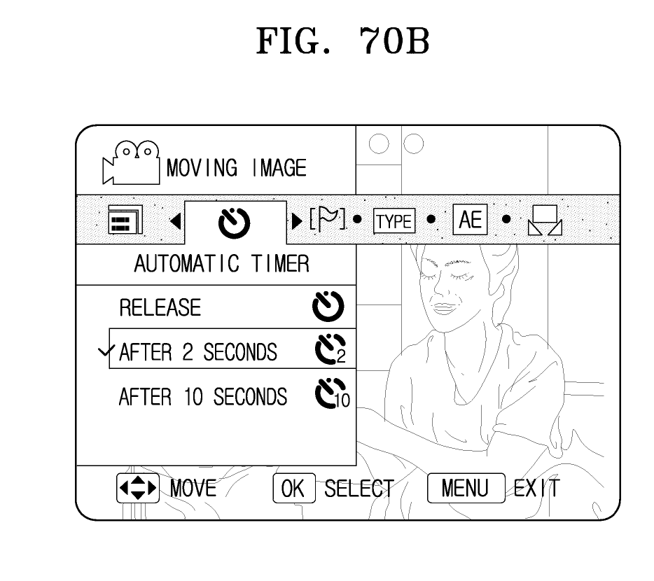

FIGS. 70A and 70B illustrate the LCD 1132 of FIG. 8, where the LCD 1132 displays an “automatic timer” menu and its sub-menus following the selecting of the “automatic timer” menu. As illustrated in FIG. 70A, if “release” is selected, the multifunctional video apparatus stops an automatic timer function. But, as illustrated in FIG. 70B, if “after 2 seconds” is selected, the multifunctional video apparatus starts to image an object after 2 seconds when the record start/stop button 1138 of FIG. 9 is pushed down. If “after 10 seconds” is selected, the multifunctional video apparatus starts to image an object after 10 seconds when the record start/stop button 1138 is pushed down. When the settings are completed, the multifunctional video apparatus displays the icon guiding the automatic timer on the LCD 1132. When the “release” is set, no icon is displayed.

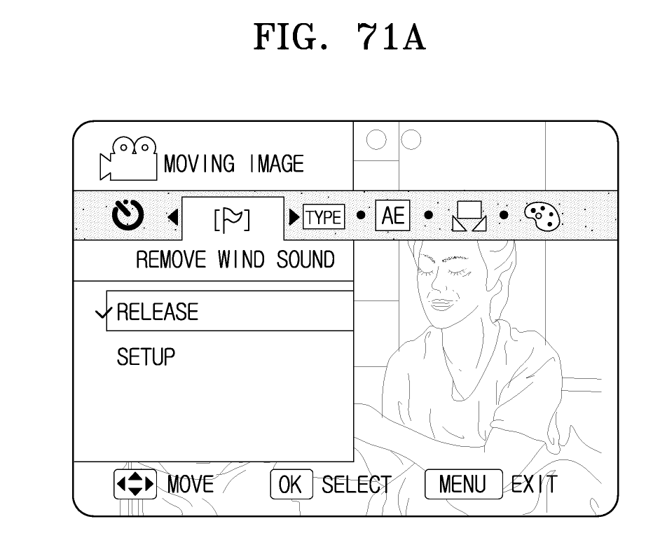

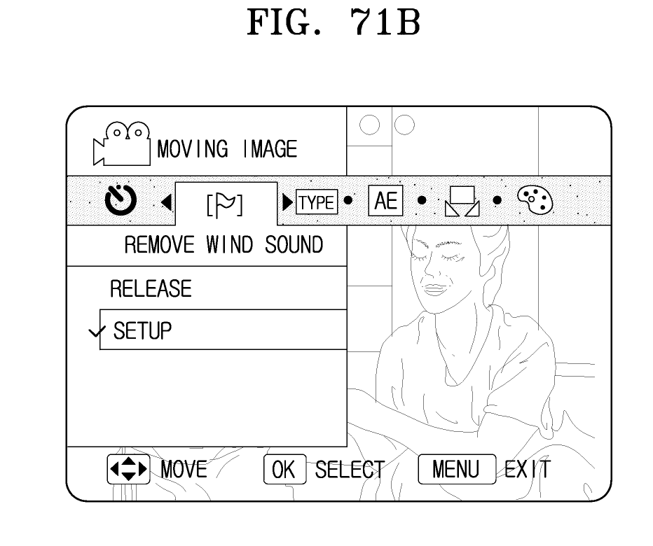

FIGS. 71A and 71B illustrate the LCD 1132 of FIG. 8, where the LCD 1132 displays a “remove wind sound” (e.g. wind sound elimination) menu and its sub-menus following the selecting of the “remove wind sound” menu. The wind sound elimination function causes a hard-blowing wind sound to be recorded at a level higher than a voice in a spot where it is blowing hard, i.e., on a beach or around a high-storied building. As illustrated in FIG. 71A, if “release” is selected, the multifunctional video apparatus cancels the wind sound elimination function. In contrast, as illustrated in FIG. 71 B, if “setup” is selected, the multifunctional video apparatus sets the wind sound elimination function. When the settings are completed, the multifunctional video apparatus displays the icon guiding the wind sound elimination on the LCD 1132. When “release” is set, no icon is displayed.

In the moving image filming mode, if the shortcut button 1110-1 of FIG. 8 is pushed down, the multifunctional video apparatus is converted into the moving image reproduction mode. In the moving image reproduction mode, if the shortcut button 1110-1 is pushed down, the multifunctional video apparatus is converted into the moving image filming mode.

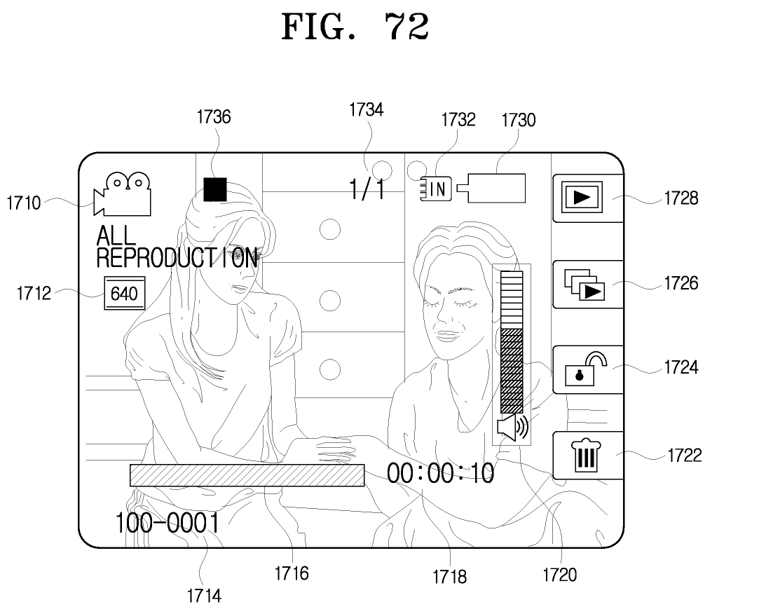

FIG. 72 illustrates the icons to be displayed on the LCD 1132 of FIG. 8 when the multifunctional video apparatus is operated in the moving image reproduction mode. As illustrated in FIG. 72, a present mode guide icon 1710, a moving image size guide icon 1712, a moving image number guide icon 1714, a reproduction progress guide icon 1716, a recorded time guide icon 1718, a volume guide icon 1720, a delete shortcut icon 1722, a locking shortcut icon 1724, a whole reproduction shortcut icon 1726, a filming/reproduction converting shortcut icon 1728, a battery state guide icon 1730, a recorded memory guide icon 1732, a present moving image number/total moving image guide icon 1734, and a stop/play/pause guide icon 1736, are displayed on the LCD 1132 of the multifunctional video apparatus in the moving image reproduction mode.

In the moving image reproduction mode, the multifunctional video apparatus reproduces the moving image recorded in the memory (e.g., one selected from the built-in memory and memory card) and displays the same on the LCD 1132. If the joystick 1114 of FIG. 8 is manipulated left and/or right, the multifunctional video apparatus displays a previous/next moving image of the moving image currently displayed which is recorded in the memory on the LCD 1132. In addition, if the joystick 1114 is pushed down for a short period of time, the multifunctional video apparatus suspends the reproduction of the moving image. If the joystick 1114 is pushed down for a long period of time, the multifunctional video apparatus stops the reproduction of the moving image. Also, if the joystick 1114 is manipulated upward and downward, the multifunctional video apparatus increases or decreases the volume accordingly.

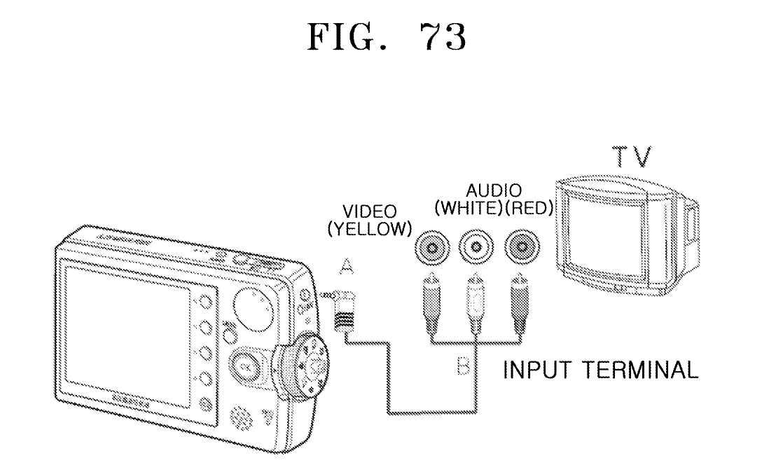

As illustrated in FIG. 73, the moving image reproduced by the multifunctional video apparatus is displayed on a TV set, if the multifunctional video apparatus is connected to the TV set via a video/audio cable.

In the moving image reproduction mode, the multifunctional video apparatus may adjust settings, including deletion of a moving image film, locking a setting of the moving image file, a reproduction setting of the whole moving image, and copying the moving image file, each of which will be described hereinafter.

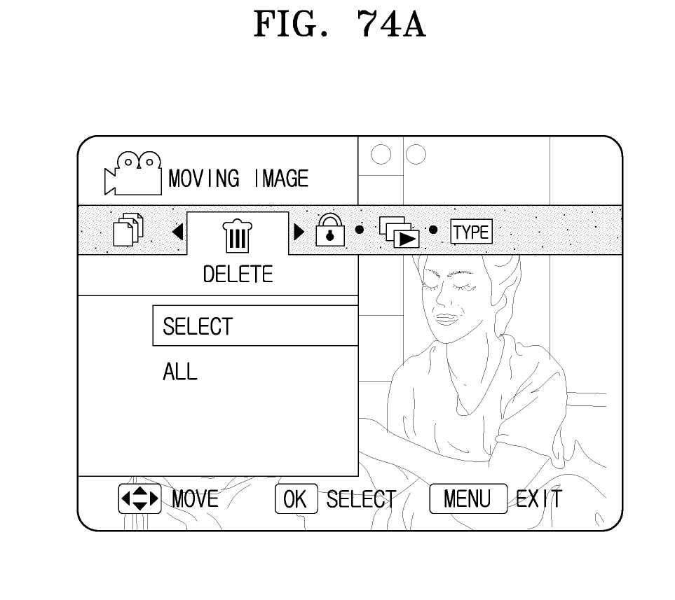

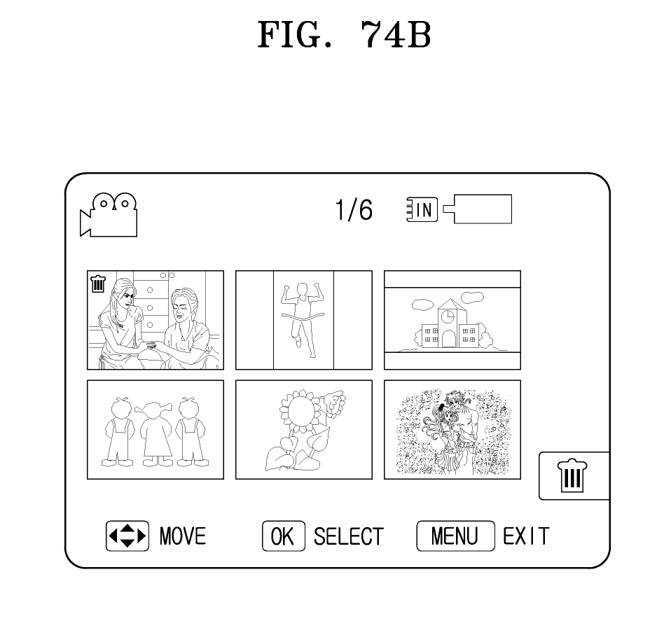

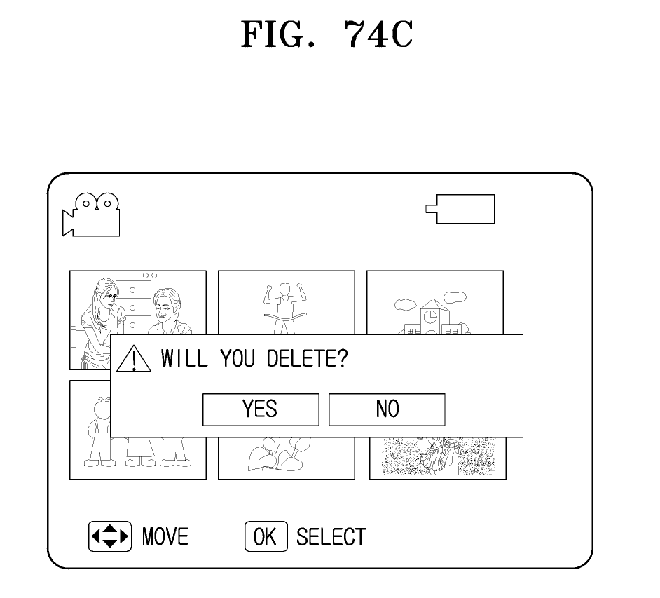

FIGS. 74A to 74C illustrate the LCD 1132 of FIG. 8, where the LCD 1132 displays a “delete” (e.g. moving image file deletion) menu and its sub-menu following the selecting of the “delete” menu. As illustrated in FIGS. 74A to 74C, if “select” is selected, the multifunctional video apparatus displays a multi-screen on the LCD 1132, and the user deletes the moving image file selected by the joystick 1114 of FIG. 8 through a deletion confirming procedure. In this instance, as illustrated in FIG. 74B, the multifunctional video apparatus displays a deleted icon on the moving image file selected by the user on the multi-screen. In contrast, if “all” is selected, the multifunctional video apparatus deletes all the moving images recorded in the memory through a deletion confirming procedure.

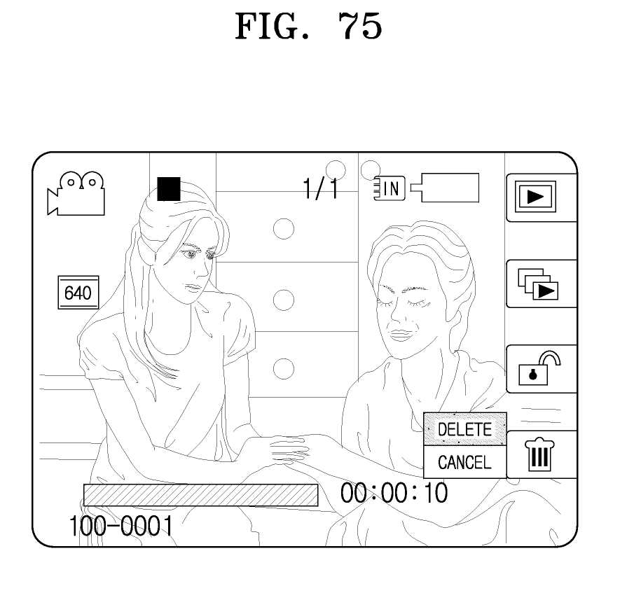

The moving image file deletion can be performed by the manipulation of the shortcut button-4 1110-4 of FIG. 8. FIG. 75 illustrates the LCD 1132 of FIG. 8, where the LCD 1132 displays a sub-menu when the shortcut button-4 1110-4 is manipulated while the reproducing moving image is displayed on the LCD 1132. As illustrated in FIG. 75, if “delete” is selected, the multifunctional video apparatus deletes the moving image displayed on the LCD 1132 through a deletion confirming procedure.

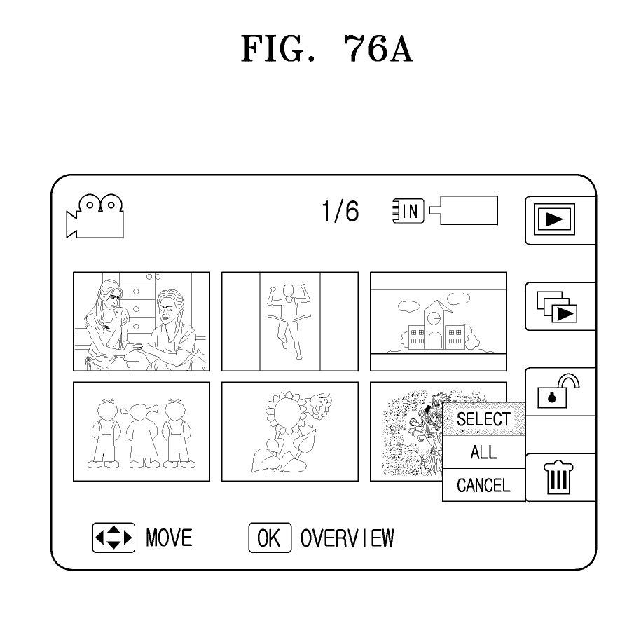

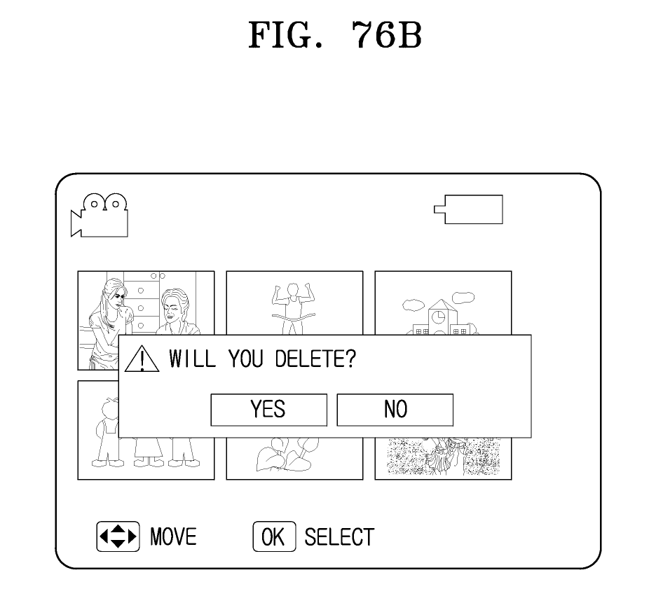

FIGS. 76A and 76B illustrate the LCD 1132 of FIG. 8, where the LCD 1132 displays a sub-menu when the shortcut button-4 1110-4 is manipulated while the multi-screen is displayed on the LCD 1132. As illustrated in FIGS. 76A and 76B, if “select” is selected, the multifunctional video apparatus deletes the moving image files selected by the user's joystick 1114 of FIG. 8 through a deletion confirming procedure. But, if “all” is selected, the multifunctional video apparatus deletes all the moving images recorded in the memory through a deletion confirming procedure.

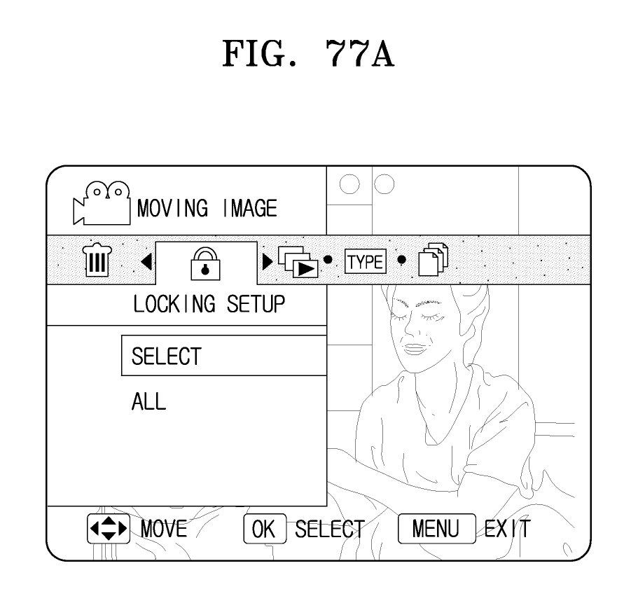

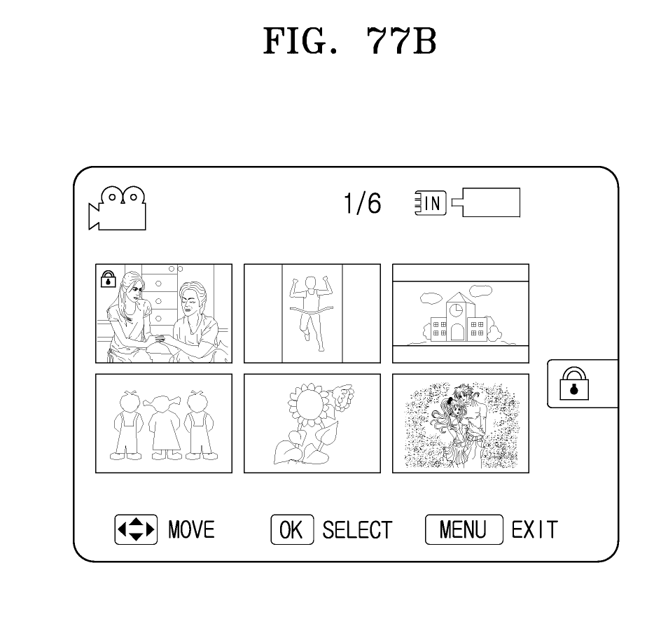

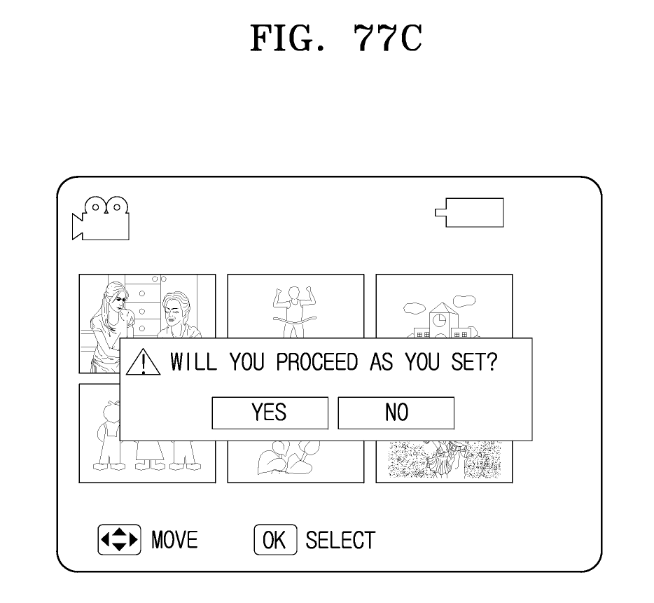

FIGS. 77A to 77C illustrate the LCD 1132 of FIG. 8, where the LCD 1132 displays a “locking setup” (e.g. moving image file locking) menu and its sub-menus following the selecting of the “locking setup” menu. As illustrated in FIGS. 77A to 77C, if “select” is selected, the multifunctional video apparatus displays a multi-screen on the LCD 1132, and the user locks the moving image file selected by the joystick 1114 of FIG. 8 through a confirming procedure. The locked moving image file can be deleted by a memory format or after an unlocking setting. As illustrated in FIG. 77B, the multifunctional video apparatus displays a locking icon on the moving image file selected by the user on the multi-screen. In contrast, if “all” is selected, the multifunctional video apparatus locks all the moving images recorded in the memory through a confirming procedure.

The moving image locking setting can be performed by the manipulation of the shortcut button-3 1110-3 of FIG. 8. Specifically, if the shortcut button-3 1110-3 is pushed down while the moving image reproduction image is displayed on the LCD 1132, the multifunctional video apparatus unlocks the moving image file displayed on the LCD 1132.

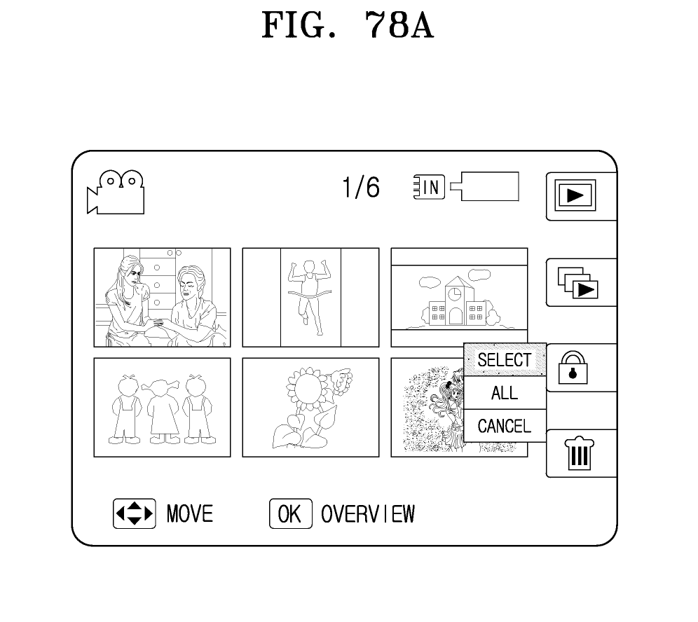

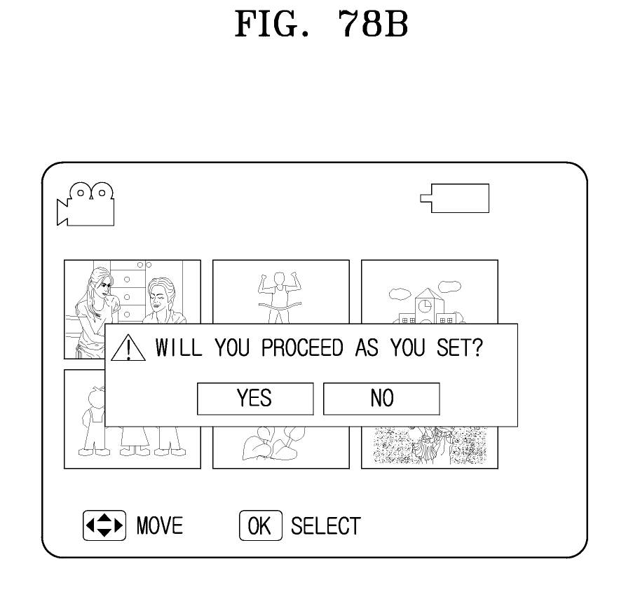

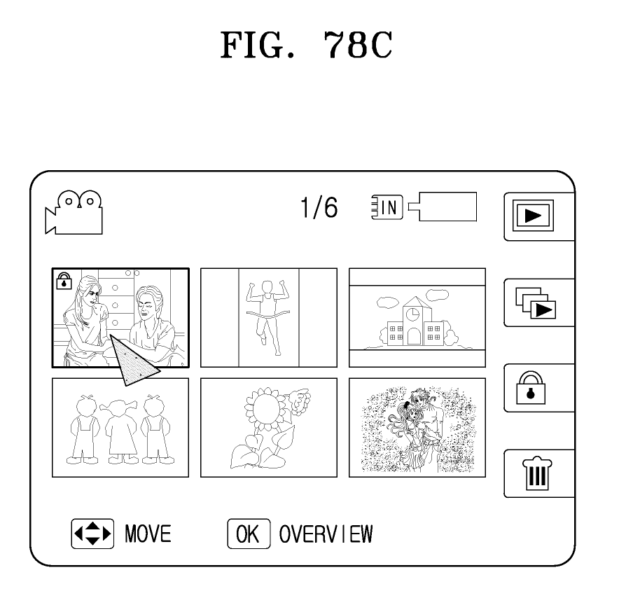

FIGS. 78A to 78C illustrate the LCD 1132 of FIG. 8, where the LCD 1132 displays a sub-menu when the shortcut button-3 1110-3 of FIG. 8 is manipulated while the multi-screen is displayed on the LCD 1132. As illustrated in FIGS. 78A to 78C, if “select” is selected, the multifunctional video apparatus locks the moving image file selected by the joystick 1114 of FIG. 8 through a confirming procedure, and a locking icon is displayed on the locked moving image file. In contrast, if “all” is selected, the multifunctional video apparatus locks all the moving images recorded in the memory through a confirming procedure.

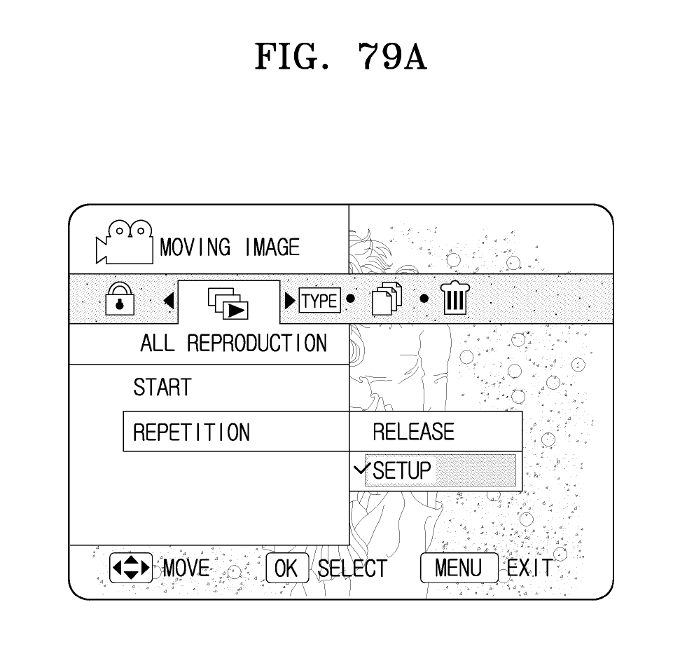

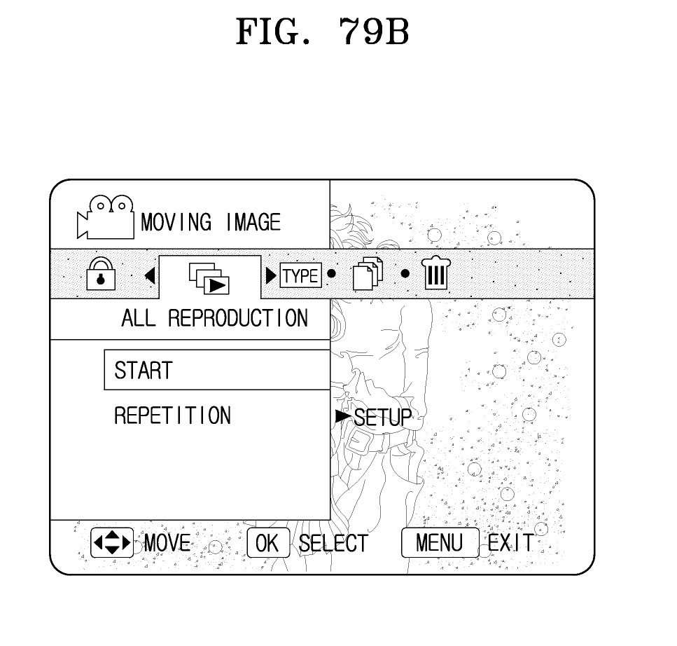

FIGS. 79A and 79B illustrate the LCD 1132 of FIG. 8, where the LCD 1132 displays an “all reproduction” (e.g. moving image whole reproduction) menu and its sub-menus following the selecting of the “all reproduction” menu. The moving image whole reproduction is a function to sequentially reproduce the whole of the moving image recorded in the memory. As illustrated in FIG. 79A, if “setup” subordinate to the “repetition” icon is selected, the multifunctional video apparatus repeatedly performs the reproduction of the whole moving image. In contrast, if “release” is selected, the multifunctional video apparatus sets so that the reproduction of the whole moving image is not repeated. As illustrated in FIG. 79B, if “start” is selected, the multifunctional video apparatus starts to reproduce the whole moving image. Otherwise, if the shortcut button-2 1110-2 of FIG. 8 is manipulated, the multifunctional video apparatus reproduces the whole moving image.

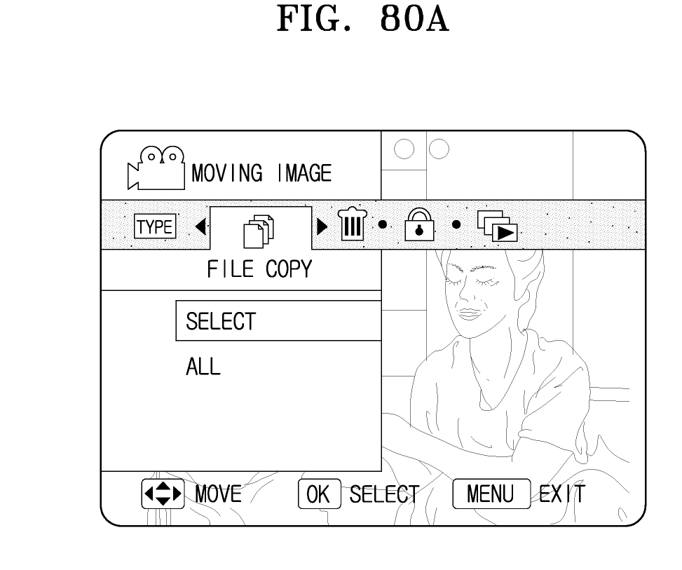

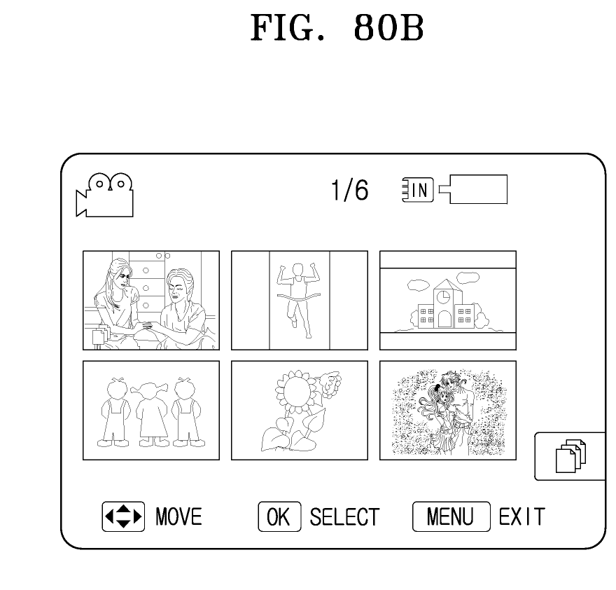

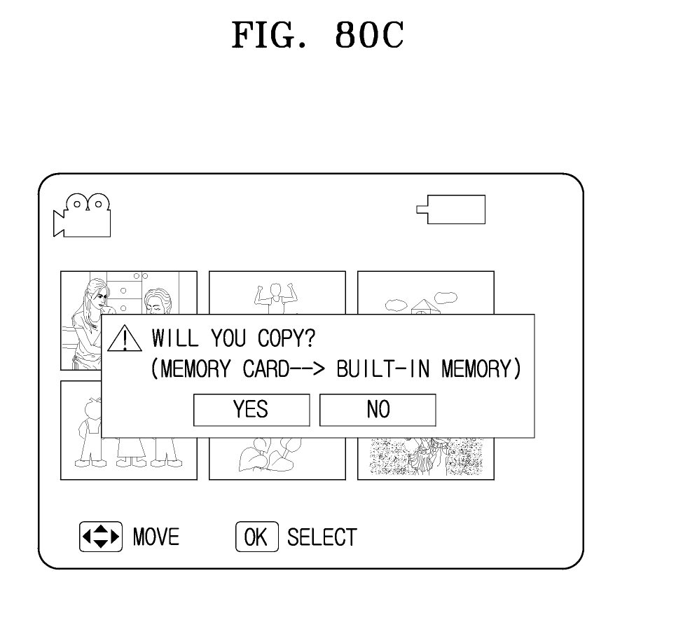

FIGS. 80A to 80C illustrate the LCD 1132 of FIG. 8, where the LCD 1132 displays a “file copy” (e.g. moving image file copy) menu and its sub-menus following the selecting of the “file copy” menu. The moving image file copy is a function to copy the moving image recorded in the memory into other memory. As illustrated in FIGS. 80A to 80C, if “select” is selected, the multifunctional video apparatus displays the multi-screen on the LCD 1132, and the user copies the moving image file selected by the joystick 1114 of FIG. 8 through a confirming procedure. In this instance, as illustrated in FIG. 80B, the multifunctional video apparatus displays an icon to be copied on the moving image file selected by the user on the multi-screen. If “all” is selected, the multifunctional video apparatus copies the all moving image files recorded in the memory through a confirmation procedure.

Operation of the multifunctional video apparatus in the music playback mode will new be described in detail. The music playback mode is a function to reproduce a music file recorded in the memory to output it to a loudspeaker or an audio output terminal.

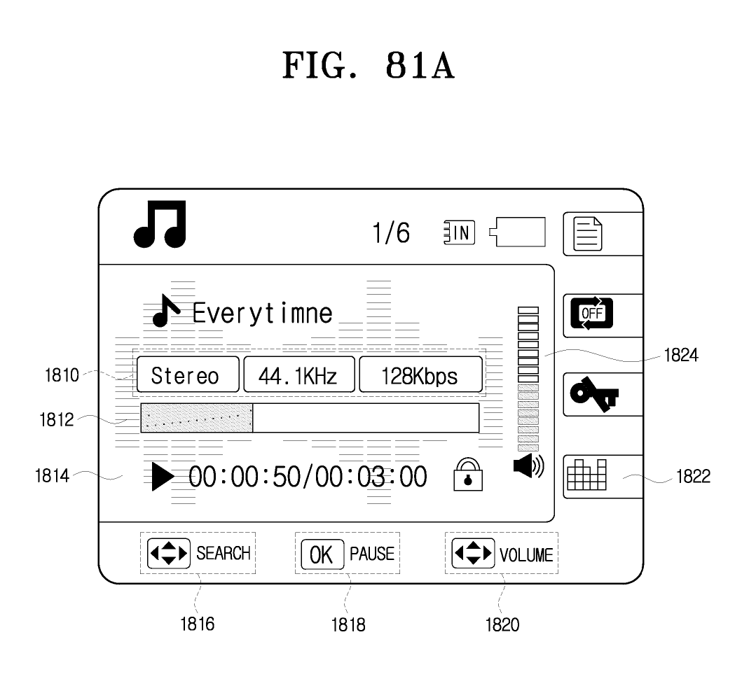

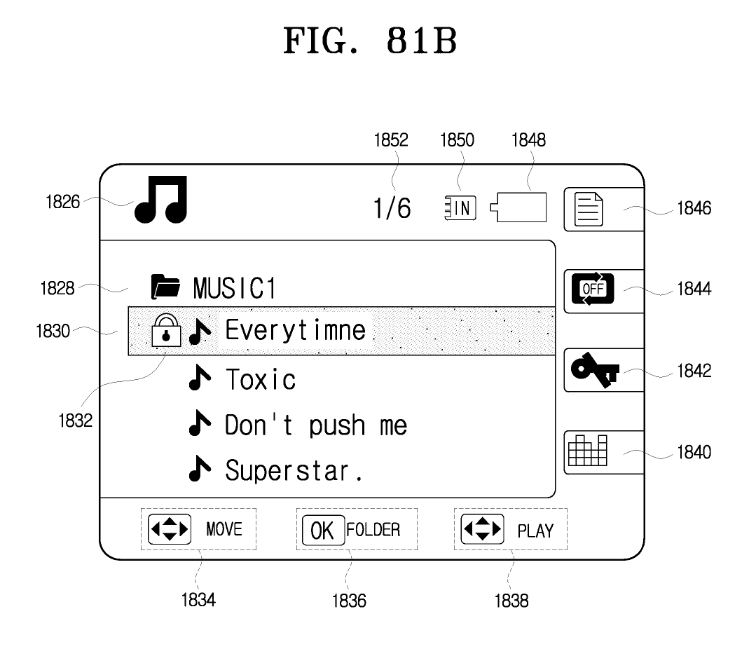

Illustrated in FIGS. 81A and 81B are the icons displayable on the LCD 1132 of FIG. 8 in operation of the present multifunctional video apparatus in music playback mode. As illustrated in FIGS. 81A and 81B, icons displayed on the LCD 1132 of the multifunctional video apparatus in music playback mode are a file information guide icon 1810, a playback proceeding bar guide icon 1812, a playback time/record time guide icon 1814, a seek guide icon 1816, a play/pause guide icon 1818, a volume adjustment guide icon 1820, an equalizer shortcut icon 1822, a volume size guide icon 1824, a mode guide icon 1826, a present folder name guide icon 1828, a music title guide icon 1830, a lock guide icon 1832, a movement guide icon 1834, a folder guide icon 1836, a playback guide icon 1838, a deletion shortcut icon 1840, a playback-lock shortcut icon 1842, a repetitive playback shortcut icon 1844, a file list display shortcut icon 1846, a battery state guide icon 1848, a record memory guide icon 1850, and a present file number/total file number guide icon 1852.

When the music playback mode is selected, the present multifunctional video apparatus displays the music file that has been reproduced before. At this time, when the joystick 1114 of FIG. 8 is shortly moved to the right and/or left, the multifunctional video apparatus displays on the LCD 1132 the next/previous music file to the present displayed music file among the music files recorded in the memory. In addition, when the joystick 1114 is pressed, the multifunctional video apparatus starts to playback the music file. During the playback of the music file, if the joystick 1114 is pressed, the multifunctional video apparatus pauses the playback of the music file, and if the joystick 1114 is pressed for a long time, the multifunctional video apparatus stops the playback of the music file. In the meantime, if the joystick 1114 is moved farther to the right and/or left, the multifunctional video apparatus quickly winds the present displayed music file among the music files recorded in the memory in forward and/or backward direction. Further, if the joystick 1114 is moved upward and/or downward, the multifunctional video apparatus increases/decreases the volume size.

In music playback mode, when the shortcut button 1 1110-1 of FIG. 8 is pressed, the multifunctional video apparatus displays on the LCD 1132 a music file list as illustrated in FIG. 81 B. When the music file list is displayed, a user can move to a desired music folder and a music file therein and select it through the manipulation of the joystick 1114 of FIG. 8 so that the multifunctional video apparatus reproduces the selected music file.

In the meantime, in music playback mode, when the shortcut button 3 1110-3 of FIG. 8 is pressed, the multifunctional video apparatus sets all buttons other than the mode dial 1118 of FIG. 8 to a lock state.

In music playback mode, the multifunctional video apparatus can implement operation of, for example, music file repetitive playback setting, equalizer setting, music file deleting, and music file locking setting. The respective items above will now be explained in detail.

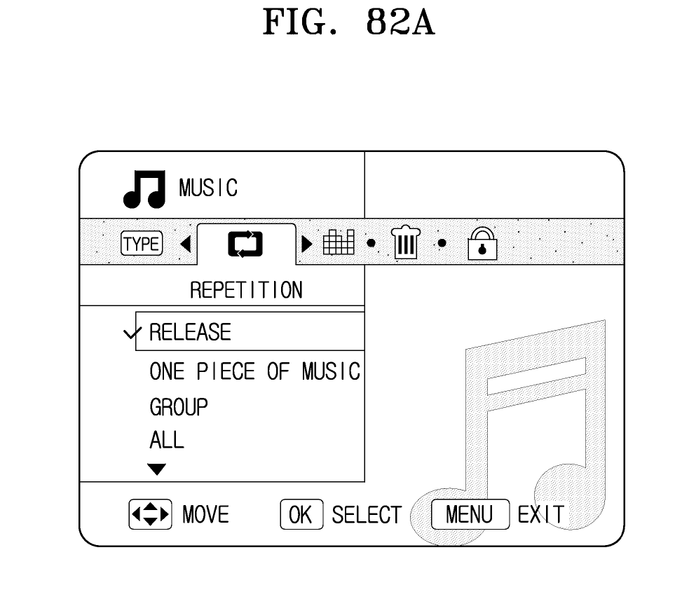

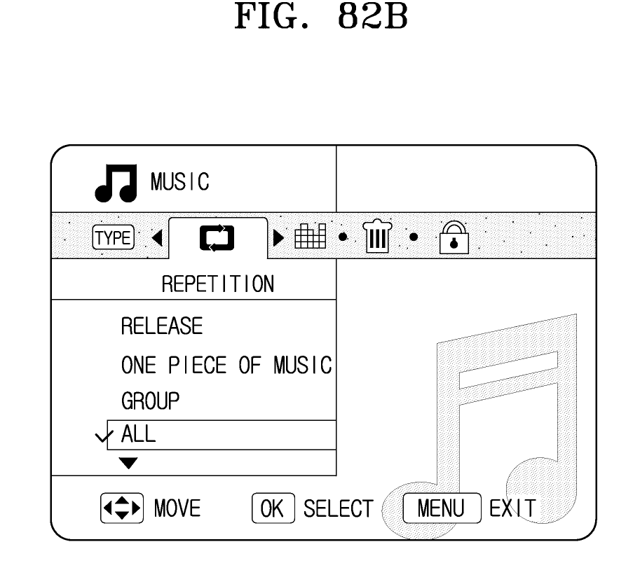

FIGS. 82A and 82B illustrate the LCD 1132 of FIG. 8, where the LCD 1132 displays a “repetition” (e.g. music file repetitive playback) menu and its sub-menus following the selecting of the “repetition” menu. As illustrated in FIG. 82A, when “release” is selected, the multifunctional video apparatus reproduces once the music files in order from the presently selected music file to the last one in the present folder, and then reproduces the first music file in the present folder. In contrast, as illustrated in FIG. 82B, when “all” is selected, the multifunctional video apparatus repetitively reproduces all the music files stored in all folders MUSIC1-MUSIC4. When “one piece of music” is selected, the multifunctional video apparatus repetitively reproduces the selected one piece of music. When “group of music” is selected, the multifunctional video apparatus repetitively reproduces the selected group of music. When “shuffle” is selected, the multifunctional video apparatus randomly reproduces once the music files stored in the present folder. The music file repetitive playback setting may be made through the shortcut button 2 1110-2 of FIG. 8, and the setting may be adjusted differently in accordance with the number of times the shortcut button 2 1110-2 is manipulated.

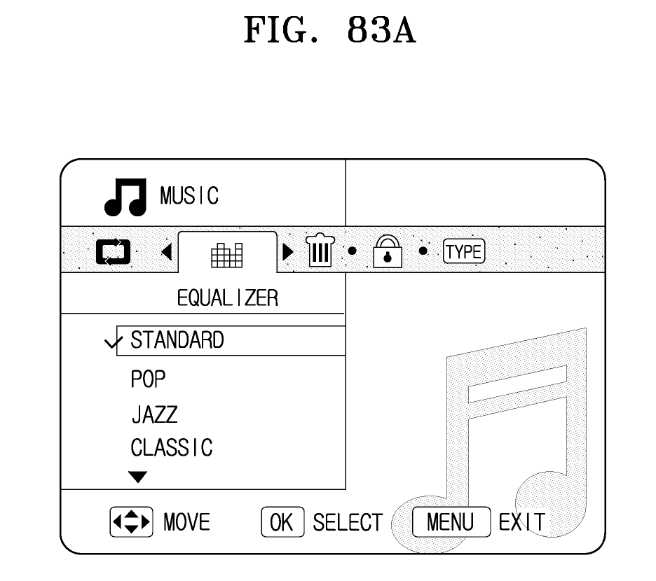

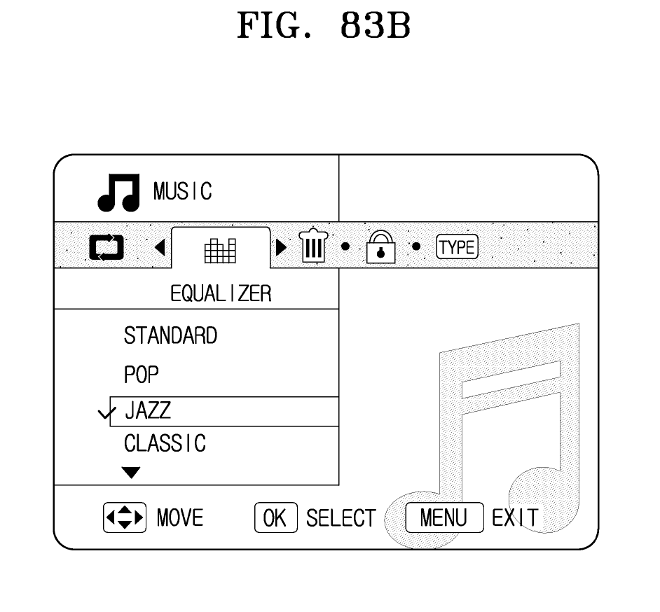

FIGS. 83A and 83B illustrate the LCD 1132 of FIG. 8, where the LCD 1132 displays an “equalizer” menu and its sub-menus following the selecting of the “equalizer” menu. As illustrated in FIG. 83A, when “standard” is selected, the multifunctional video apparatus sets to a standard equalizer. In contrast, as illustrated in FIG. 83B, when the “jazz” is selected, the multifunctional video apparatus sets to an equalizer suitable to play jazz music. When “pop” is selected, the multifunctional video apparatus sets to an equalizer suitable to play pop music, and when “classic” is selected, the multifunctional video apparatus sets to an equalizer suitable to play classical music. The equalizer setting can be made through the shortcut button 4 1110-4 of FIG. 8, and the equalizer setting may be adjusted differently in accordance with the number of times the shortcut button 4 1110-4 is manipulated.

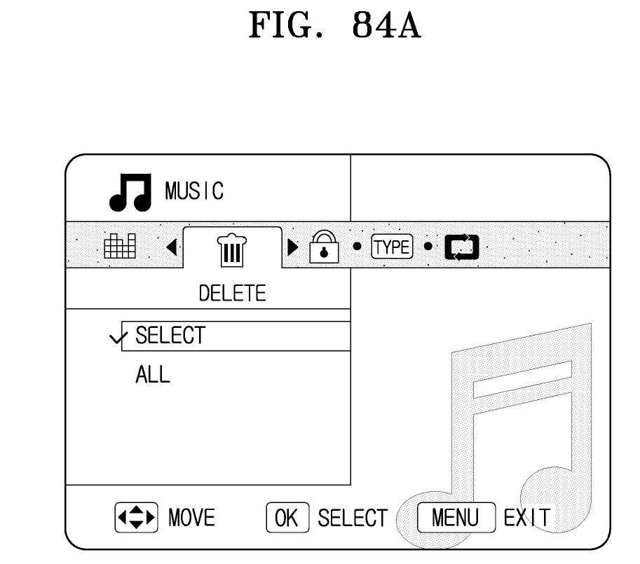

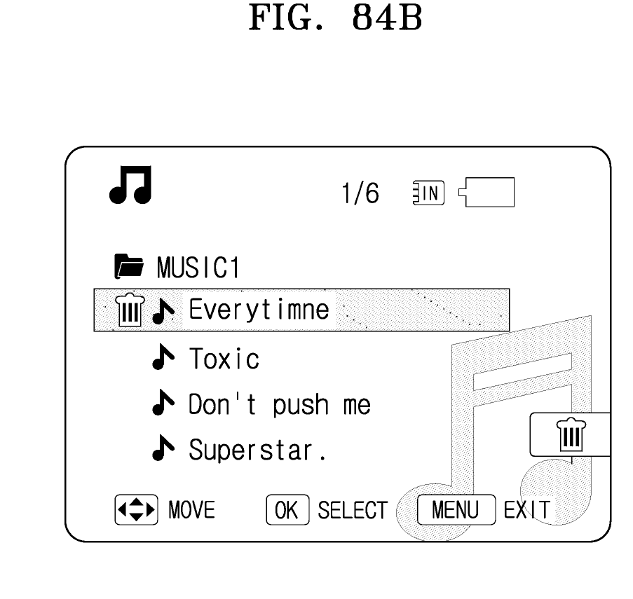

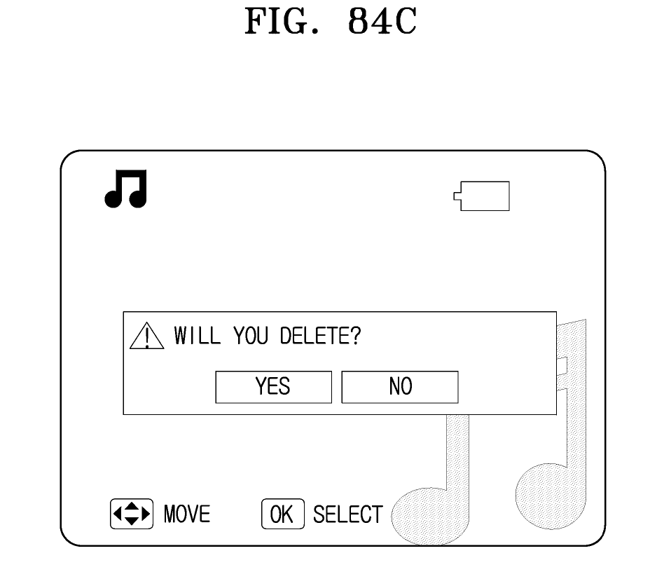

FIGS. 84A to 84C illustrate the LCD 1132 of FIG. 8, where the LCD 1132 displays a “delete” (e.g. music file deleting) menu and its sub-menus following the selecting of the “delete” menu. As illustrated in FIGS. 84A to 84C, when “select” is selected, the multifunctional video apparatus displays the music file list on the LCD 1132, and a user then deletes the selected music file through a confirmation procedure for deletion, using the joystick 1114 of FIG. 8. As illustrated in FIG. 84B, the multifunctional video apparatus displays a deletion icon for the music file selected by user in the music file list. In contrast, when “all” is selected, the multifunctional video apparatus deletes all the music files recorded in the memory through the confirmation procedure to delete all of music files.

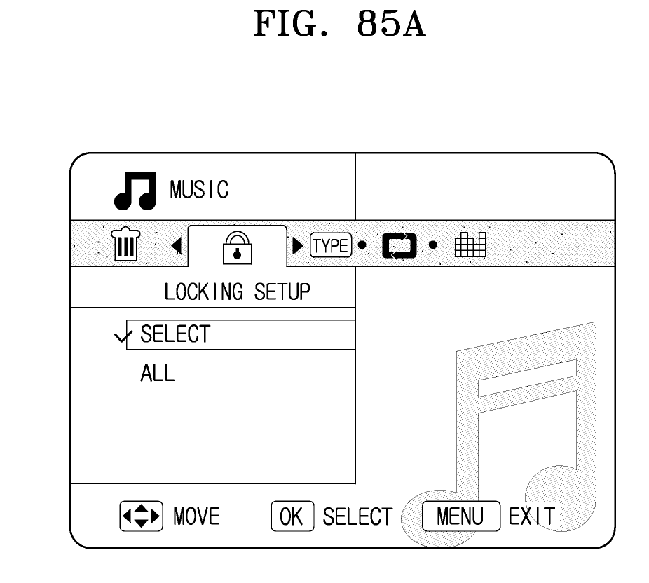

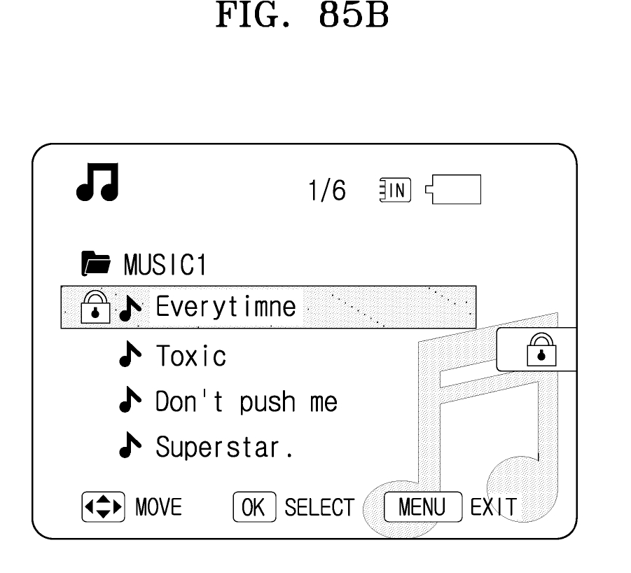

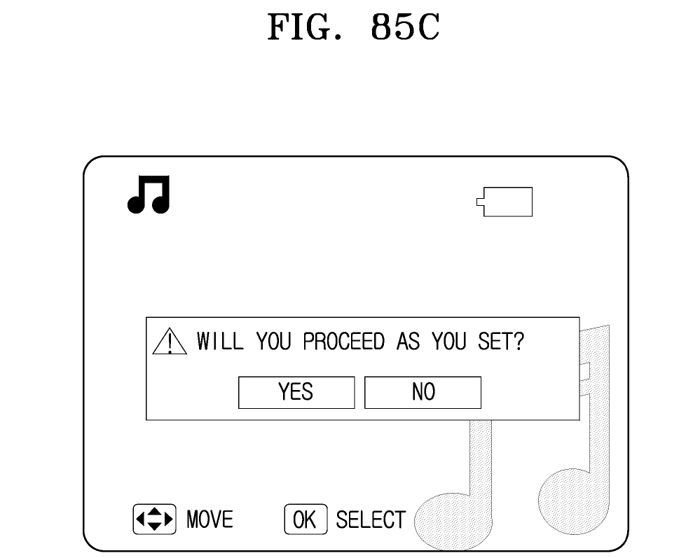

FIGS. 85A to 85C illustrate the LCD 1132 of FIG. 8, where the LCD 1132 displays a “music file locking setup” (e.g. music file locking) menu and its sub-menus following the selecting of the “locking setup” menu. As illustrated in FIGS. 85A to 85C, when the “select” is selected, the multifunctional video apparatus displays the music file list on the LCD 1132, and a user then sets to a locking state the selected music file through a confirmation procedure, using the joystick 1114 of FIG. 8. The music file set to a locking state is not deleted until the memory is formatted or the locking setting is released. As illustrated in FIG. 85B, the multifunctional video apparatus displays a locking icon for the music file selected by user on the multi-screen. In contrast, when “all” is selected, the multifunctional video apparatus sets to a locking state all the music files recorded in the memory through the confirmation procedure.

Now an operation of the multifunctional video apparatus operates in audio mode will be described. The audio mode consists of an audio recording mode in which the multifunctional video apparatus records in a memory (an internal memory or a memory card) an audio file created through audio recording and an audio playback mode in which the multifunctional video apparatus reproduces the audio file recorded in the memory and outputs it to a speaker or an audio output terminal. The respective modes will now be explained in detail.

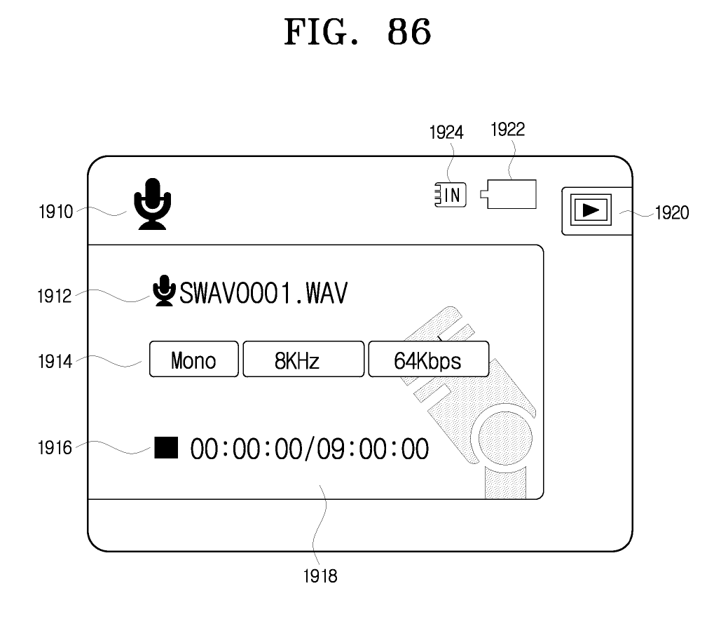

Illustrated in FIG. 86 are the icons displayable on the LCD 1132 of FIG. 8 in operation of the present multifunctional video apparatus in audio recording mode. As illustrated in FIG. 86, icons displayed on the LCD 1132 of the multifunctional video apparatus in audio recording mode include a present mode guide icon 1910, a target recording file guide icon 1912, a file information guide icon 1914, a standby/record guide icon 1916, a recording time/remaining time guide icon 1918, a record/playback switching shortcut icon 1920, a battery state guide icon 1922, and a record memory guide icon 1924.

In audio recording mode, when the recording start/stop button 1138 of FIG. 9 is pressed, the multifunctional video apparatus starts recording audio. In the course of audio recording, when the recording start/stop button 1138 is pressed, the multifunctional video apparatus stops audio recording. Whenever the audio recording is stopped, the multifunctional video apparatus records in a memory a file of the audio recorded until that time.

In audio recording mode, when the shortcut button 1 1110-1 of FIG. 8 is pressed, the multifunctional video apparatus is switched into the audio playback mode. Then, in the audio playback mode, when the shortcut button 1 1110-1 is pressed, the multifunctional video apparatus is switched into the audio recording mode. The audio playback mode will now be explained in detail.

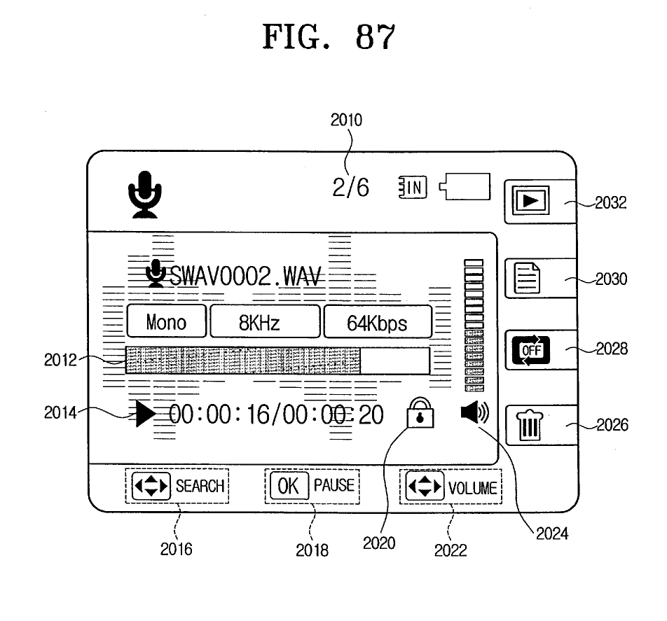

Illustrated in FIG. 87 are the icons displayable on the LCD 1132 of FIG. 8 in operation of the present multifunctional video apparatus in audio playback mode. As illustrated in FIG. 87, icons displayed on the LCD 1132 of the multifunctional video apparatus in audio playback mode include a present audio file number/total audio file number guide icon 2010, a playback proceeding bar guide icon 2012, a playback time/record time guide icon 2014, a file seek guide icon 2016, a play/pause guide icon 2018, a lock guide icon 2020, a volume adjustment guide icon 2022, a volume size guide icon 2024, a deletion shortcut icon 2026, a repetitive playback shortcut icon 2028, a audio file list display shortcut icon 2030, and a record/playback switching shortcut icon 2032.

When the audio playback mode is selected, the present multifunctional video apparatus displays the audio file that has been previously recorded. When the joystick 1114 of FIG. 8 is moved a short distance to the right and/or left, the multifunctional video apparatus displays on the LCD 1132 the next/previous audio file to the present displayed audio file among the audio files recorded in the memory. In addition, when the joystick 1114 is pressed, the multifunctional video apparatus starts to payback the audio file. During playback of the audio file, if the joystick 1114 is shortly pressed, the multifunctional video apparatus pauses the playback of the audio file, and if the joystick 1114 is pressed for a long time, the multifunctional video apparatus stops the playback of the audio file. In the meantime, if the joystick 1114 is moved farther to the right and/or left, the multifunctional video apparatus quickly winds the present displayed audio file among the audio files recorded in the memory in forward and/or backward direction. Further, if the joystick 1114 is moved upward and/or downward, the multifunctional video apparatus increases and/or decreases the volume size.

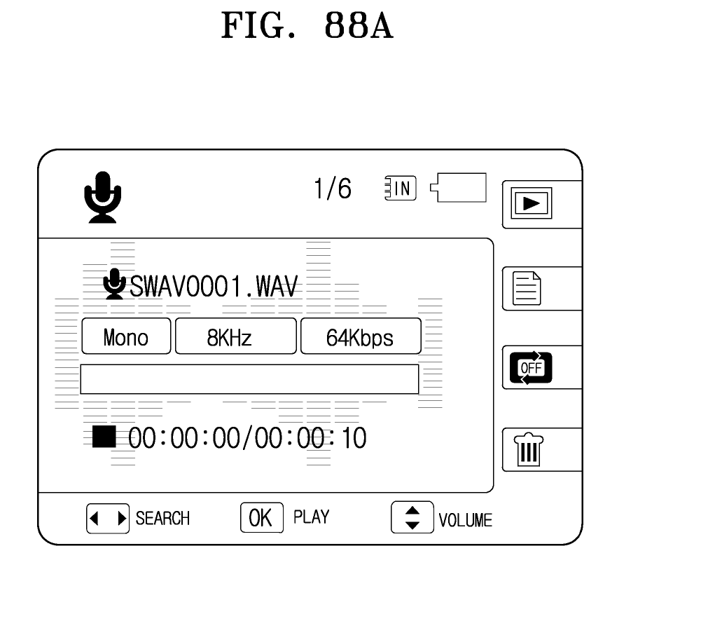

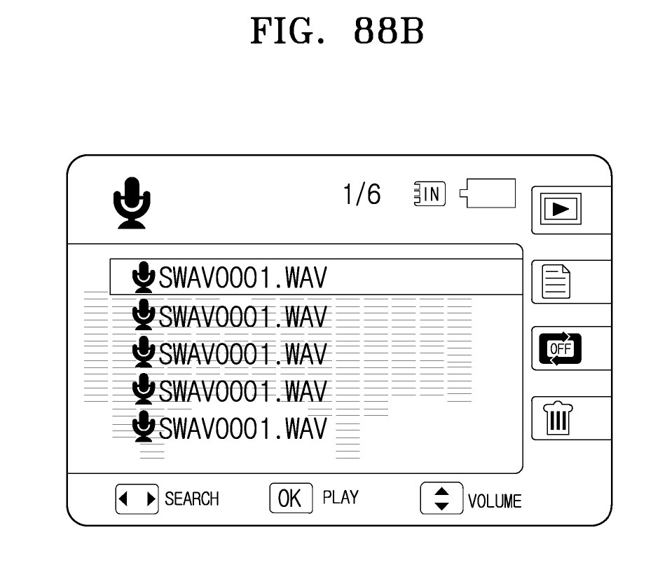

When the shortcut button 2 1110-2 of FIG. 8 is pressed while the audio file being displayed on the LCD 1132 of FIG. 8 as illustrated in FIG. 88A, the multifunctional video apparatus displays on the LCD 1132 an audio file list as illustrated in FIG. 88B. When the audio file list is displayed, a user can move to a desired music file and select it through the manipulation of the joystick 1114 of FIG. 8 so that the multifunctional video apparatus reproduces the selected music file.

In audio playback mode, the multifunctional video apparatus can implement an audio file repetitive playback, an audio file deleting, an audio file locking setting, and an audio file copying. The respective items above will now be explained in detail.

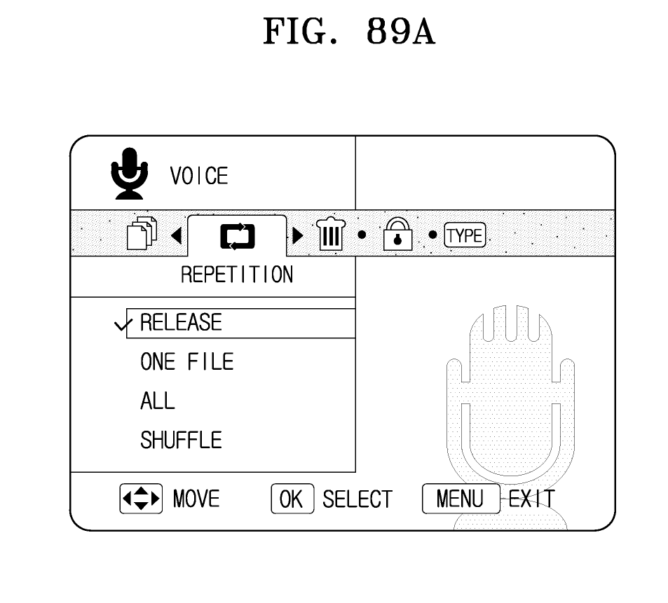

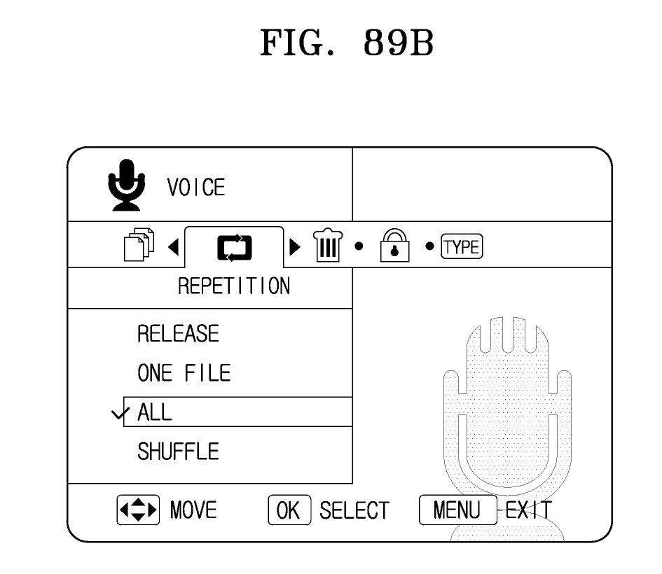

FIGS. 89A and 89B illustrate the LCD 1132 of FIG. 8, where the LCD 1132 displays an “repetition” (e.g. audio file repetitive playback) menu and its sub-menus following the selecting of the “repetition” menu. As illustrated in FIG. 89A, when “release” is selected, the multifunctional video apparatus reproduces once the presently selected audio file. In contrast, as illustrated in FIG. 89B, when “all” is selected, the multifunctional video apparatus repetitively reproduces all the audio files. When “one file” is selected, the multifunctional video apparatus repetitively reproduces the selected one file, and when the “shuffle” is selected, the multifunctional video apparatus randomly reproduces the stored audio files once. The audio file repetitive playback setting may be made through the shortcut button 3 1110-3 of FIG. 8, and the setting may be adjusted differently in accordance with the number of times the shortcut button 3 1110-3 is manipulated.

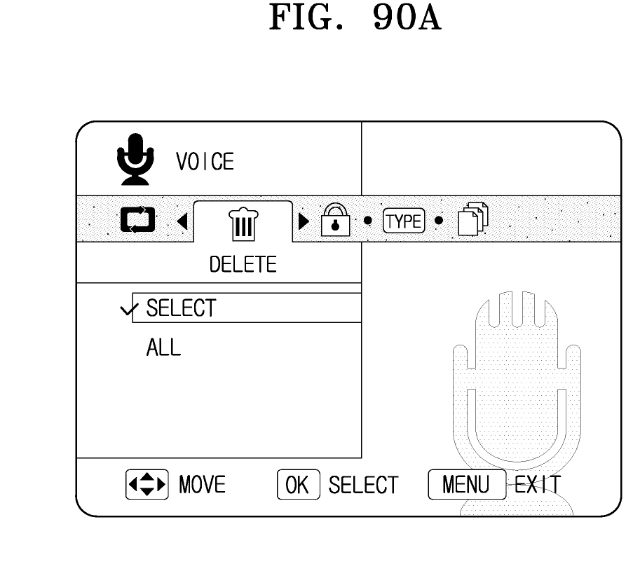

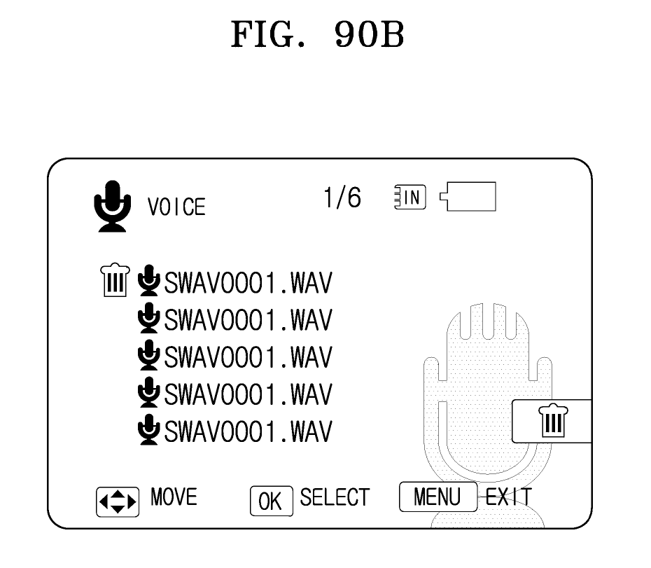

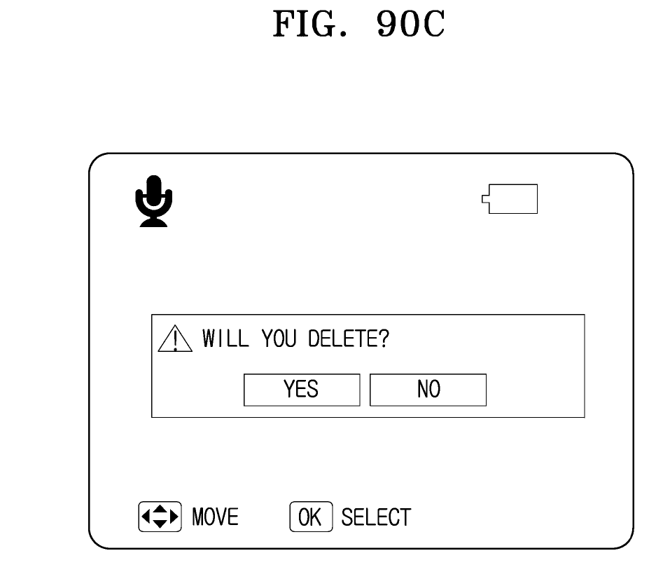

FIGS. 90A to 90C illustrate the LCD 1132 of FIG. 8, where the LCD 1132 displays an “delete” (e.g. audio file deleting) menu and its sub-menus following the selecting of the “delete” menu. As illustrated in FIGS. 90A to 90C, when “select” is selected, the multifunctional video apparatus displays the audio file list on the LCD 1132, and a user then deletes the selected audio file through a confirmation procedure for deletion, using the joystick 1114 of FIG. 8. As illustrated in FIG. 90B, the multifunctional video apparatus displays a deletion icon for the audio file selected by user in the audio file list. In contrast, when “all” is selected, the multifunctional video apparatus deletes all the audio files recorded in the memory though the confirmation procedure to delete all of audio files.

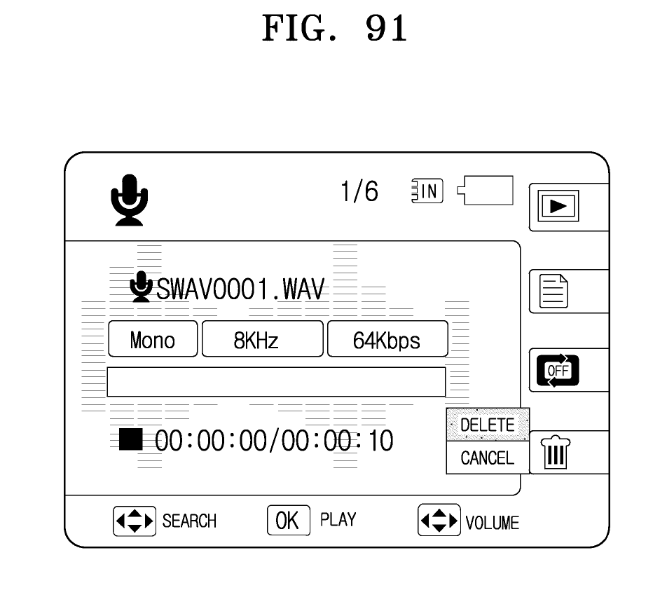

The audio file deletion can also be carried out by the manipulation of the shortcut button 4 1110-4 of FIG. 8. FIG. 91 illustrates the LCD 1132 of FIG. 8 in which the shortcut button 4 1110-4 is manipulated while the audio file playback screen being displayed on the LCD 1132, and the sub-menus thereof are displayed. As illustrated in FIG. 91, when “delete” is selected, the multifunctional video apparatus deletes the audio file displayed on the LCD 1132 through a confirmation procedure for deletion.

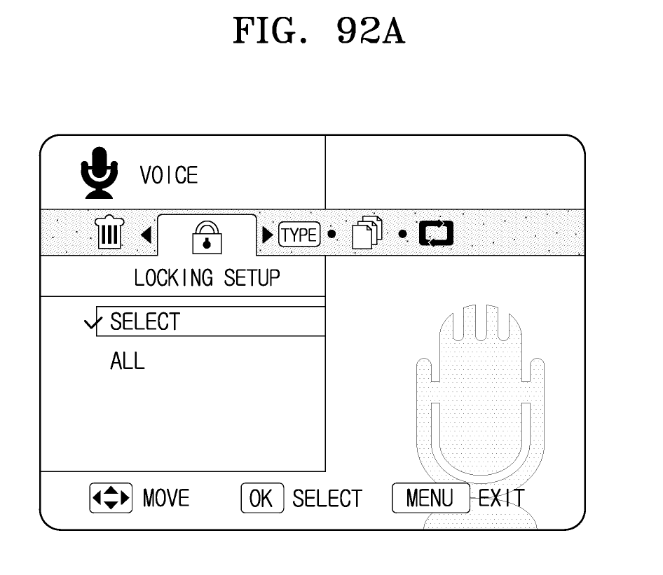

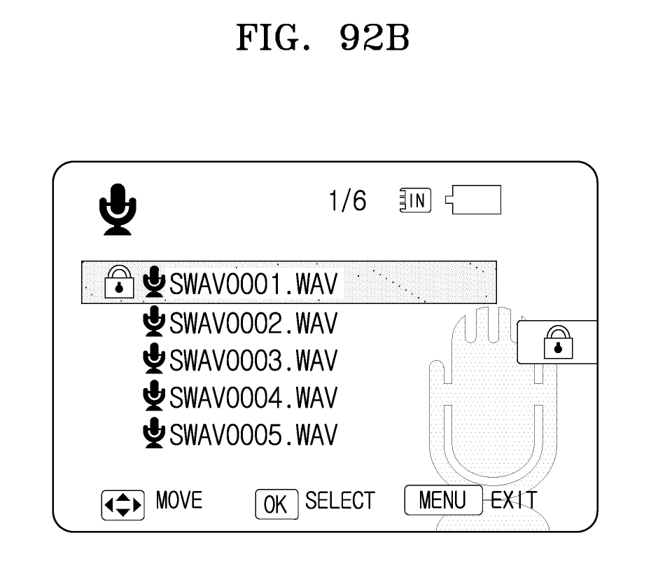

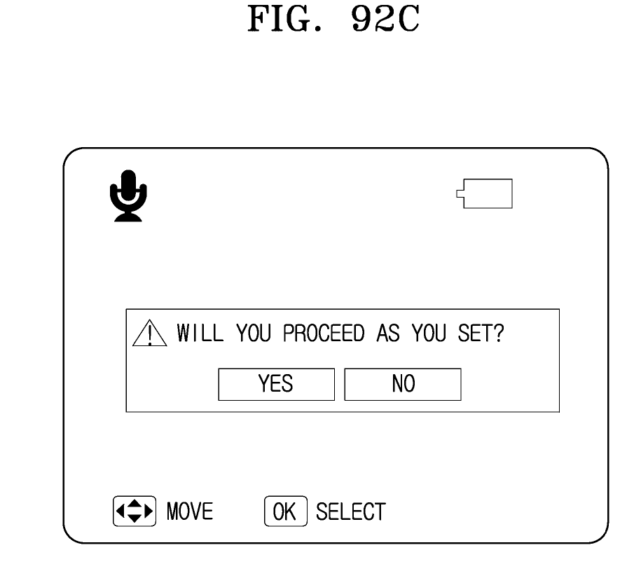

FIGS. 92A to 92C illustrate the LCD 1132 of FIG. 8 in which the menu, “locking setup” (e.g. audio file locking setting), is selected and the sub-menus thereof are displayed. As illustrated in FIGS. 92A to 92C, when “select” is selected, the multifunctional video apparatus displays the audio file list on the LCD 1132, and a user then sets to a locking state the selected audio file through a confirmation procedure, using the joystick 1114 of FIG. 8. The audio file set to a locking state is not deleted until the memory is formatted or the locking setting is released. As illustrated in FIG. 92B, the multifunctional video apparatus displays a locking icon for the audio file selected by user on the multi-screen. In contrast, when “all” is selected, the multifunctional video apparatus sets to a locking state all the audio files recorded in the memory through a confirmation procedure.

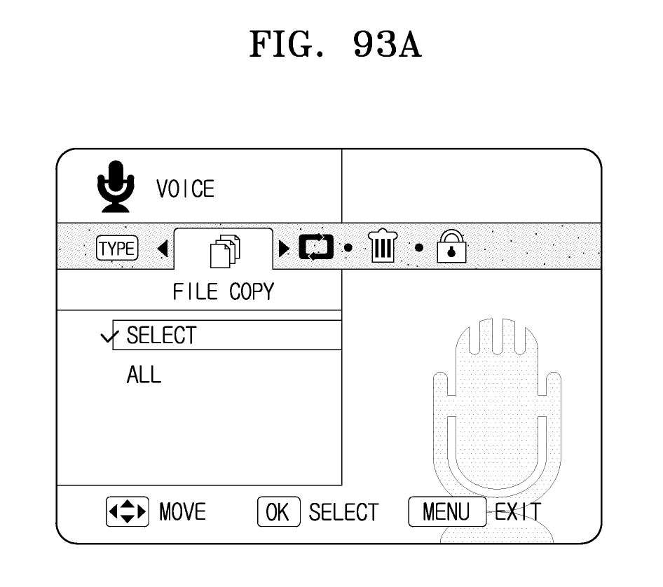

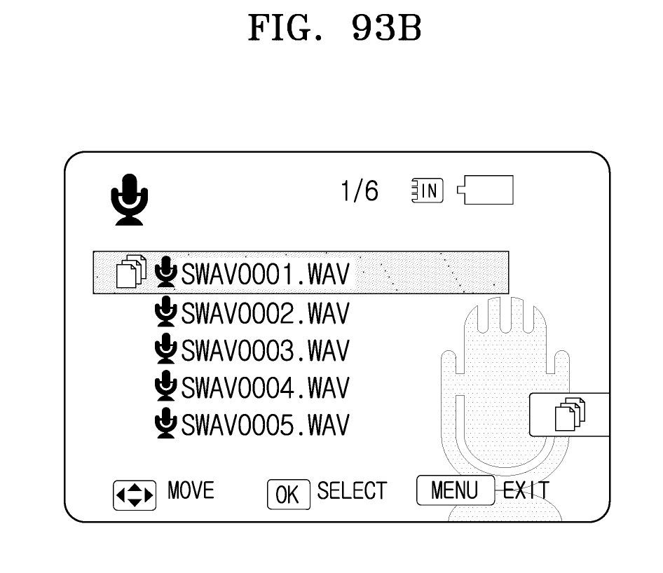

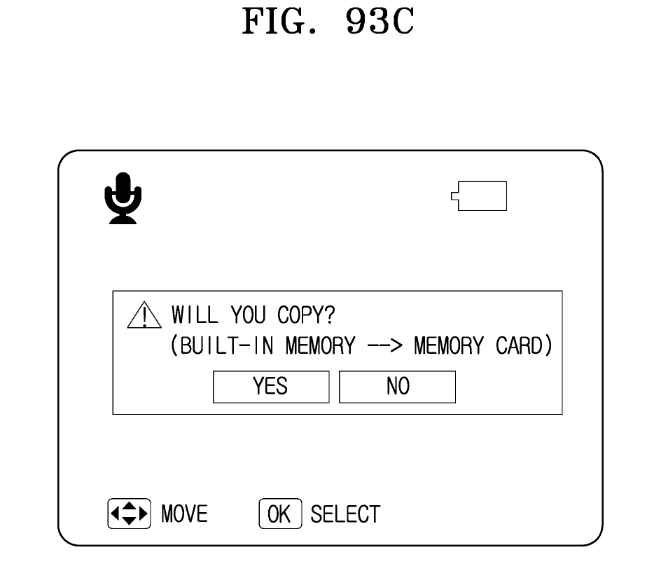

FIGS. 93A to 93C illustrate the LCD 1132 of FIG. 8 “file copy” (e.g. audio file copying) menu and its sub-menus following the selecting of the “file copy” menu. The audio file copying is a function of copying to another memory the audio file recorded in a memory that is presently set as a record memory. As illustrated in FIGS. 93A to 93C, when the “select” is selected, the multifunctional video apparatus displays a multi-screen on the LCD 1132, and a user then implements the copying of the audio file selected using the joystick 1114 of FIG. 8, through a confirmation procedure. As illustrated in FIG. 93B, the multifunctional video apparatus displays a target copy icon for the audio file selected by user on the multi-screen. In contrast, when “all” is selected, the multifunctional video apparatus implements the copying of all the audio files recorded in the memory through a confirmation procedure.

The multifunctional video apparatus can operate in a PC camera mode. The PC camera mode is a function of sending a motion image created through photographing to a PC connected with the multifunctional video apparatus. The PC camera function is implemented by USB communication between the multifunctional video apparatus and the PC.

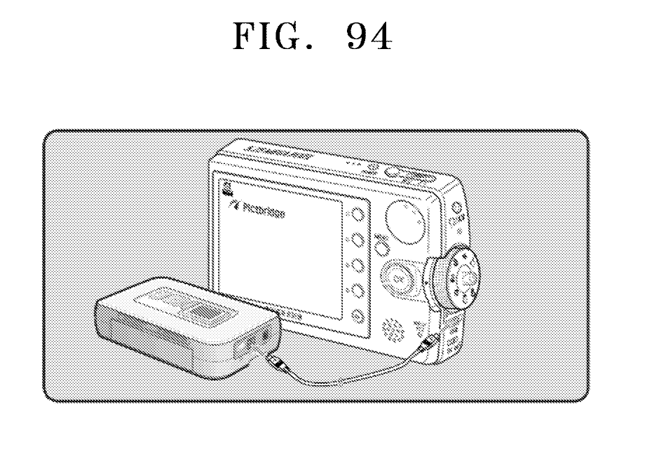

The multifunctional video apparatus can operate in direct print mode. As illustrated in FIG. 94, the direct print mode is a function of directly outputting the photograph files recorded in the memory of the multifunctional video apparatus by using a printer supporting a PictBridge. Herein, “the directly outputting” means that the photograph is outputted on the printing paper through USB communication between the multifunctional video apparatus and a PictBridge type printer connected therewith, “without separate additional equipment (e.g., PC) other than a USB cable”.

In direct print mode, it is possible to set whether to print date/time using the shortcut button 2 1110-2 of FIG. 8, to set the number of print sheet using the shortcut buttons 3 and 4 1110-3 and 4 of FIG. 8, and to input print/release using the shortcut button 1 1110-1 of FIG. 8.

Furthermore, the multifunctional video apparatus provides a USB transfer function. The USB transfer function is a function of directly transferring the files recorded in a memory to a PC. Herein, “the direct transferring” means that the transfer is carried out through USB communication between the multifunctional video apparatus and a printer connected therewith, “without separate additional equipment other than a USB cable”.

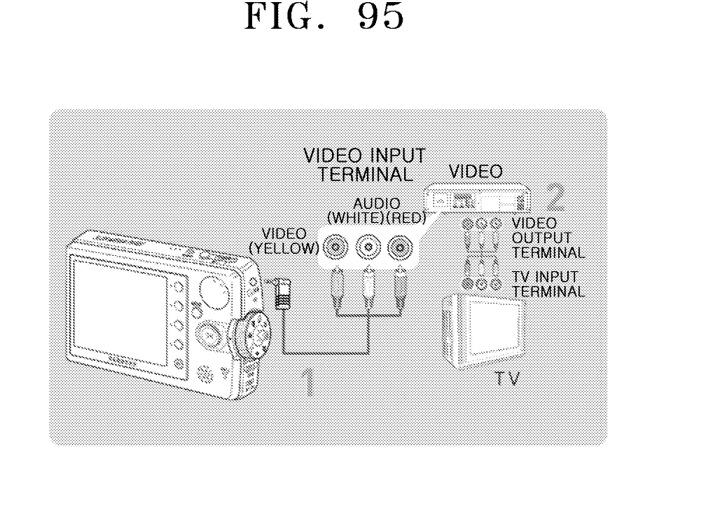

As illustrated in FIG. 95, the multifunctional video apparatus can be connected to a VCR.

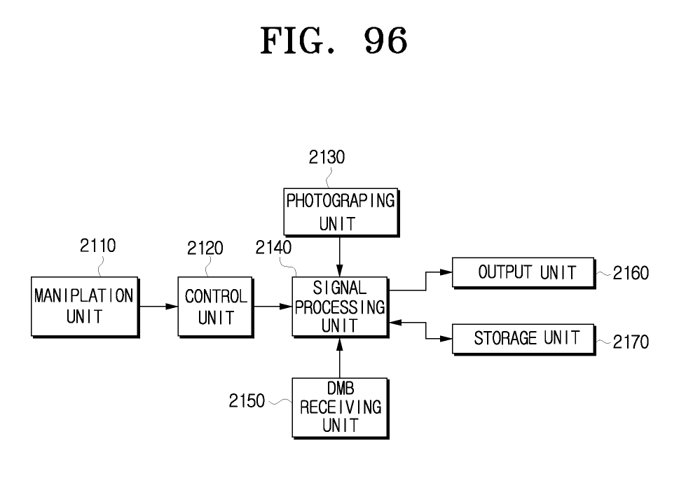

FIG. 96 is an internal block diagram illustrating the construction of the multifunctional video apparatus as described heretofore. As illustrated in FIG. 96, the multifunctional video apparatus includes a manipulation unit 2110, a control unit 2120, a photographing unit 2130, a signal processing unit 2140, a DMB receiving unit 2150, an output unit 2160, and a storage unit 2170.

Referring to FIGS. 8-9 and 96, the manipulation unit 2110 receives a user's manipulation command and then sends it to the control unit 2120 described hereafter. The shortcut buttons 1110-1 to 1110-4, the menu button 1112, the joystick 1114, the mode dial 1118, the display button 1130, the zoom switch 1136, the record start/stop button 1138, the power button 1140, and so forth, which are described before, correspond to the manipulation unit.

The control unit 2120 controls the operations of the photographing unit 2130, signal processing unit 2140, and the DMB receiving unit 2150 so as to implement an operation according to the user's manipulation command inputted from the manipulation unit 2110. The control unit 210 as illustrated in FIG. 1 corresponds to the control unit 2120 as illustrated in FIG. 96.

The photographing unit 2130 photographs/films a photograph/moving image and sends the photograph/moving image created to the signal processing unit 2140 described hereafter. The lens 110, the CCD module 120, and the motor driver 130 as illustrated in FIG. 1 correspond to the photographing unit 2130 as illustrated in FIG. 96.

The DMB receiving unit 2150 receives DMB and sends it to the signal processing unit 2140. The antenna 170, the active module 180, the tuner module 190, the video decoding module 200 as illustrated in FIG. 1 correspond to the DMB receiving unit 2150 as illustrated in FIG. 96.

The signal processing unit 2140 signal-processes photographs, moving images, DMB, music, voice, and so forth, and then stores them in the storage unit 2170. The flash memory 220 and the memory card 240 as illustrated in FIG. 1 correspond to the storage unit 2170 as illustrated in FIG. 96. In addition, the signal processing unit 2140 reproduces the photographs, moving images, DMB, music, voice, and so forth stored in the storage unit 2170, and then sends them to the output unit 2160.

The signal process block 300 as illustrated in FIG. 1 corresponds to the signal processing unit 2140 as illustrated in FIG. 96.The output unit 2160 outputs the photographs, moving images, DMB, music, voice, and so forth sent from the signal processing unit 2140, and then provides them to a user. The earphone and video/audio terminal 1116, the LCD 1132, and the built-in speaker 1128 as described before correspond to the output. The LCD 150 and the DAC/ADC 160 as illustrated in FIG. 1 correspond to the output unit 2160 as illustrated in FIG. 96.

As described above, the multifunctional video apparatus according to embodiments of the present general inventive concept may be configured so that it includes other video apparatuses than those above and receives other type broadcasts than the DMB/MAB.

Accordingly, the user can operate a multifunctional video apparatus in a variety of modes and functions through a simple manipulation, and have excellent visual effects.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A multifunctional video apparatus comprising:
a Charge Coupled Device (CCD) module to capture an image of an object and to generate a corresponding video signal;
a tuner module to receive a broadcasting signal provided through a selected channel;
a decoding module to decode the broadcasting signal received through the tuner module;
a display unit to display a video corresponding to a reproduced signal; and
a signal processing block to process the video signal generated from the CCD module, to record the processed video signal in a memory, to reproduce an output signal of the decoding module, and to apply the reproduced signal to the display unit.

2. The multifunctional video apparatus as claimed in claim 1, further comprising:
a conversion unit to output an audio corresponding to an audio signal provided from the signal processing block, and to generate and transfer an audio signal corresponding to an audio inputted from an outside to the signal processing block;
wherein the signal processing block processes the audio signal transferred from the conversion unit and then stores the processed audio signal in the memory.

3. The multifunctional video apparatus as claimed in claim 2, wherein the signal processing block transfers a DAB signal received from the tuner module to the conversion unit.

4. The multifunctional video apparatus as claimed in claim 2, wherein the signal processing block processes the audio signal applied from the conversion unit, and then records the processed audio signal in the memory.

5. The multifunctional video apparatus as claimed in claim 2, wherein the signal processing block reproduces the signal stored in the memory, and transfers the reproduced signal to at least one of the display unit and the conversion unit.

6. A method of providing a user interface (UI) of a multifunctional video apparatus, the method comprising:
displaying a plurality of selectable shortcut icons by using a plurality of shortcut buttons provided on an outer part of the multifunctional video apparatus; and
performing a function of the multifunctional video apparatus that is indicated by the shortcut icon corresponding to the manipulated shortcut button among the plurality of shortcut buttons.

7. The method as claimed in claim 6, wherein the displaying operation comprises displaying the plurality of shortcut icons indicating different functions through a display, which is provided at the outer side of the multifunctional video apparatus, in accordance with a mode of the multifunctional video apparatus.

8. The method as claimed in claim 7, wherein the display is provided near to the plurality of shortcut buttons.

9. The method as claimed in claim 7, wherein the mode of the multifunctional video apparatus comprises at least one of:
a setting mode to set an operation environment;
a broadcast mode to receive a broadcast signal;
a mode to record a photograph file generated through photographing;
a mode to reproduce the recorded photograph file;
a mode to record a moving image file generated through moving image filming;
a mode to reproduce the recorded moving image file;
a mode to play a music file;
a mode to record a voice file generated through a voice recording;
a mode to transfer the moving image generated through the moving image filming to an external device connected to the multifunctional video apparatus; and
a mode to output the recorded photograph files to the external device.

10. The method as claimed in claim 6, wherein the performing of the multifunction video apparatus comprises displaying through a display a broadcast channel indicated by the manipulated shortcut button among the plurality of shortcut buttons, when the shortcut button is manipulated for less than a predetermined time.

11. The method as claimed in claim 6, wherein the performing of the multifunction video apparatus comprises registering a broadcast channel currently provided through a display as a favorite channel to be indicated by the manipulated shortcut button among the plurality of shortcut buttons, when the shortcut button is manipulated for more than a predetermined time.

12. The method as claimed in claim 6, wherein the performing of the multifunction video apparatus comprises displaying through a display one of:
a list of all receivable channels of the multifunction video apparatus;
a list of video channels among all receivable channels,; and
a list of audio channels among all receivable channels.

13. The method as claimed in claim 12, wherein the performing of the multifunction video apparatus further comprises displaying through the display the currently displayed list along with the other lists among the list of all receivable channels, the list of video channels among all receivable channels, and the list of audio channels among all receivable channels, when the manipulated shortcut button is manipulated one more time.

14. The method as claimed in claim 6, wherein the plurality of shortcut buttons comprise at least one of:
a shortcut button to change operation mode of the multifunction video apparatus between a photographing mode and the reproducing mode;
a shortcut button to set flash operation;
a shortcut button to set photographing distance; and
a shortcut button to set timer operation.

15. The method as claimed in claim 6, wherein the plurality of shortcut buttons comprise at least one of:
a shortcut button to change operation mode of the multifunction video apparatus between photographing mode and reproducing mode;
a shortcut button to start photograph slide;
a shortcut button to lock a file from deletion; and
a shortcut button to delete a file.

16. The method as claimed in claim 6, wherein the plurality of shortcut buttons comprise at least one of:
a shortcut button to change operation of the multifunction video apparatus between photographing mode and reproducing mode;
a shortcut button to set exposure;
a shortcut button to set white balance; and
a shortcut button to set digital effect of an image.

17. The method as claimed in claim 6, wherein the plurality of shortcut buttons comprise at least one of:
a shortcut button to change operation mode of the multifunction video apparatus between photographing mode and reproducing mode;
a shortcut button to reproduce recorded files in order;
a shortcut button to lock a file from deletion; and
a shortcut button to delete a file.

18. The method as claimed in claim 6, wherein the plurality of shortcut buttons comprise at least one of:
a shortcut button to display a list of recorded files;
a shortcut button to reproduce a predetermined number of files repeatedly;
a shortcut button to lock certain buttons; and
a shortcut button to delete a file.

19. The method as claimed in claim 6, wherein the plurality of shortcut buttons comprise at least one of:
a shortcut button to change operation mode of the multifunction apparatus between recording mode and reproducing mode;
a shortcut button to display a list of recorded files;
a shortcut button to reproduce a predetermined number of files repeatedly; and
a shortcut button to delete a file.

20. A multifunction video apparatus comprising:
a memory which records a file; and
a controller which controls such that a photograph file is recorded in a photograph folder of the memory, a moving image file is recorded in a moving image folder of the memory, and an audio related file is recorded in an audio folder of the memory, respectively.

21. The multifunction video apparatus as claimed in claim 20, wherein the audio folder comprises at least one of:
a voice folder which records a voice file generated through voice recording; and
a music folder which records a music file.

22. The multifunction video apparatus as claimed in claim 21, wherein the moving image folder and the audio folder are subfolders of a same folder.

23. A multifunction video apparatus, comprising:
a first memory which records a file; and
a controller which controls such that a file recorded in the first memory is copied to a second memory which is newly mounted, or a file recorded in the second memory is copied to the first memory.

24. The multifunction video apparatus as claimed in claim 23, wherein the first memory is provided inside the multifunction video apparatus, and the second memory is removable with respect to the multifunction video apparatus.

25. A user interface (UI) of a multifunctional video apparatus, the UI comprising:
a plurality of selectable shortcut buttons provided on an outer part of the multifunctional video apparatus; and
a plurality of shortcut icons corresponding to the plurality of shortcut buttons, each shortcut icon to perform an operation of the multifunctional video apparatus when the corresponding shortcut button is manipulated.

26. The UI of claim 25, wherein the plurality of shortcut icons perform operations corresponding to operations of at least one of an audio file player, an audio file recorder, an audio and video signal compressor, an audio and video signal storage device, an audio and video reproducing device, an image capturing device, and a display unit.

27. A method of operating a multifunctional video apparatus, the method comprising:
capturing an image of an object and generating a corresponding video signal;
recording the video signal in a memory;
receiving a broadcasting signal provided through a selected channel;
decoding and outputting the received broadcasting signal;
reproducing the output broadcasting signal of the decoding module; and
displaying an image corresponding to a reproduced broadcasting signal onto a display unit.

28. A multifunctional video apparatus, comprising:
a manipulation unit to receive a manipulation command and to output the received command; a photographing unit to photograph images;
a DMB receiving unit to receive DMB;
signal processing unit to process and store signals from audio files, moving images, still images, and DMB; and
a control unit to receive an output from the manipulation unit and to control operation of each of the photographing unit, signal processing unit, and the DMB receiving unit according to the received command.

29. The multifunctional video apparatus of claim 28, wherein the photographing unit sends the images to the signal processing unit.

30. The multifunctional video apparatus of claim 29, wherein the photographing unit comprises:
a charge coupled device (CCD) module to capture an image of an object and to generate a corresponding video signal;
a lens to form an optical image of an object on an optical plane of the CCD; and
a motor drive unit to operate the lens by driving a zoom motor, a focus motor, and an iris motor.

31. The multifunctional video apparatus of claim 28, wherein the DMB receiving unit sends the DMB to the signal processing unit.

32. The multifunctional video apparatus of claim 31, wherein the DMB receiving unit comprises:
an antenna to receive the DMB signal;
an active module to perform operations of DMB signal amplification or noise removal;
a tuner module to perform channel tuning and signal decoding; and
a video decoding module to transfer the DMB signal to the signal processing unit.

33. The multifunctional video apparatus of claim 28, wherein the signal processing unit further reproduces the stored signals, and outputs the stored signals to a display unit.
